(19) United States
(12) Patent Application Publication
(10) Pub. No.: US 2025/0321966 A1
(43) Pub. Date: Oct. 16, 2025

(54) SELECTING A SERVICE CLASS FOR QUERY EXECUTION BASED ON TEXT OF A QUERY EXPRESSION MATCHING A TEXT PATTERN

(71) Applicant: Ocient Holdings LLC, Chicago, IL (US)

(72) Inventor: Andrei Lougovtsov, Boston, MA (US)

(73) Assignee: Ocient Holdings LLC, Chicago, IL (US)

(21) Appl. No.: 18/632,515

(22) Filed: Apr. 11, 2024

(51) Int. Cl. G06F 16/2453

(52) U.S. Cl. CPC G06F 16/24545; G06F 16/24532; G06F 16/24539

(57) ABSTRACT

A database system is operable to determine query service class text pattern data indicating a plurality of text patterns each corresponding to one of a plurality of service classes. A query expression indicating a query for execution is determined, and the query service class text pattern data to select one service class of the plurality of service classes for the query based on text of the query expression matching a corresponding text pattern of the plurality of text patterns that corresponds to the one service class. The query is executed in accordance with a set of query execution attributes of the one service class based on selecting the one service class for the query.

### CROSS-REFERENCE TO RELATED APPLICATIONS

None

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to computer networking and more particularly to database system and operation.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function.

Of the many applications a computer can perform, a database system is one of the largest and most complex applications. In general, a database system stores a large amount of data in a particular way for subsequent processing. In some situations, the hardware of the computer is a limiting factor regarding the speed at which a database system can process a particular function. In some other instances, the way in which the data is stored is a limiting factor regarding the speed of execution. In yet some other instances, restricted co-process options are a limiting factor regarding the speed of execution.

### BRIEF DESCRIPTION OF THE SEVERAL VIEWS OF THE DRAWING(S)

FIG. 1 is a schematic block diagram of an embodiment of a large scale data processing network that includes a database system in accordance with various embodiments;

FIG. 1A is a schematic block diagram of an embodiment of a database system in accordance with various embodiments;

FIG. 2 is a schematic block diagram of an embodiment of an administrative sub-system in accordance with various embodiments;

FIG. 3 is a schematic block diagram of an embodiment of a configuration sub-system in accordance with various embodiments;

FIG. 4 is a schematic block diagram of an embodiment of a parallelized data input sub-system in accordance with various embodiments;

FIG. 5 is a schematic block diagram of an embodiment of a parallelized query and response (Q&R) sub-system in accordance with various embodiments;

FIG. 6 is a schematic block diagram of an embodiment of a parallelized data store, retrieve, and/or process (IO& P) sub-system in accordance with various embodiments;

FIG. 7 is a schematic block diagram of an embodiment of a computing device in accordance with various embodiments;

FIG. 8 is a schematic block diagram of another embodiment of a computing device in accordance with various embodiments;

FIG. 9 is a schematic block diagram of another embodiment of a computing device in accordance with various embodiments;

FIG. 10 is a schematic block diagram of an embodiment of a node of a computing device in accordance with various embodiments;

FIG. 11 is a schematic block diagram of an embodiment of a node of a computing device in accordance with various embodiments;

FIG. 12 is a schematic block diagram of an embodiment of a node of a computing device in accordance with various embodiments;

FIG. 13 is a schematic block diagram of an embodiment of a node of a computing device in accordance with various embodiments;

FIG. 14 is a schematic block diagram of an embodiment of operating systems of a computing device in accordance with various embodiments;

FIGS. 15-23 are schematic block diagrams of an example of processing a table or data set for storage in the database system in accordance with various embodiments;

FIG. 24A is a schematic block diagram of a query execution plan implemented via a plurality of nodes in accordance with various embodiments;

FIGS. 24B-24D are schematic block diagrams of embodiments of a node that implements a query processing module in accordance with various embodiments;

FIG. 24E is an embodiment is schematic block diagrams illustrating a plurality of nodes that communicate via shuffle networks in accordance with various embodiments;

FIG. 24F is a schematic block diagram of a database system communicating with an external requesting entity in accordance with various embodiments;

FIG. 24G is a schematic block diagram of a query processing system in accordance with various embodiments;

FIG. 24H is a schematic block diagram of a query operator execution flow in accordance with various embodiments;

FIG. 24I is a schematic block diagram of a plurality of nodes that utilize query operator execution flows in accordance with various embodiments;

FIG. 24J is a schematic block diagram of a query execution module that executes a query operator execution flow via a plurality of corresponding operator execution modules in accordance with various embodiments;

FIG. 24K illustrates an example embodiment of a plurality of database tables stored in database storage in accordance with various embodiments;

FIG. 24L illustrates an example embodiment of a dataset stored in database storage that includes at least one array field in accordance with various embodiments;

FIG. 24M is a schematic block diagram of a query execution module that implements a plurality of column data streams in accordance with various embodiments;

FIG. 24N illustrates example data blocks of a column data stream in accordance with various embodiments;

FIG. 240 is a schematic block diagram of a query execution module illustrating writing and processing of data blocks by operator execution modules in accordance with various embodiments;

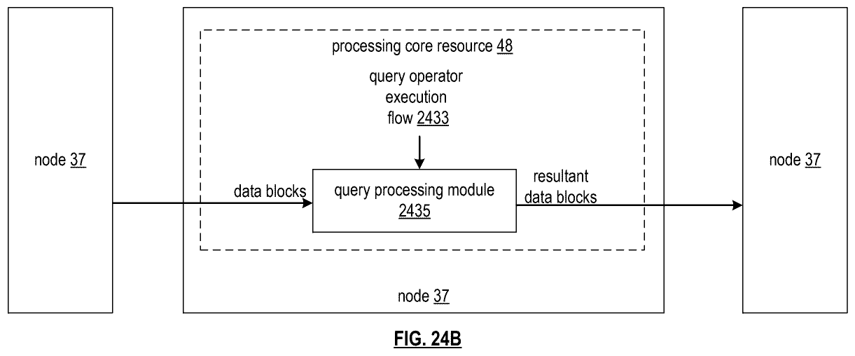

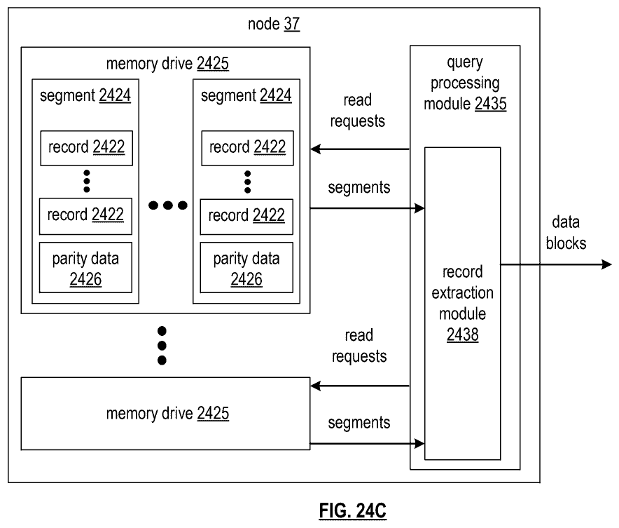

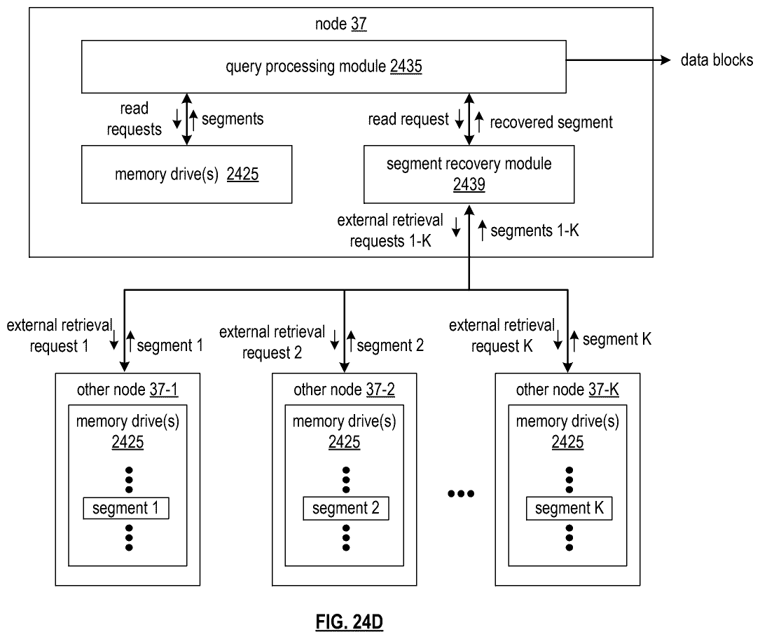

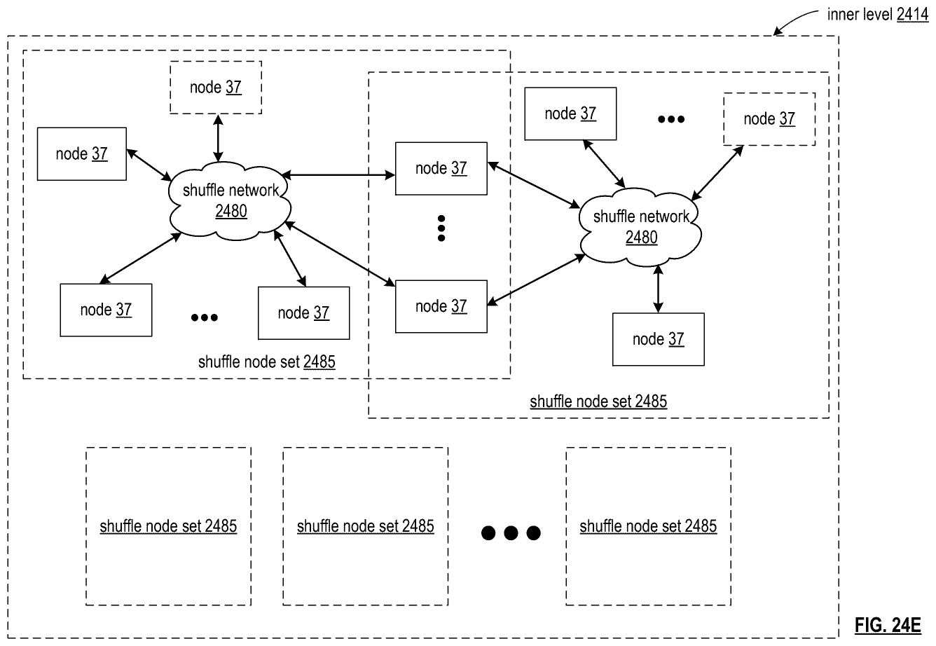

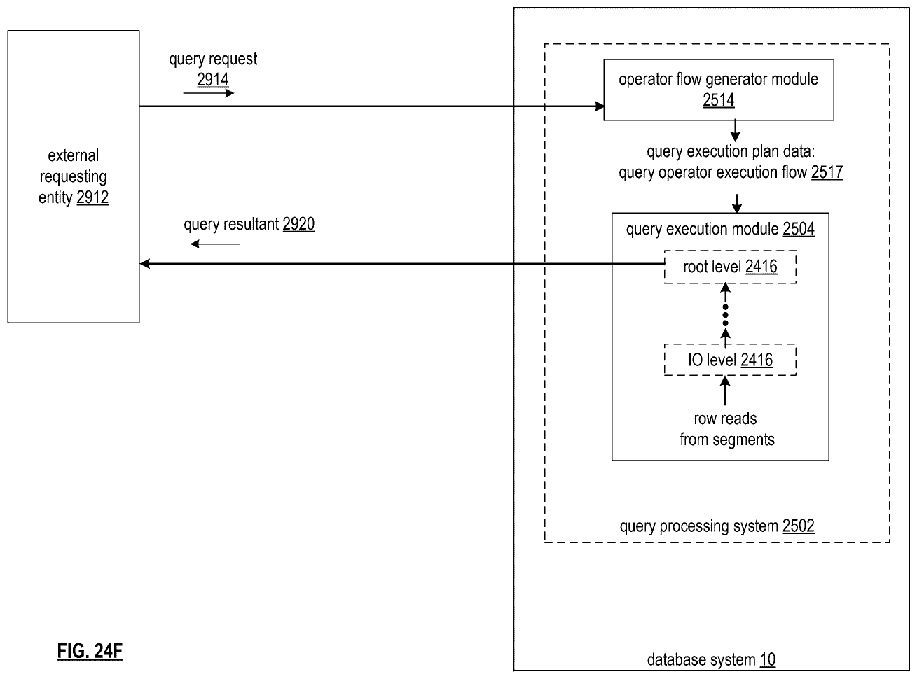

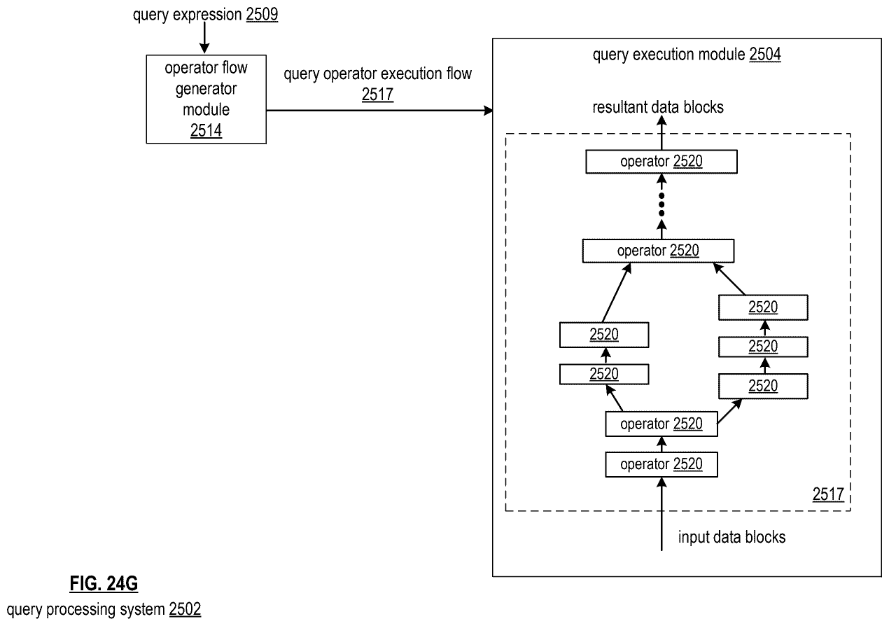

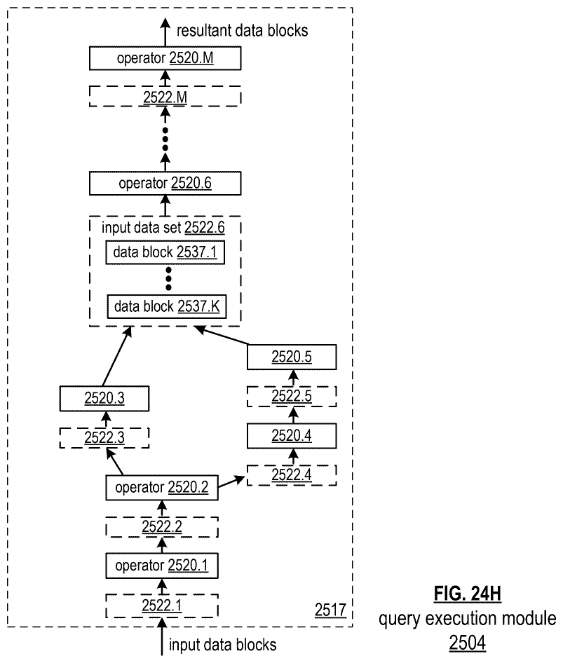

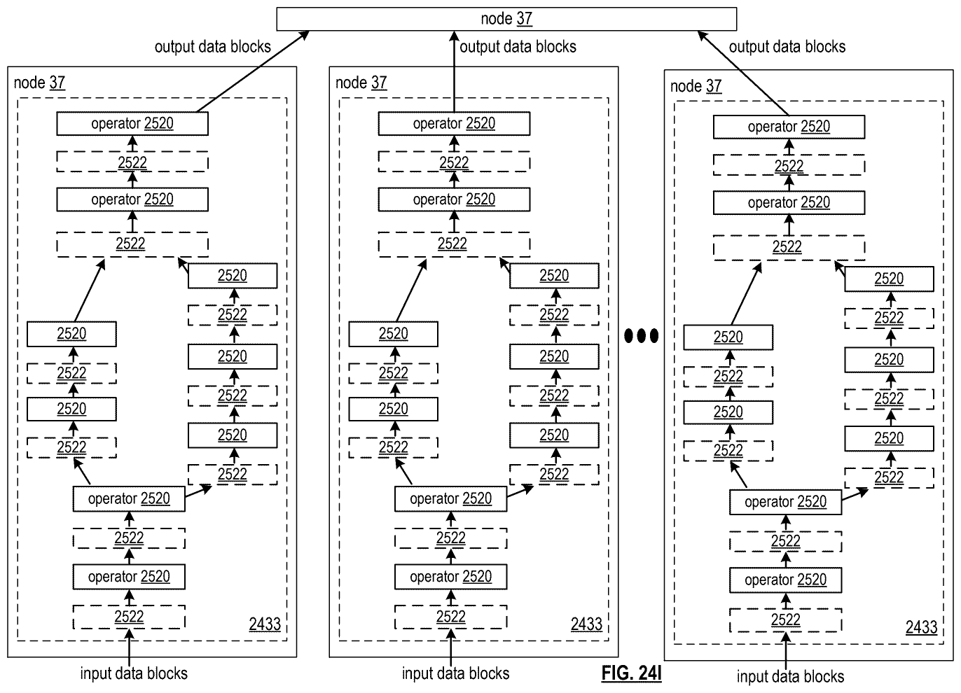

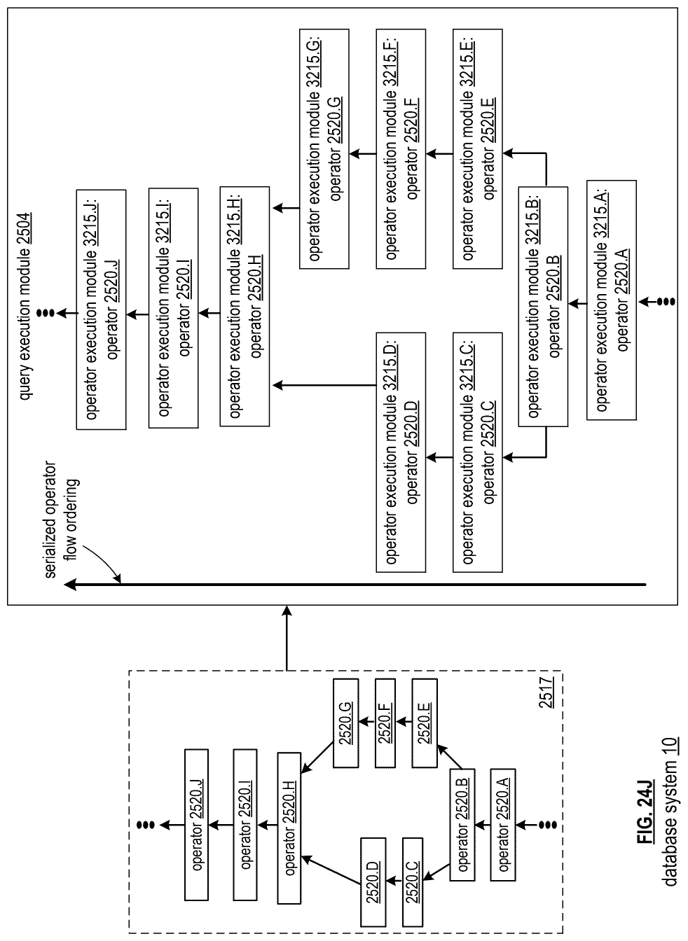

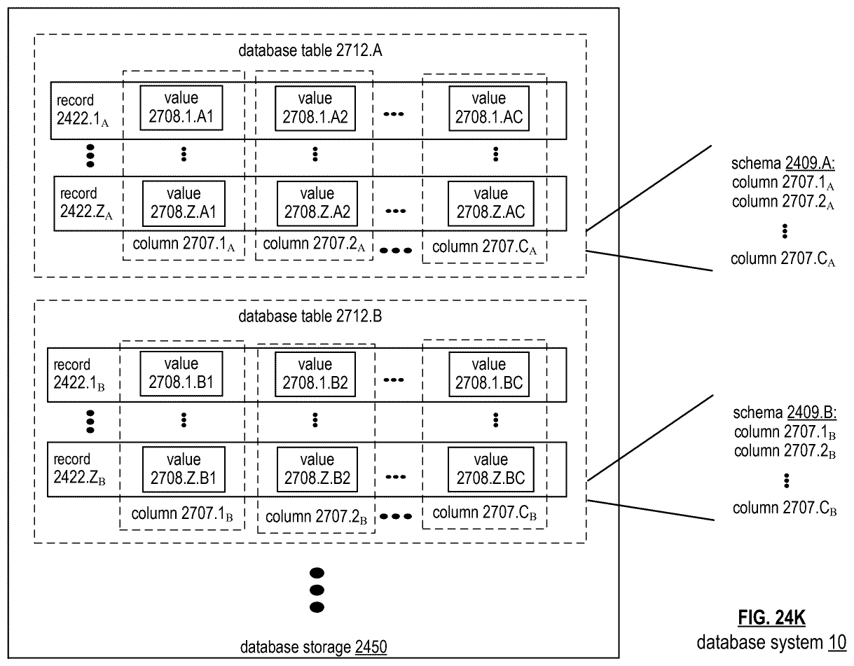

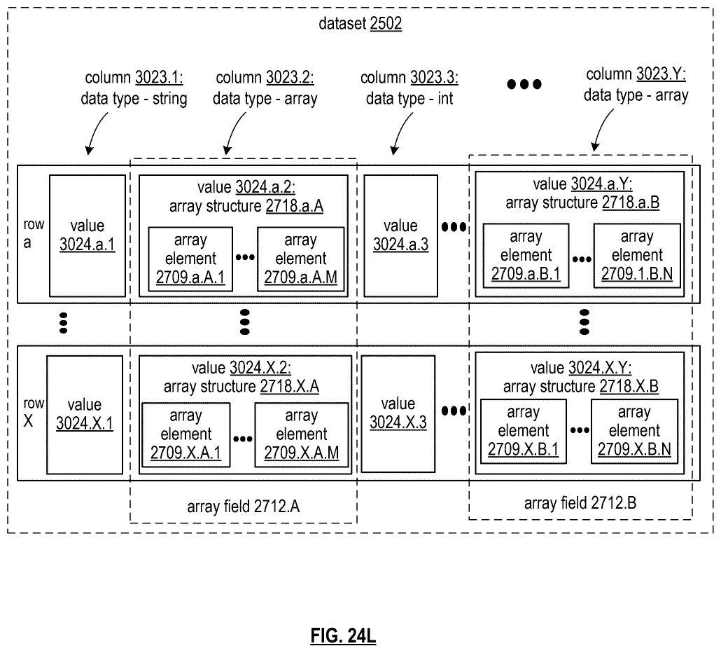

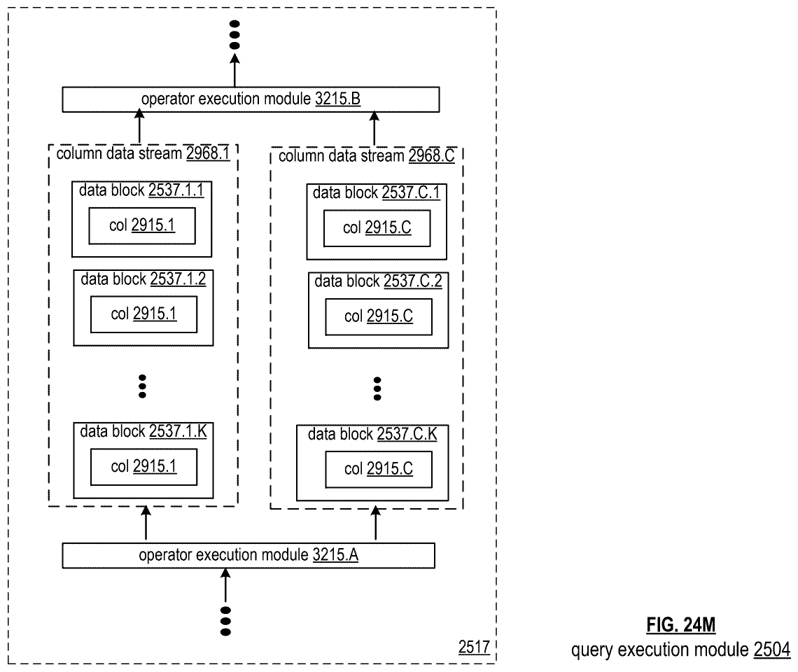

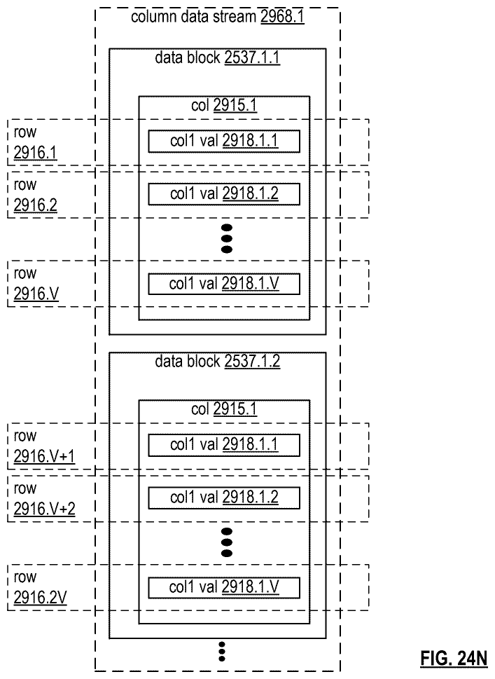

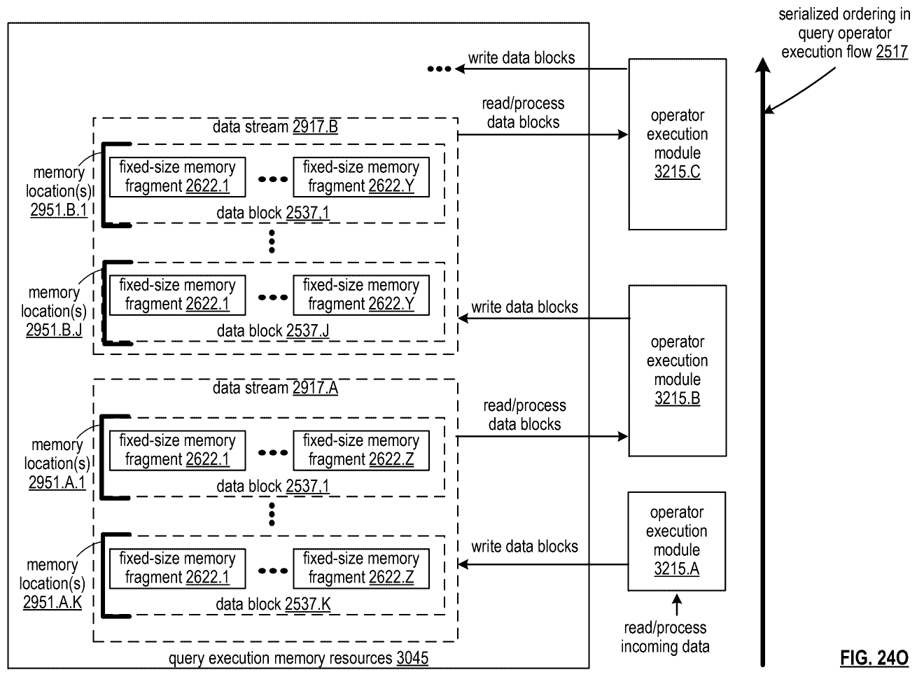

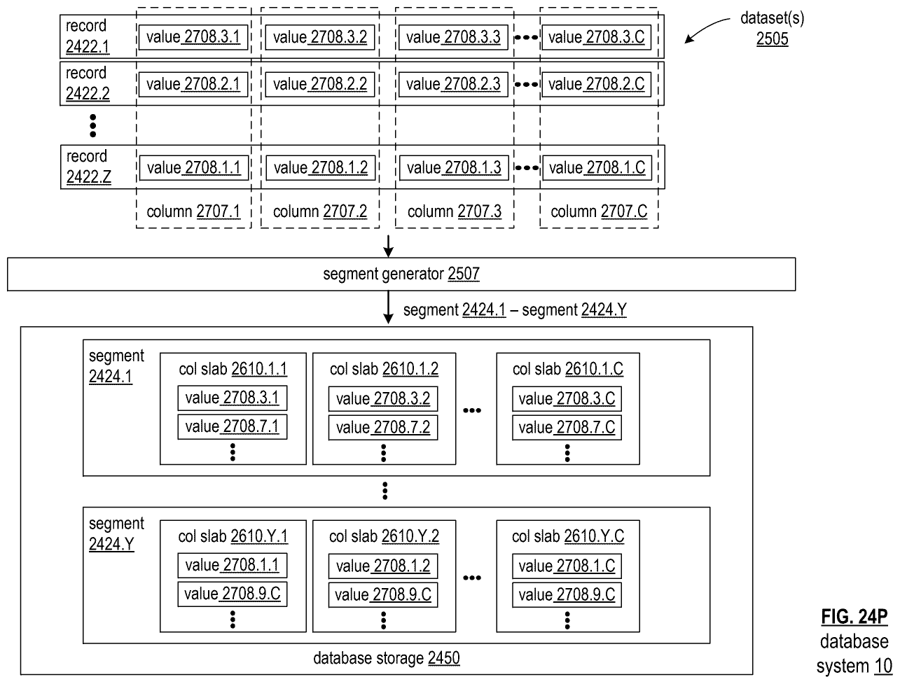

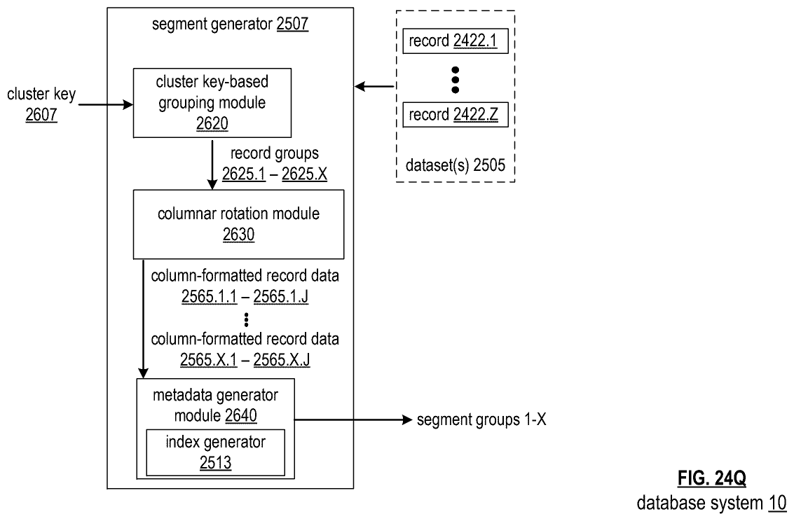

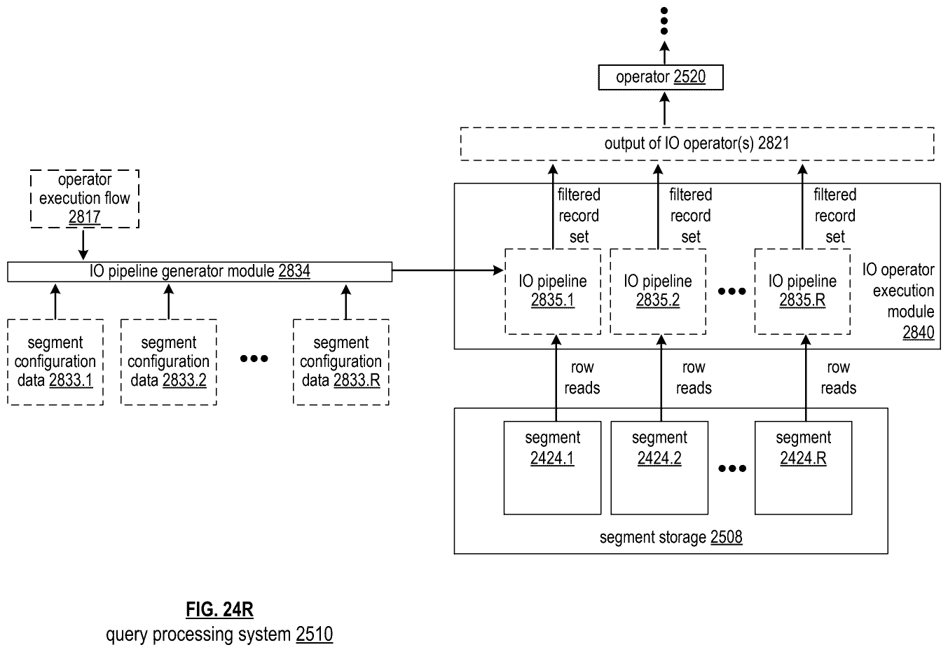

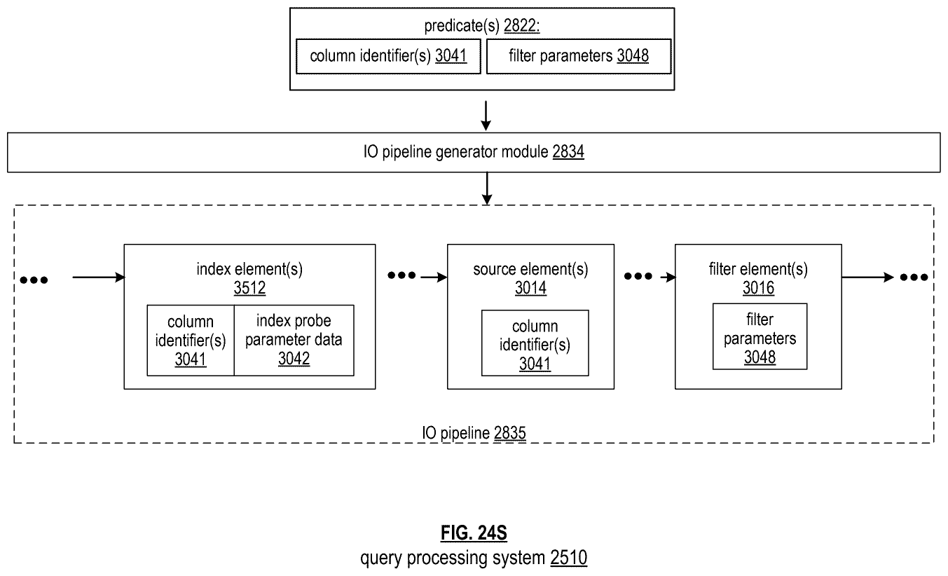

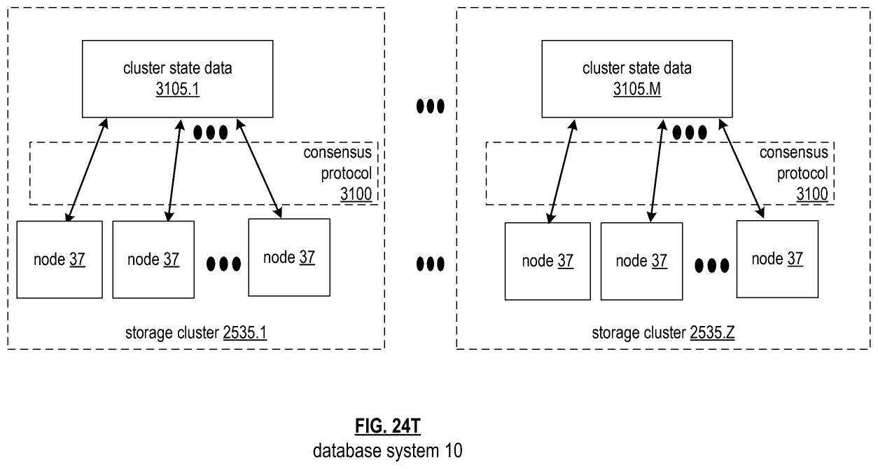

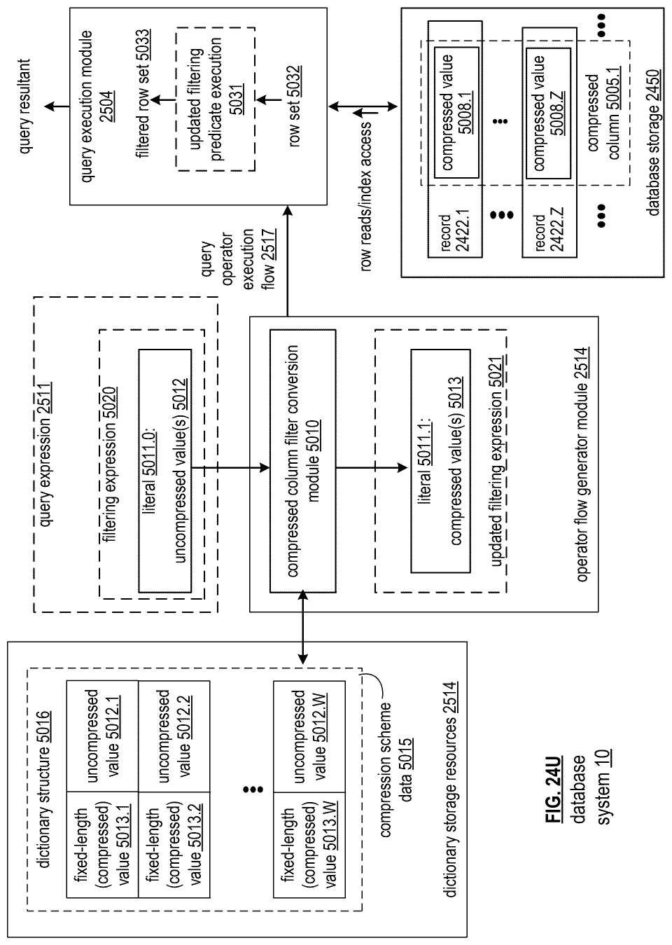

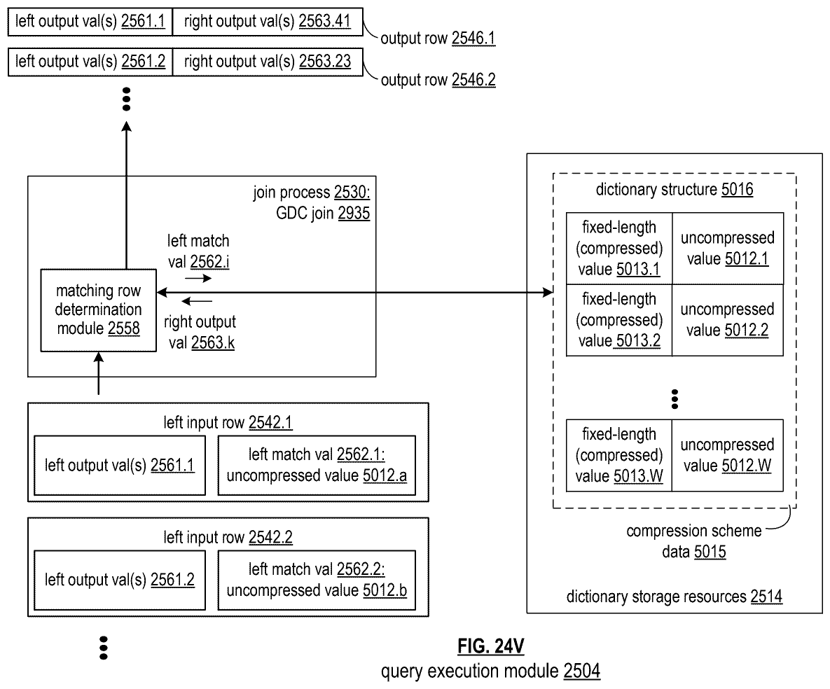

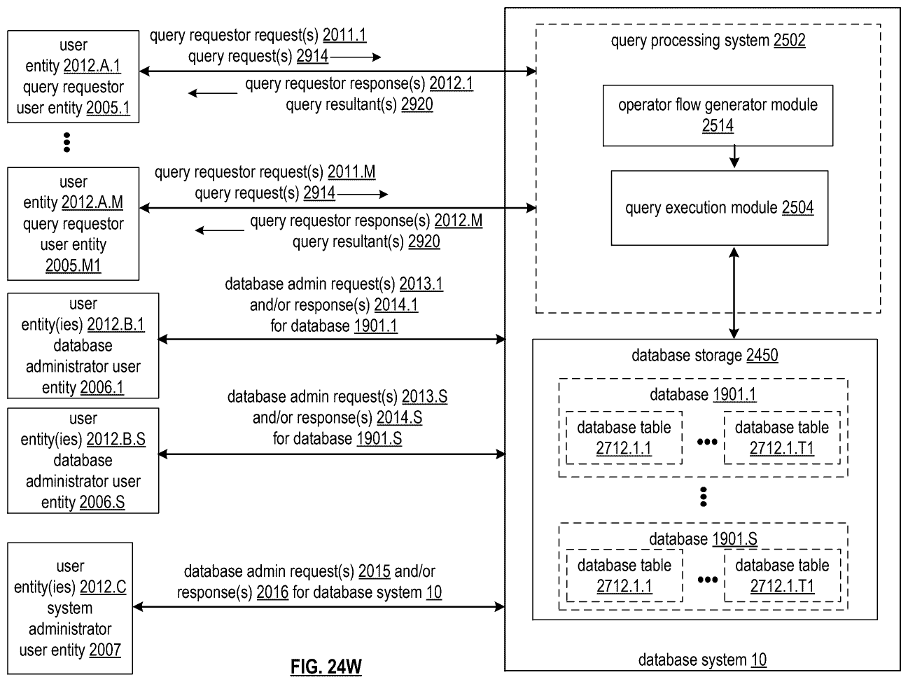

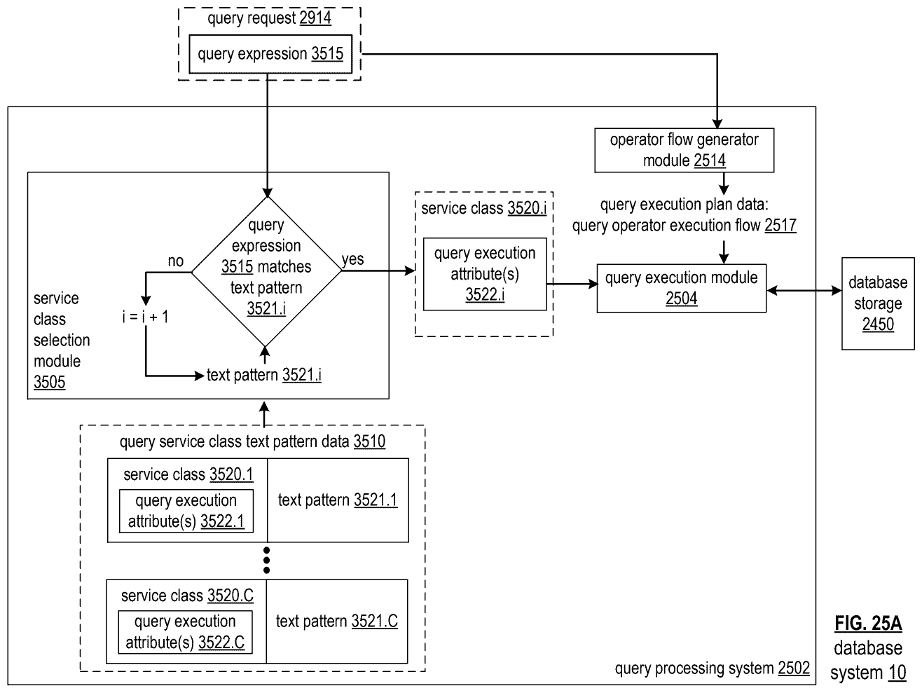

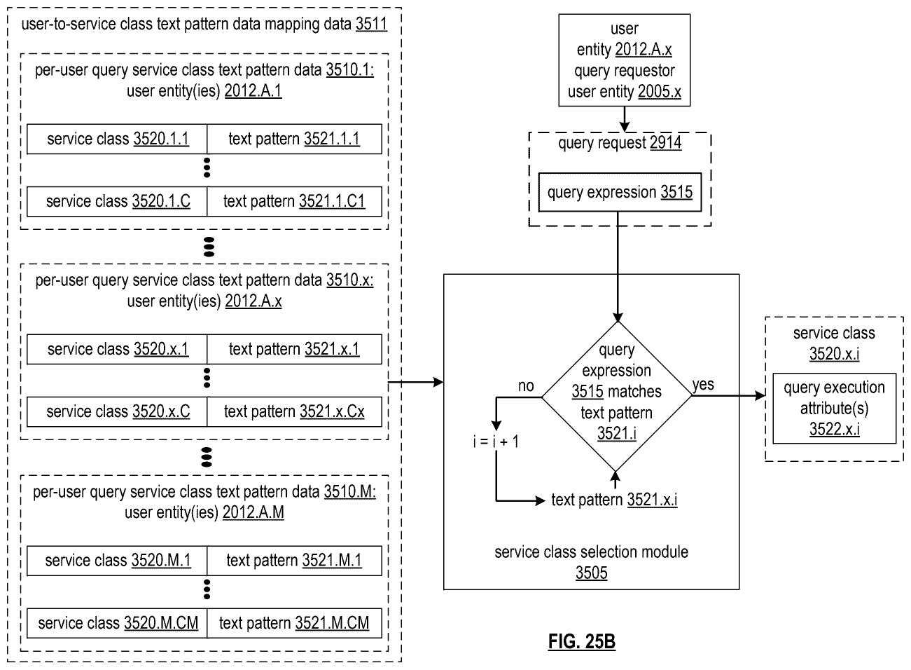

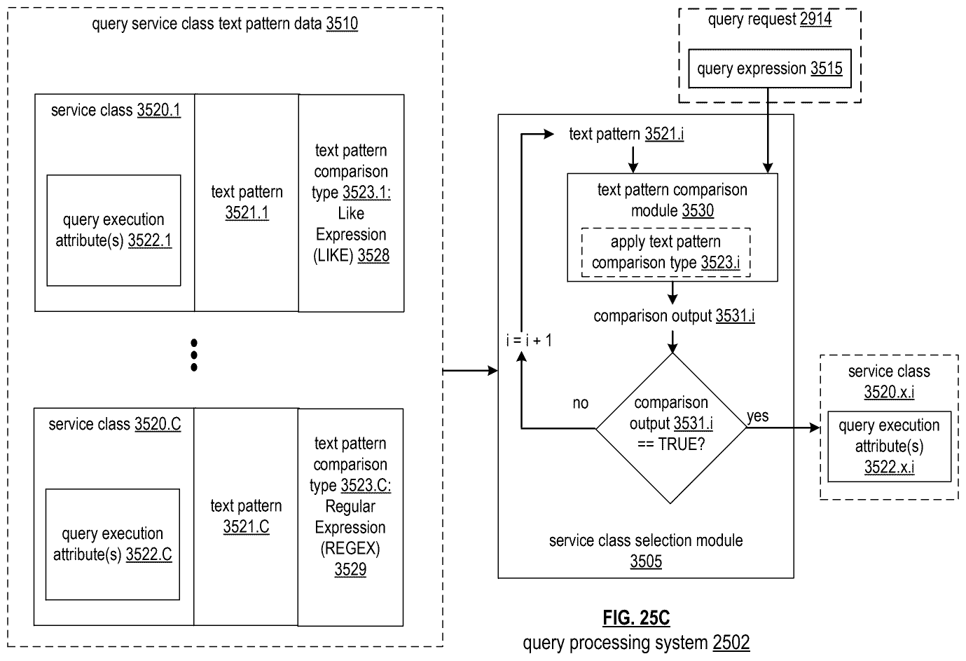

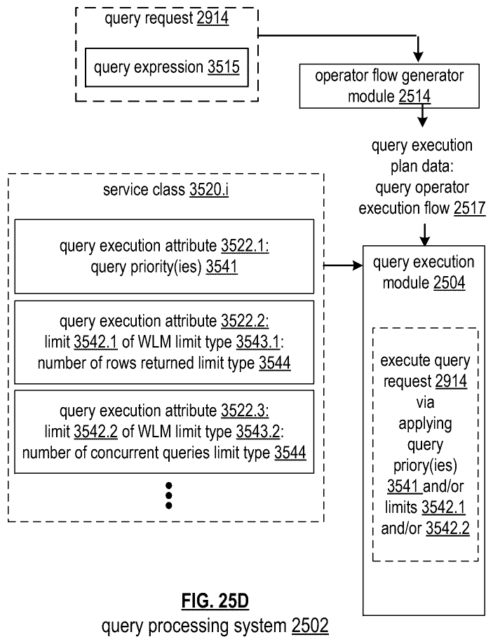

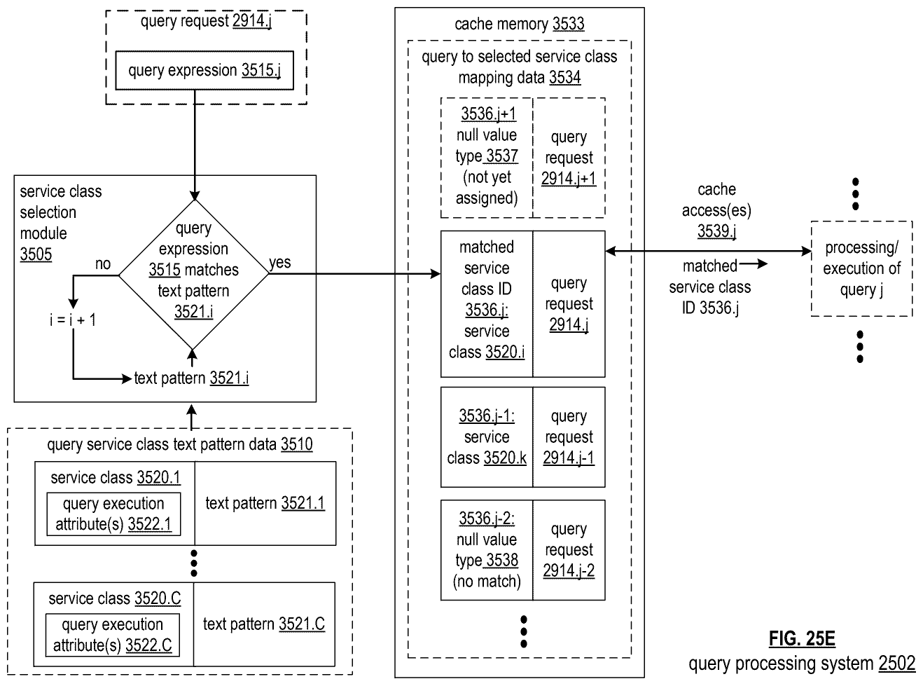

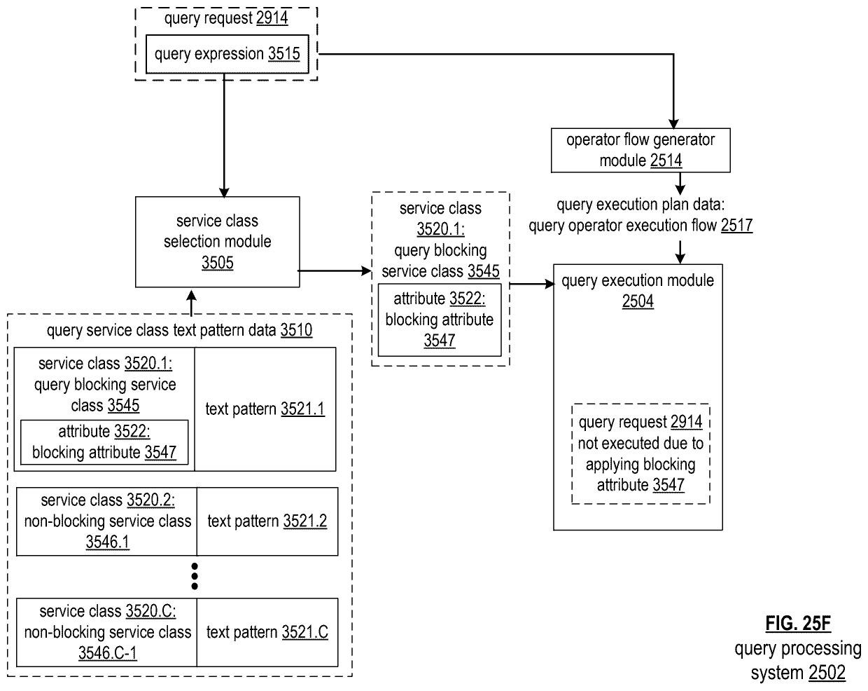

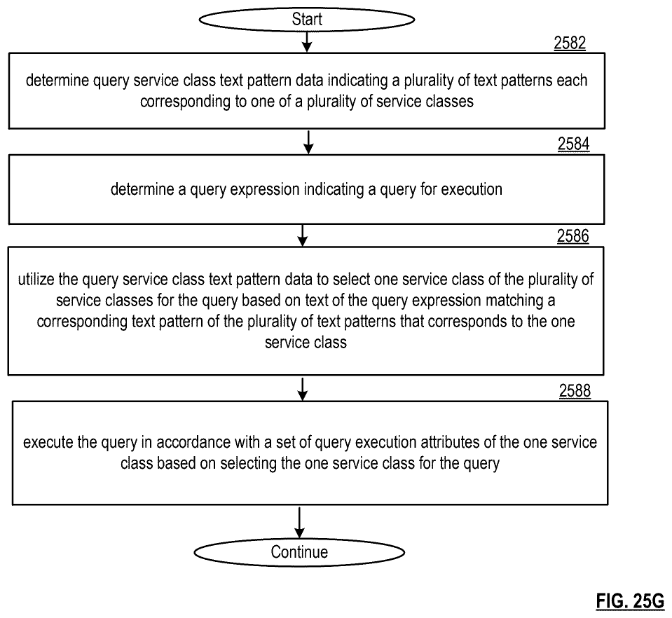

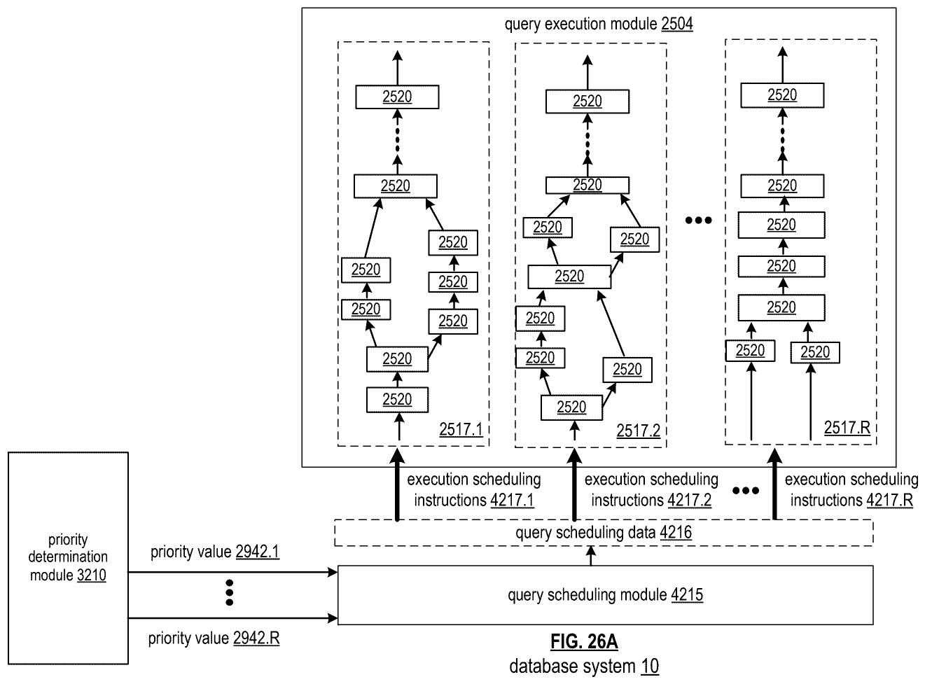

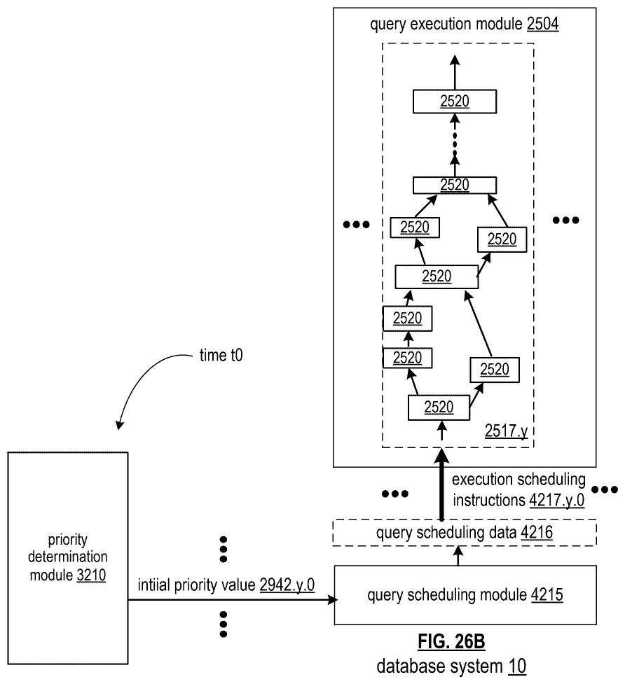

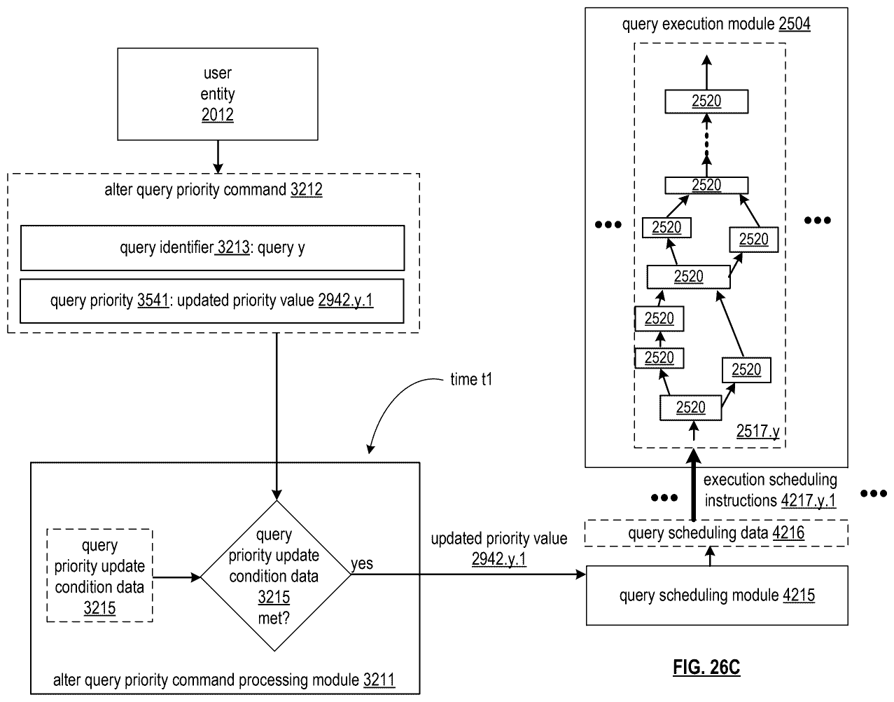

FIG. 24P is a schematic block diagram of a database system that implements a segment generator that generates segments from a plurality of records in accordance with various embodiments;

FIG. 24Q is a schematic block diagram of a segment generator that implements a cluster key-based grouping module, a columnar rotation module, and a metadata generator module in accordance with various embodiments;

FIG. 24R is a schematic block diagram of a query processing system that generates and executes a plurality of IO pipelines to generate filtered records sets from a plurality of segments in conjunction with executing a query in accordance with various embodiments;

FIG. 24S is a schematic block diagram of a query processing system that generates an IO pipeline for accessing a corresponding segment based on predicates of a query in accordance with various embodiments;

FIG. 24T is a schematic block diagram of a database system that includes a plurality of storage clusters that each mediate cluster state data via a plurality of nodes in accordance with a consensus protocol in accordance with various embodiments;

FIG. 24U is a schematic block diagram of a database system that implements a compressed column filter conversion module based on accessing a dictionary structure in accordance with various embodiments;

FIG. 24V is a schematic block diagram of a query execution module that implements a Global Dictionary Compression join via access to a dictionary structure in accordance with various embodiments;

FIG. 24W is a schematic block diagram illustrating communication between database system 10 and a plurality of user entities in accordance with various embodiments;

FIG. 25A is a schematic block diagram of a query processing system that implements a service class selection module to select a service class for execution of a query request based on query service data text pattern data in accordance with various embodiments;

FIG. 25B is a schematic block diagram of a query processing system that implements a service class selection module select a service class for execution of a query request requested by a user entity based on per-user query service data text pattern data in accordance with various embodiments;

FIG. 25C is a schematic block diagram of a query processing system that implements a service class selection module that implements a text pattern comparison module to compare a query expression to a corresponding text pattern based on apply a text pattern comparison type mapped to the corresponding text pattern in query service plan text pattern data in accordance with various embodiments;

FIG. 25D is a schematic block/flow diagram of a query processing system that executes a query based on an example set of query attributes of a service class selected for the query in accordance with various embodiments;

FIG. 25E is a schematic block diagram of a query processing system that stores query to selected service class mapping data in cache memory in accordance with various embodiments;

FIG. 25F is a schematic block diagram of a service class selection module that selects a query blocking service class for a query based on service class text pattern data in accordance with various embodiments;

FIG. 25G is a logic diagram illustrating a method for execution in accordance with various embodiments;

FIG. 26A is a schematic block diagram of a database system that implements a query scheduling module to generate query scheduling data for concurrent execution of a plurality of queries based on priority values of the plurality of queries in accordance with various embodiments;

FIG. 26B is a schematic block diagram illustrating execution of a query via a query execution module based on query scheduling data generated based on an initial priority value for the query in accordance with various embodiments;

FIG. 26C is a schematic block diagram illustrating execution of a query via a query execution module based on query scheduling data generated based on an updated priority value for the query generated via an alter query priority command processing module based on processing an alter query priority command in accordance with various embodiments; and

FIG. 26D is a logic diagram illustrating a method for execution in accordance with various embodiments.

### DETAILED DESCRIPTION OF THE INVENTION

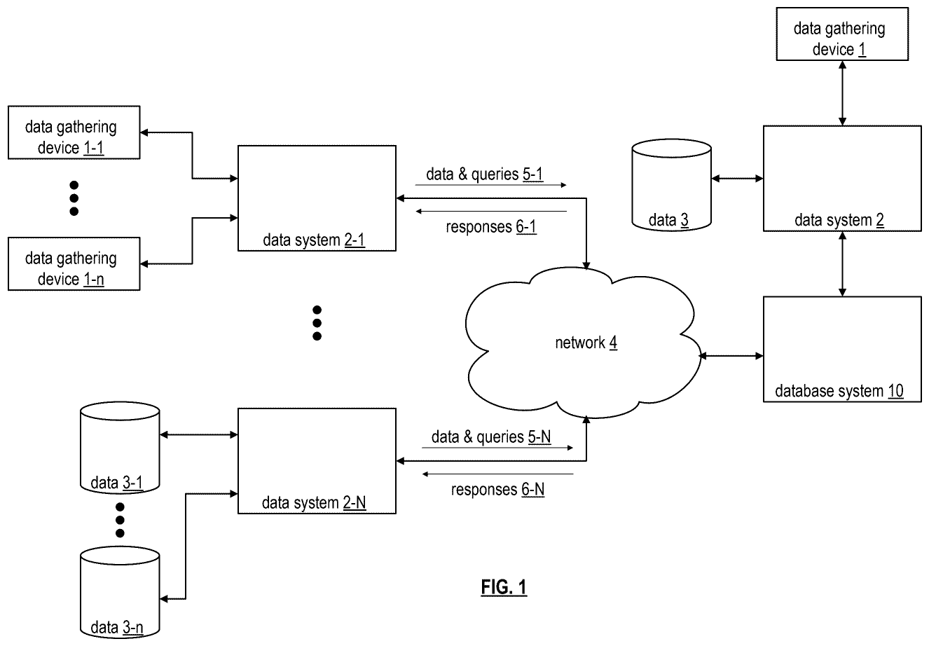

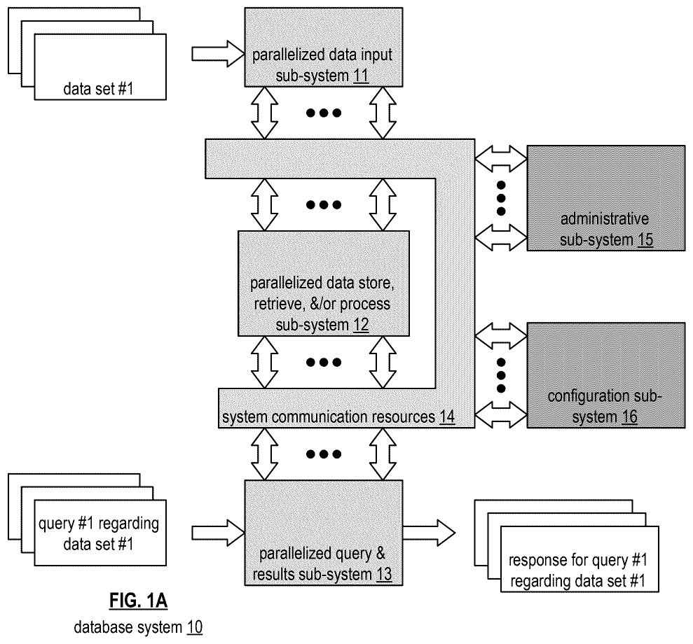

FIG. 1 is a schematic block diagram of an embodiment of a large-scale data processing network that includes data gathering devices (1, 1-1 through 1-n), data systems (2, 2-1 through 2-N), data storage systems (3, 3-1 through 3-n), a network 4, and a database system 10. The data gathering devices are computing devices that collect a wide variety of data and may further include sensors, monitors, measuring instruments, and/or other instrument for collecting data. The data gathering devices collect data in real-time (i.e., as it is happening) and provides it to data system 2-1 for storage and real-time processing of queries 5-1 to produce responses 6-1. As an example, the data gathering devices are computing in a factory collecting data regarding manufacturing of one or more products and the data system is evaluating queries to determine manufacturing efficiency, quality control, and/or product development status.

The data storage systems 3 store existing data. The existing data may originate from the data gathering devices or other sources, but the data is not real time data. For example, the data storage system stores financial data of a bank, a credit card company, or like financial institution. The data system 2-N processes queries 5-N regarding the data stored in the data storage systems to produce responses 6-N.

Data system 2 processes queries regarding real time data from data gathering devices and/or queries regarding non-real time data stored in the data storage system 3. The data system 2 produces responses in regard to the queries. Storage of real time and non-real time data, the processing of queries, and the generating of responses will be discussed with reference to one or more of the subsequent figures.

FIG. 1A is a schematic block diagram of an embodiment of a database system 10 that includes a parallelized data input sub-system 11, a parallelized data store, retrieve, and/or process sub-system 12, a parallelized query and response sub-system 13, system communication resources 14, an administrative sub-system 15, and a configuration sub-system 16. The system communication resources 14 include one or more of: wide area network (WAN) connections, local area network (LAN) connections, wireless connections, wireline connections, etc. to couple the sub-systems 11, 12, 13, 15, and 16 together.

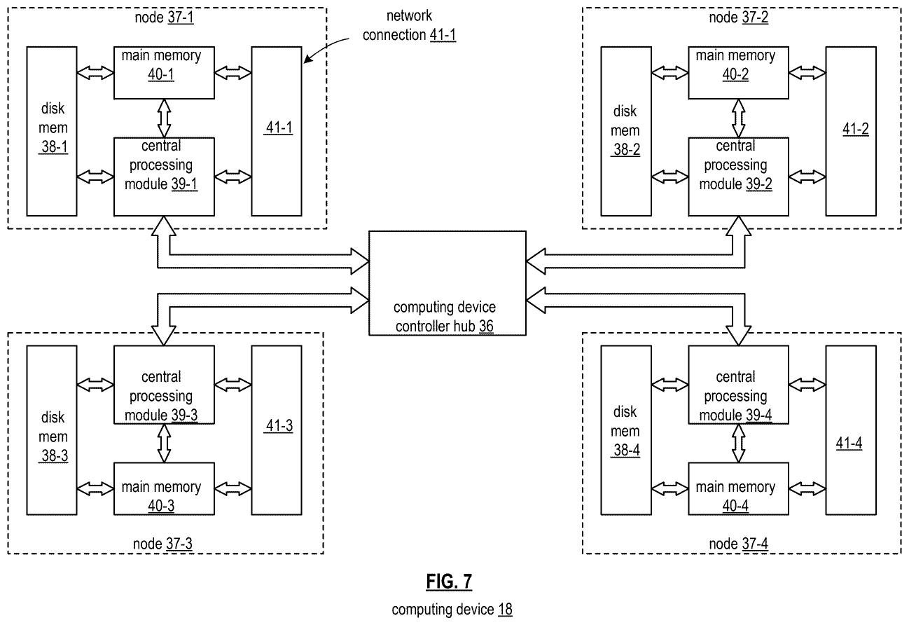

Each of the sub-systems 11, 12, 13, 15, and 16 include a plurality of computing devices; an example of which is discussed with reference to one or more of FIGS. 7-9. Hereafter, the parallelized data input sub-system 11 may also be referred to as a data input sub-system, the parallelized data store, retrieve, and/or process sub-system may also be referred to as a data storage and processing sub-system, and the parallelized query and response sub-system 13 may also be referred to as a query and results sub-system.

In an example of operation, the parallelized data input sub-system 11 receives a data set (e.g., a table) that includes a plurality of records. A record includes a plurality of data fields. As a specific example, the data set includes tables of data from a data source. For example, a data source includes one or more computers. As another example, the data source is a plurality of machines. As yet another example, the data source is a plurality of data mining algorithms operating on one or more computers.

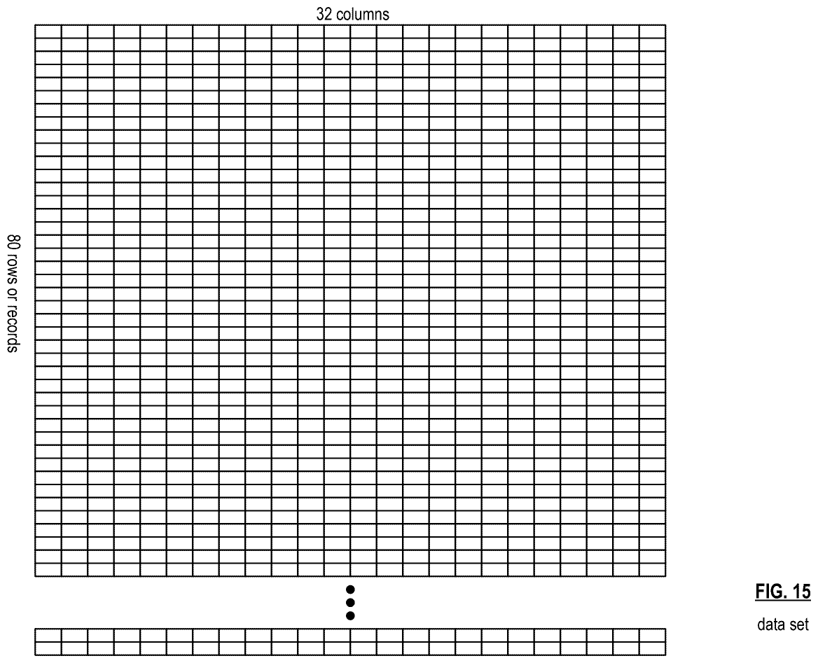

As is further discussed with reference to FIG. 15, the data source organizes its records of the data set into a table that includes rows and columns. The columns represent data fields of data for the rows. Each row corresponds to a record of data. For example, a table include payroll information for a company's employees. Each row is an employee's payroll record. The columns include data fields for employee name, address, department, annual salary, tax deduction information, direct deposit information, etc.

The parallelized data input sub-system 11 processes a table to determine how to store it. For example, the parallelized data input sub-system 11 divides the data set into a plurality of data partitions. For each partition, the parallelized data input sub-system 11 divides it into a plurality of data segments based on a segmenting factor. The segmenting factor includes a variety of approaches of dividing a partition into segments. For example, the segment factor indicates a number of records to include in a segment. As another example, the segmenting factor indicates a number of segments to include in a segment group. As another example, the segmenting factor identifies how to segment a data partition based on storage capabilities of the data store and processing sub-system. As a further example, the segmenting factor indicates how many segments for a data partition based on a redundancy storage encoding scheme.

As an example of dividing a data partition into segments based on a redundancy storage encoding scheme, assume that it includes a 4 of 5 encoding scheme (meaning any 4 of 5 encoded data elements can be used to recover the data). Based on these parameters, the parallelized data input sub-system 11 divides a data partition into 5 segments: one corresponding to each of the data elements).

The parallelized data input sub-system 11 restructures the plurality of data segments to produce restructured data segments. For example, the parallelized data input sub-system 11 restructures records of a first data segment of the plurality of data segments based on a key field of the plurality of data fields to produce a first restructured data segment. The key field is common to the plurality of records. As a specific example, the parallelized data input sub-system 11 restructures a first data segment by dividing the first data segment into a plurality of data slabs (e.g., columns of a segment of a partition of a table). Using one or more of the columns as a key, or keys, the parallelized data input sub-system 11 sorts the data slabs. The restructuring to produce the data slabs is discussed in greater detail with reference to FIG. 4 and FIGS. 16-18.

The parallelized data input sub-system 11 also generates storage instructions regarding how sub-system 12 is to store the restructured data segments for efficient processing of subsequently received queries regarding the stored data. For example, the storage instructions include one or more of: a naming scheme, a request to store, a memory resource requirement, a processing resource requirement, an expected access frequency level, an expected storage duration, a required maximum access latency time, and other requirements associated with storage, processing, and retrieval of data.

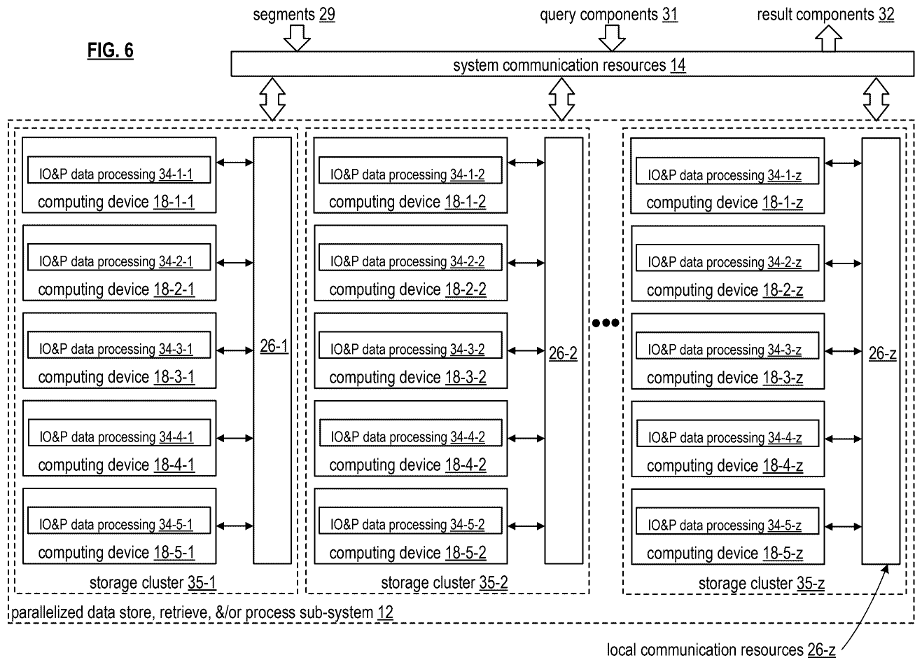

A designated computing device of the parallelized data store, retrieve, and/or process sub-system 12 receives the restructured data segments and the storage instructions. The designated computing device (which is randomly selected, selected in a round robin manner, or by default) interprets the storage instructions to identify resources (e.g., itself, its components, other computing devices, and/or components thereof) within the computing device's storage cluster. The designated computing device then divides the restructured data segments of a segment group of a partition of a table into segment divisions based on the identified resources and/or the storage instructions. The designated computing device then sends the segment divisions to the identified resources for storage and subsequent processing in accordance with a query. The operation of the parallelized data store, retrieve, and/or process sub-system 12 is discussed in greater detail with reference to FIG. 6.

The parallelized query and response sub-system 13 receives queries regarding tables (e.g., data sets) and processes the queries prior to sending them to the parallelized data store, retrieve, and/or process sub-system 12 for execution. For example, the parallelized query and response sub-system 13 generates an initial query plan based on a data processing request (e.g., a query) regarding a data set (e.g., the tables). Sub-system 13 optimizes the initial query plan based on one or more of the storage instructions, the engaged resources, and optimization functions to produce an optimized query plan.

For example, the parallelized query and response sub-system 13 receives a specific query no. 1 regarding the data set no. 1 (e.g., a specific table). The query is in a standard query format such as Open Database Connectivity (ODBC), Java Database Connectivity (JDBC), and/or SPARK. The query is assigned to a node within the parallelized query and response sub-system 13 for processing. The assigned node identifies the relevant table, determines where and how it is stored, and determines available nodes within the parallelized data store, retrieve, and/or process sub-system 12 for processing the query.

In addition, the assigned node parses the query to create an abstract syntax tree. As a specific example, the assigned node converts an SQL (Structured Query Language) statement into a database instruction set. The assigned node then validates the abstract syntax tree. If not valid, the assigned node generates a SQL exception, determines an appropriate correction, and repeats. When the abstract syntax tree is validated, the assigned node then creates an annotated abstract syntax tree. The annotated abstract syntax tree includes the verified abstract syntax tree plus annotations regarding column names, data type(s), data aggregation or not, correlation or not, sub-query or not, and so on.

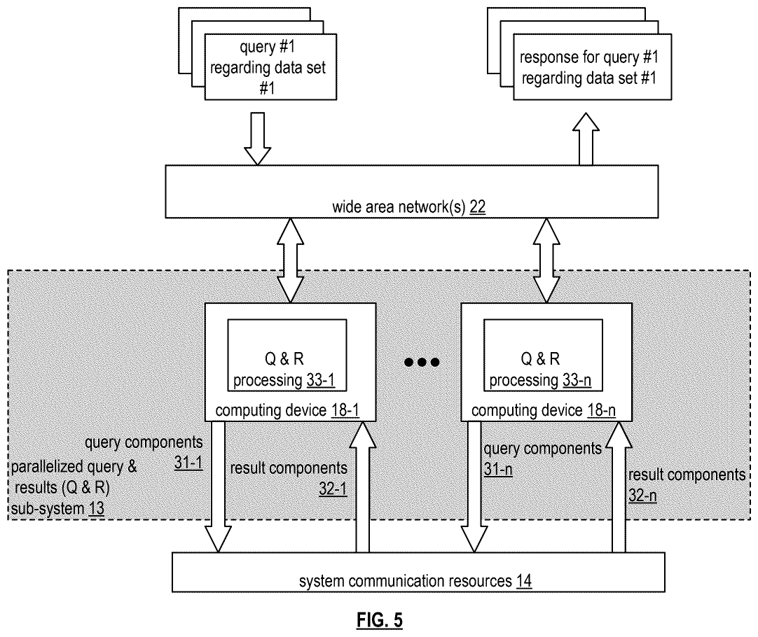

The assigned node then creates an initial query plan from the annotated abstract syntax tree. The assigned node optimizes the initial query plan using a cost analysis function (e.g., processing time, processing resources, etc.) and/or other optimization functions. Having produced the optimized query plan, the parallelized query and response sub-system 13 sends the optimized query plan to the parallelized data store, retrieve, and/or process sub-system 12 for execution. The operation of the parallelized query and response sub-system 13 is discussed in greater detail with reference to FIG. 5.

The parallelized data store, retrieve, and/or process sub-system 12 executes the optimized query plan to produce resultants and sends the resultants to the parallelized query and response sub-system 13. Within the parallelized data store, retrieve, and/or process sub-system 12, a computing device is designated as a primary device for the query plan (e.g., optimized query plan) and receives it. The primary device processes the query plan to identify nodes within the parallelized data store, retrieve, and/or process sub-system 12 for processing the query plan. The primary device then sends appropriate portions of the query plan to the identified nodes for execution. The primary device receives responses from the identified nodes and processes them in accordance with the query plan.

The primary device of the parallelized data store, retrieve, and/or process sub-system 12 provides the resulting response (e.g., resultants) to the assigned node of the parallelized query and response sub-system 13. For example, the assigned node determines whether further processing is needed on the resulting response (e.g., joining, filtering, etc.). If not, the assigned node outputs the resulting response as the response to the query (e.g., a response for query no. 1 regarding data set no. 1). If, however, further processing is determined, the assigned node further processes the resulting response to produce the response to the query. Having received the resultants, the parallelized query and response sub-system 13 creates a response from the resultants for the data processing request.

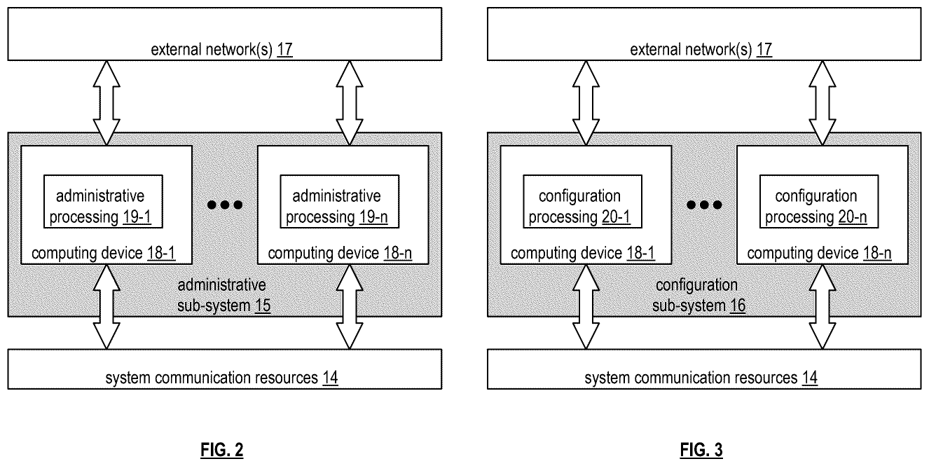

FIG. 2 is a schematic block diagram of an embodiment of the administrative sub-system 15 of FIG. 1A that includes one or more computing devices 18-1 through 18-n. Each of the computing devices executes an administrative processing function utilizing a corresponding administrative processing of administrative processing 19-1 through 19-n (which includes a plurality of administrative operations) that coordinates system level operations of the database system. Each computing device is coupled to an external network 17, or networks, and to the system communication resources 14 of FIG. 1A.

As will be described in greater detail with reference to one or more subsequent figures, a computing device includes a plurality of nodes and each node includes a plurality of processing core resources. Each processing core resource is capable of executing at least a portion of an administrative operation independently. This supports lock free and parallel execution of one or more administrative operations.

The administrative sub-system 15 functions to store metadata of the data set described with reference to FIG. 1A. For example, the storing includes generating the metadata to include one or more of an identifier of a stored table, the size of the stored table (e.g., bytes, number of columns, number of rows, etc.), labels for key fields of data segments, a data type indicator, the data owner, access permissions, available storage resources, storage resource specifications, software for operating the data processing, historical storage information, storage statistics, stored data access statistics (e.g., frequency, time of day, accessing entity identifiers, etc.) and any other information associated with optimizing operation of the database system 10.

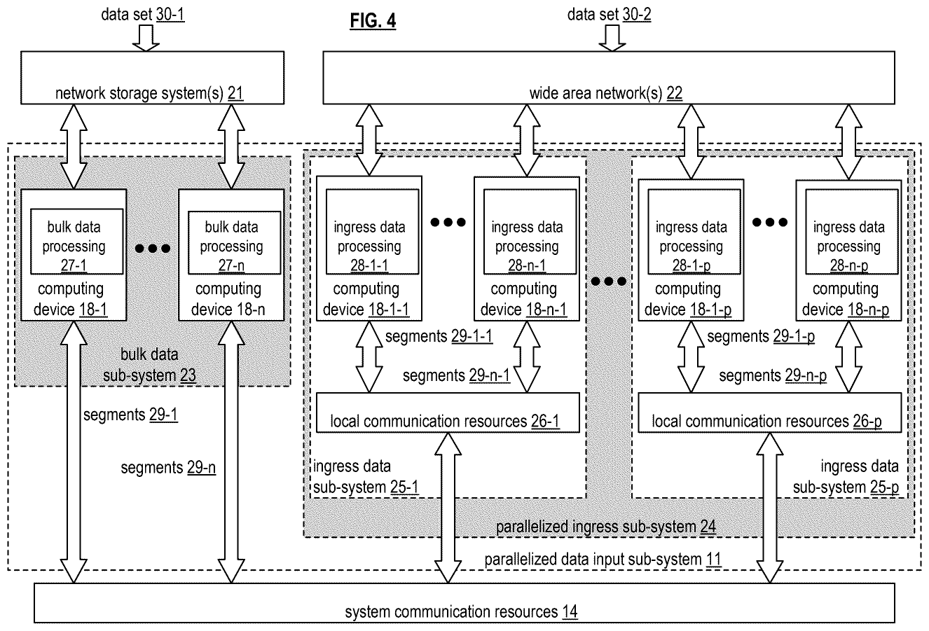

FIG. 3 is a schematic block diagram of an embodiment of the configuration sub-system 16 of FIG. 1A that includes one or more computing devices 18-1 through 18-n. Each of the computing devices executes a configuration processing function 20-1 through 20-n (which includes a plurality of configuration operations) that coordinates system level configurations of the database system. Each computing device is coupled to the external network 17 of FIG. 2, or networks, and to the system communication resources 14 of FIG. 1A.

FIG. 4 is a schematic block diagram of an embodiment of the parallelized data input sub-system 11 of FIG. 1A that includes a bulk data sub-system 23 and a parallelized ingress sub-system 24. The bulk data sub-system 23 includes a plurality of computing devices 18-1 through 18-n. A computing device includes a bulk data processing function (e.g., 27-1) for receiving a table from a network storage system 21 (e.g., a server, a cloud storage service, etc.) and processing it for storage as generally discussed with reference to FIG. 1A.

The parallelized ingress sub-system 24 includes a plurality of ingress data sub-systems 25-1 through 25-p that each include a local communication resource of local communication resources 26-1 through 26-p and a plurality of computing devices 18-1 through 18-n. A computing device executes an ingress data processing function (e.g., 28-1) to receive streaming data regarding a table via a wide area network 22 and processing it for storage as generally discussed with reference to FIG. 1A. With a plurality of ingress data sub-systems 25-1 through 25-p, data from a plurality of tables can be streamed into the database system 10 at one time.

In general, the bulk data processing function is geared towards receiving data of a table in a bulk fashion (e.g., the table exists and is being retrieved as a whole, or portion thereof). The ingress data processing function is geared towards receiving streaming data from one or more data sources (e.g., receive data of a table as the data is being generated). For example, the ingress data processing function is geared towards receiving data from a plurality of machines in a factory in a periodic or continual manner as the machines create the data.

FIG. 5 is a schematic block diagram of an embodiment of a parallelized query and results sub-system 13 that includes a plurality of computing devices 18-1 through 18-n. Each of the computing devices executes a query (Q) & response (R) processing function 33-1 through 33-n. The computing devices are coupled to the wide area network 22 to receive queries (e.g., query no. 1 regarding data set no. 1) regarding tables and to provide responses to the queries (e.g., response for query no. 1 regarding the data set no. 1). For example, a computing device (e.g., 18-1) receives a query, creates an initial query plan therefrom, and optimizes it to produce an optimized plan. The computing device then sends components (e.g., one or more operations) of the optimized plan to the parallelized data store, retrieve, &/or process sub-system 12.

Processing resources of the parallelized data store, retrieve, &/or process sub-system 12 processes the components of the optimized plan to produce results components 32-1 through 32-n. The computing device of the Q&R sub-system 13 processes the result components to produce a query response.

The Q&R sub-system 13 allows for multiple queries regarding one or more tables to be processed concurrently. For example, a set of processing core resources of a computing device (e.g., one or more processing core resources) processes a first query and a second set of processing core resources of the computing device (or a different computing device) processes a second query.

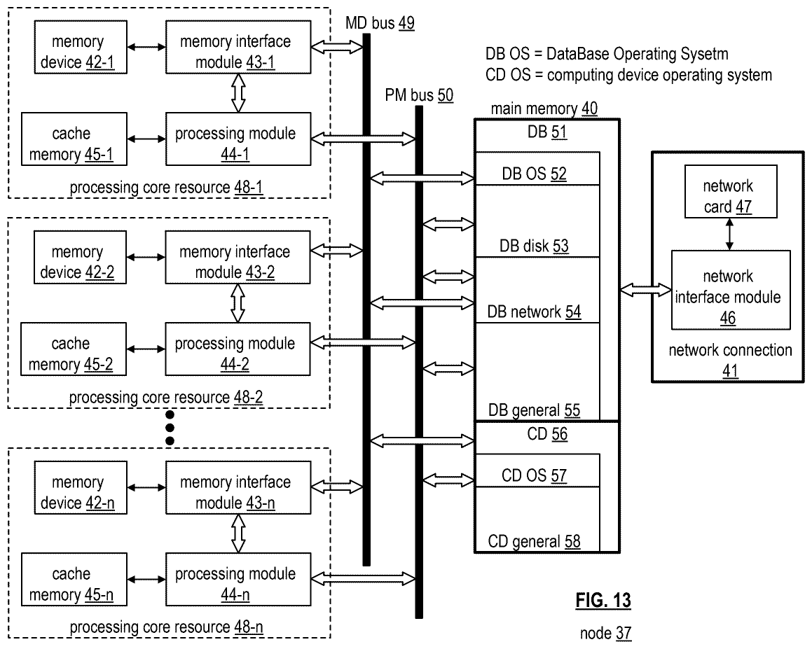

As will be described in greater detail with reference to one or more subsequent figures, a computing device includes a plurality of nodes and each node includes multiple processing core resources such that a plurality of computing devices includes pluralities of multiple processing core resources A processing core resource of the pluralities of multiple processing core resources generates the optimized query plan and other processing core resources of the pluralities of multiple processing core resources generates other optimized query plans for other data processing requests. Each processing core resource is capable of executing at least a portion of the Q & R function. In an embodiment, a plurality of processing core resources of one or more nodes executes the Q & R function to produce a response to a query. The processing core resource is discussed in greater detail with reference to FIG. 13.

FIG. 6 is a schematic block diagram of an embodiment of a parallelized data store, retrieve, and/or process sub-system 12 that includes a plurality of computing devices, where each computing device includes a plurality of nodes and each node includes multiple processing core resources. Each processing core resource is capable of executing at least a portion of the function of the parallelized data store, retrieve, and/or process sub-system 12. The plurality of computing devices is arranged into a plurality of storage clusters. Each storage cluster includes a number of computing devices.

In an embodiment, the parallelized data store, retrieve, and/or process sub-system 12 includes a plurality of storage clusters 35-1 through 35-z. Each storage cluster includes a corresponding local communication resource 26-1 through 26-z and a number of computing devices 18-1 through 18-5. Each computing device executes an input, output, and processing (IO &P) processing function 34-1 through 34-5 to store and process data.

The number of computing devices in a storage cluster corresponds to the number of segments (e.g., a segment group) in which a data partitioned is divided. For example, if a data partition is divided into five segments, a storage cluster includes five computing devices. As another example, if the data is divided into eight segments, then there are eight computing devices in the storage clusters.

To store a segment group of segments 29 within a storage cluster, a designated computing device of the storage cluster interprets storage instructions to identify computing devices (and/or processing core resources thereof) for storing the segments to produce identified engaged resources. The designated computing device is selected by a random selection, a default selection, a round-robin selection, or any other mechanism for selection.

The designated computing device sends a segment to each computing device in the storage cluster, including itself. Each of the computing devices stores their segment of the segment group. As an example, five segments 29 of a segment group are stored by five computing devices of storage cluster 35-1. The first computing device 18-1-1 stores a first segment of the segment group; a second computing device 18-2-1 stores a second segment of the segment group; and so on. With the segments stored, the computing devices are able to process queries (e.g., query components from the Q&R sub-system 13) and produce appropriate result components.

While storage cluster 35-1 is storing and/or processing a segment group, the other storage clusters 35-2 through 35-n are storing and/or processing other segment groups. For example, a table is partitioned into three segment groups. Three storage clusters store and/or process the three segment groups independently. As another example, four tables are independently stored and/or processed by one or more storage clusters. As yet another example, storage cluster 35-1 is storing and/or processing a second segment group while it is storing/or and processing a first segment group.

FIG. 7 is a schematic block diagram of an embodiment of a computing device 18 that includes a plurality of nodes 37-1 through 37-4 coupled to a computing device controller hub 36. The computing device controller hub 36 includes one or more of a chipset, a quick path interconnect (QPI), and an ultra path interconnection (UPI). Each node 37-1 through 37-4 includes a central processing module 39-1 through 39-4, a main memory 40-1 through 40-4 (e.g., volatile memory), a disk memory 38-1 through 38-4 (non-volatile memory), and a network connection 41-1 through 41-4. In an alternate configuration, the nodes share a network connection, which is coupled to the computing device controller hub 36 or to one of the nodes as illustrated in subsequent figures.

In an embodiment, each node is capable of operating independently of the other nodes. This allows for large scale parallel operation of a query request, which significantly reduces processing time for such queries. In another embodiment, one or more node function as co-processors to share processing requirements of a particular function, or functions.

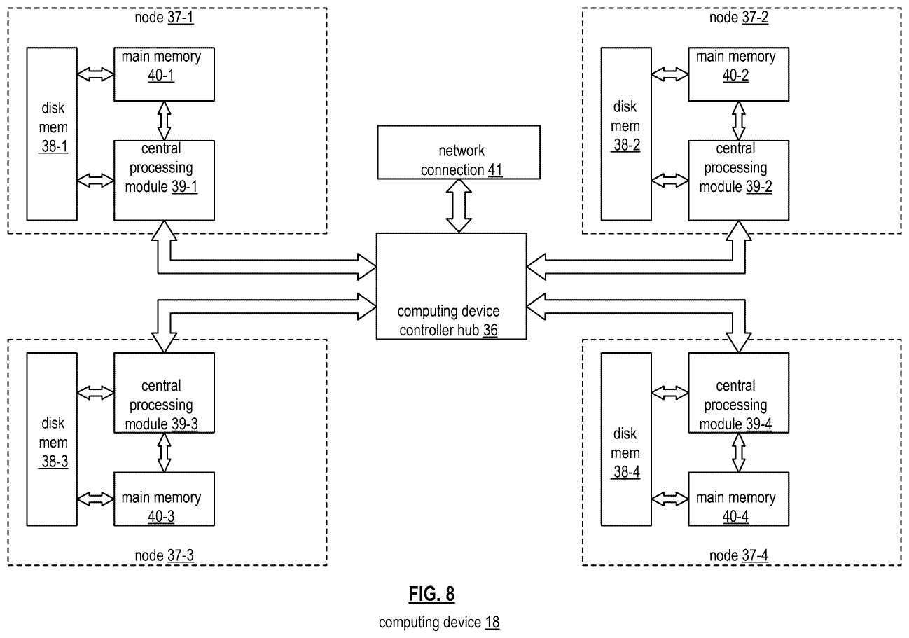

FIG. 8 is a schematic block diagram of another embodiment of a computing device similar to the computing device of FIG. 7 with an exception that it includes a single network connection 41, which is coupled to the computing device controller hub 36. As such, each node coordinates with the computing device controller hub to transmit or receive data via the network connection.

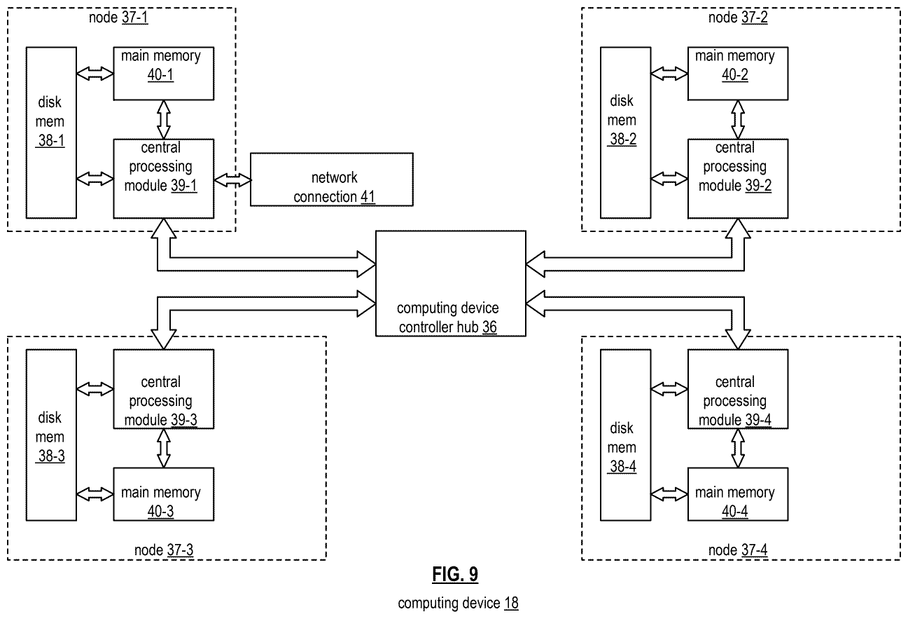

FIG. 9 is a schematic block diagram of another embodiment of a computing device is similar to the computing device of FIG. 7 with an exception that it includes a single network connection 41, which is coupled to a central processing module of a node (e.g., to central processing module 39-1 of node 37-1). As such, each node coordinates with the central processing module via the computing device controller hub 36 to transmit or receive data via the network connection.

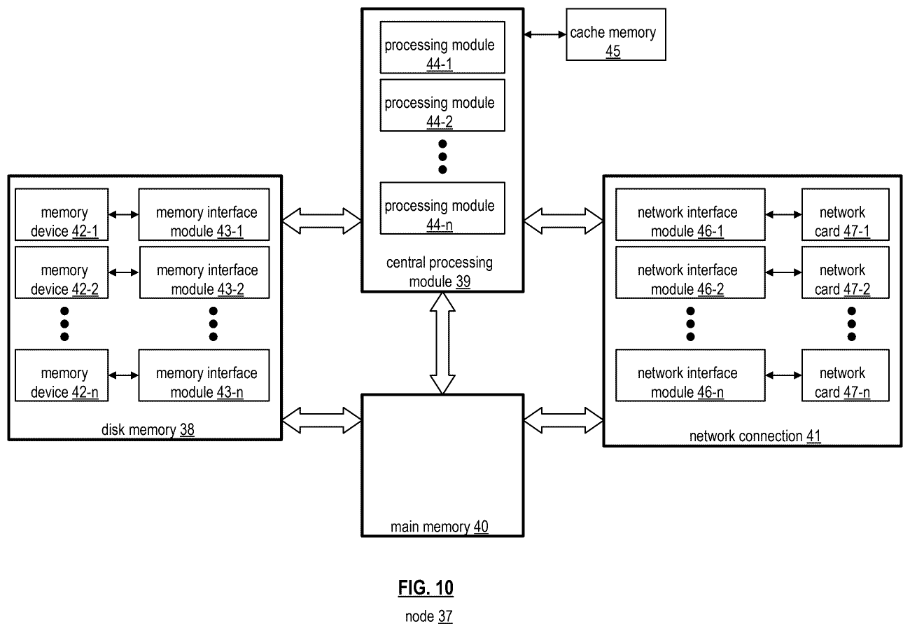

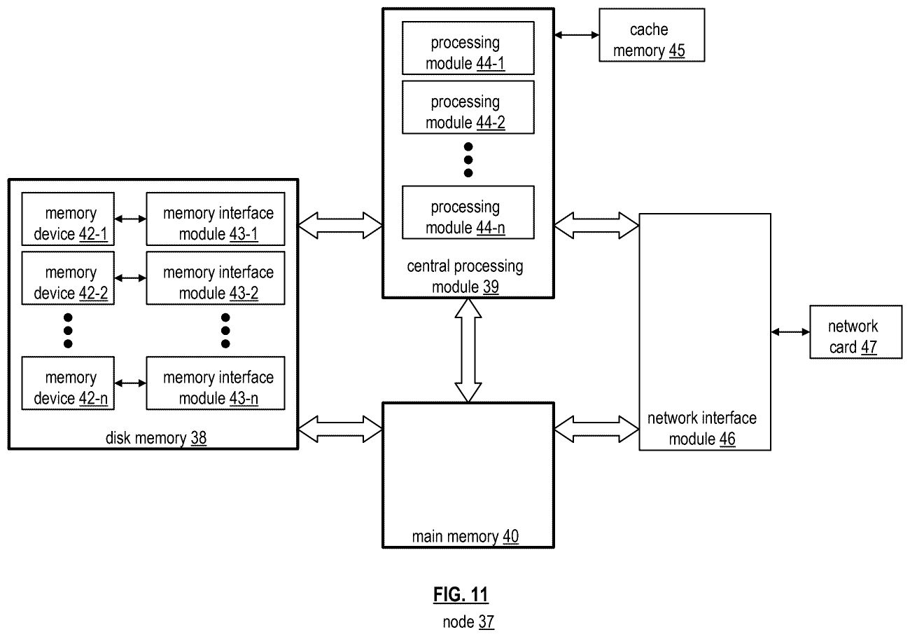

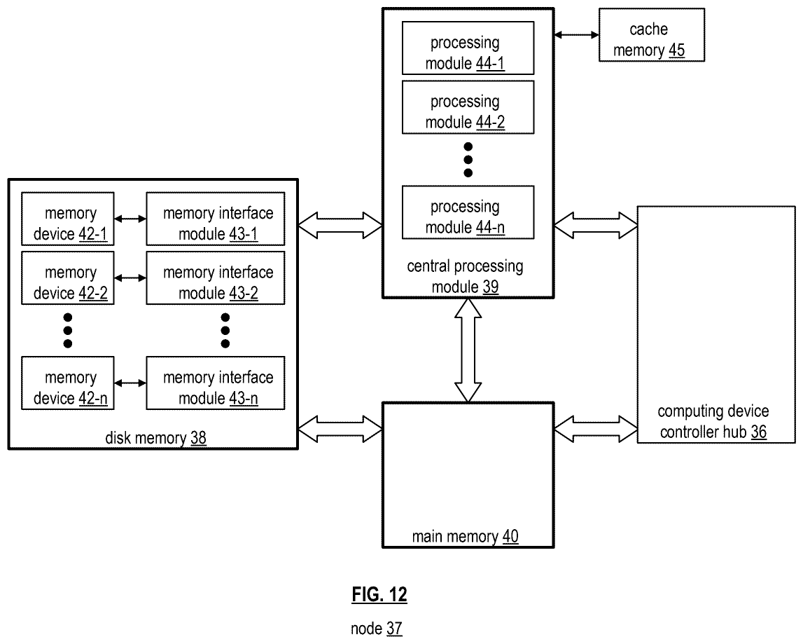

FIG. 10 is a schematic block diagram of an embodiment of a node 37 of computing device 18. The node 37 includes the central processing module 39, the main memory 40, the disk memory 38, and the network connection 41. The main memory 40 includes read only memory (RAM) and/or other form of volatile memory for storage of data and/or operational instructions of applications and/or of the operating system. The central processing module 39 includes a plurality of processing modules 44-1 through 44-n and an associated one or more cache memory 45. A processing module is as defined at the end of the detailed description.

The disk memory 38 includes a plurality of memory interface modules 43-1 through 43-n and a plurality of memory devices 42-1 through 42-n (e.g., non-volatile memory). The memory devices 42-1 through 42-n include, but are not limited to, solid state memory, disk drive memory, cloud storage memory, and other non-volatile memory. For each type of memory device, a different memory interface module 43-1 through 43-n is used. For example, solid state memory uses a standard, or serial, ATA (SATA), variation, or extension thereof, as its memory interface. As another example, disk drive memory devices use a small computer system interface (SCSI), variation, or extension thereof, as its memory interface.

In an embodiment, the disk memory 38 includes a plurality of solid state memory devices and corresponding memory interface modules. In another embodiment, the disk memory 38 includes a plurality of solid state memory devices, a plurality of disk memories, and corresponding memory interface modules.

The network connection 41 includes a plurality of network interface modules 46-1 through 46-n and a plurality of network cards 47-1 through 47-n. A network card includes a wireless LAN (WLAN) device (e.g., an IEEE 802.11n or another protocol), a LAN device (e.g., Ethernet), a cellular device (e.g., CDMA), etc. The corresponding network interface modules 46-1 through 46-n include a software driver for the corresponding network card and a physical connection that couples the network card to the central processing module 39 or other component(s) of the node.

The connections between the central processing module 39, the main memory 40, the disk memory 38, and the network connection 41 may be implemented in a variety of ways. For example, the connections are made through a node controller (e.g., a local version of the computing device controller hub 36). As another example, the connections are made through the computing device controller hub 36.

FIG. 11 is a schematic block diagram of an embodiment of a node 37 of a computing device 18 that is similar to the node of FIG. 10, with a difference in the network connection. In this embodiment, the node 37 includes a single network interface module 46 and a corresponding network card 47 configuration.

FIG. 12 is a schematic block diagram of an embodiment of a node 37 of a computing device 18 that is similar to the node of FIG. 10, with a difference in the network connection. In this embodiment, the node 37 connects to a network connection via the computing device controller hub 36.

FIG. 13 is a schematic block diagram of another embodiment of a node 37 of computing device 18 that includes processing core resources 48-1 through 48-n, a memory device (MD) bus 49, a processing module (PM) bus 50, a main memory 40 and a network connection 41. The network connection 41 includes the network card 47 and the network interface module 46 of FIG. 10. Each processing core resource 48 includes a corresponding processing module 44-1 through 44-n, a corresponding memory interface module 43-1 through 43-n, a corresponding memory device 42-1 through 42-n, and a corresponding cache memory 45-1 through 45-n. In this configuration, each processing core resource can operate independently of the other processing core resources. This further supports increased parallel operation of database functions to further reduce execution time.

The main memory 40 is divided into a computing device (CD) 56 section and a database (DB) 51 section. The database section includes a database operating system (OS) area 52, a disk area 53, a network area 54, and a general area 55. The computing device section includes a computing device operating system (OS) area 57 and a general area 58. Note that each section could include more or less allocated areas for various tasks being executed by the database system.

In general, the database OS 52 allocates main memory for database operations. Once allocated, the computing device OS 57 cannot access that portion of the main memory 40. This supports lock free and independent parallel execution of one or more operations.

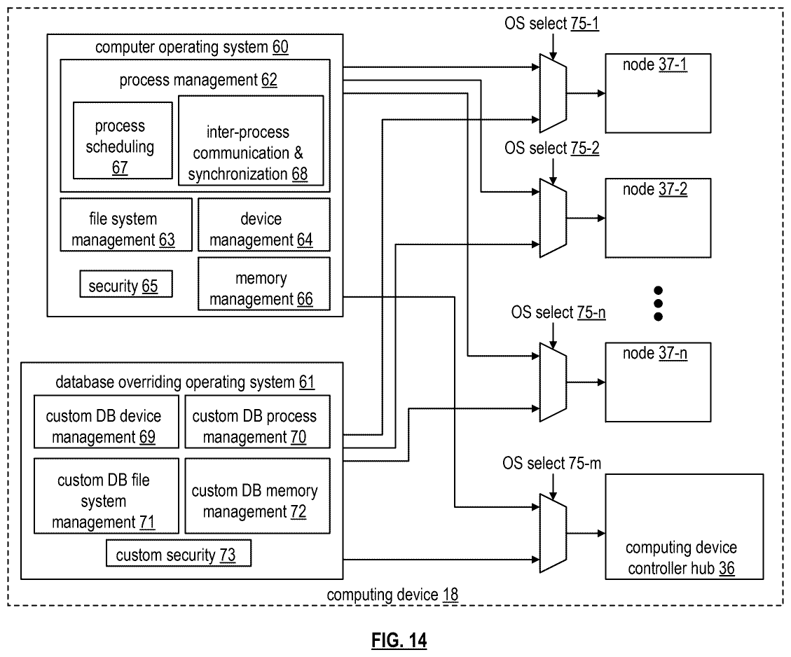

FIG. 14 is a schematic block diagram of an embodiment of operating systems of a computing device 18. The computing device 18 includes a computer operating system 60 and a database overriding operating system (DB OS) 61. The computer OS 60 includes process management 62, file system management 63, device management 64, memory management 66, and security 65. The processing management 62 generally includes process scheduling 67 and inter-process communication and synchronization 68. In general, the computer OS 60 is a conventional operating system used by a variety of types of computing devices. For example, the computer operating system is a personal computer operating system, a server operating system, a tablet operating system, a cell phone operating system, etc.

The database overriding operating system (DB OS) 61 includes custom DB device management 69, custom DB process management 70 (e.g., process scheduling and/or inter-process communication & synchronization), custom DB file system management 71, custom DB memory management 72, and/or custom security 73. In general, the database overriding OS 61 provides hardware components of a node for more direct access to memory, more direct access to a network connection, improved independency, improved data storage, improved data retrieval, and/or improved data processing than the computing device OS.

In an example of operation, the database overriding OS 61 controls which operating system, or portions thereof, operate with each node and/or computing device controller hub of a computing device (e.g., via OS select 75-1 through 75-n when communicating with nodes 37-1 through 37-n and via OS select 75-m when communicating with the computing device controller hub 36). For example, device management of a node is supported by the computer operating system, while process management, memory management, and file system management are supported by the database overriding operating system. To override the computer OS, the database overriding OS provides instructions to the computer OS regarding which management tasks will be controlled by the database overriding OS. The database overriding OS also provides notification to the computer OS as to which sections of the main memory it is reserving exclusively for one or more database functions, operations, and/or tasks. One or more examples of the database overriding operating system are provided in subsequent figures.

The database system 10 can be implemented as a massive scale database system that is operable to process data at a massive scale. As used herein, a massive scale refers to a massive number of records of a single dataset and/or many datasets, such as millions, billions, and/or trillions of records that collectively include many Gigabytes, Terabytes, Petabytes, and/or Exabytes of data. As used herein, a massive scale database system refers to a database system operable to process data at a massive scale. The processing of data at this massive scale can be achieved via a large number, such as hundreds, thousands, and/or millions of computing devices 18, nodes 37, and/or processing core resources 48 performing various functionality of database system 10 described herein in parallel, for example, independently and/or without coordination.

Such processing of data at this massive scale cannot practically be performed by the human mind. In particular, the human mind is not equipped to perform processing of data at a massive scale. Furthermore, the human mind is not equipped to perform hundreds, thousands, and/or millions of independent processes in parallel, within overlapping time spans. The embodiments of database system 10 discussed herein improves the technology of database systems by enabling data to be processed at a massive scale efficiently and/or reliably.

In particular, the database system 10 can be operable to receive data and/or to store received data at a massive scale. For example, the parallelized input and/or storing of data by the database system 10 achieved by utilizing the parallelized data input sub-system 11 and/or the parallelized data store, retrieve, and/or process sub-system 12 can cause the database system 10 to receive records for storage at a massive scale, where millions, billions, and/or trillions of records that collectively include many Gigabytes, Terabytes, Petabytes, and/or Exabytes can be received for storage, for example, reliably, redundantly and/or with a guarantee that no received records are missing in storage and/or that no received records are duplicated in storage. This can include processing real-time and/or near-real time data streams from one or more data sources at a massive scale based on facilitating ingress of these data streams in parallel. To meet the data rates required by these one or more real-time data streams, the processing of incoming data streams can be distributed across hundreds, thousands, and/or millions of computing devices 18, nodes 37, and/or processing core resources 48 for separate, independent processing with minimal and/or no coordination. The processing of incoming data streams for storage at this scale and/or this data rate cannot practically be performed by the human mind. The processing of incoming data streams for storage at this scale and/or this data rate improves database system by enabling greater amounts of data to be stored in databases for analysis and/or by enabling real-time data to be stored and utilized for analysis. The resulting richness of data stored in the database system can improve the technology of database systems by improving the depth and/or insights of various data analyses performed upon this massive scale of data.

Additionally, the database system 10 can be operable to perform queries upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to retrieve stored records at a massive scale and/or to and/or filter, aggregate, and/or perform query operators upon records at a massive scale in conjunction with query execution, where millions, billions, and/or trillions of records that collectively include many Gigabytes, Terabytes, Petabytes, and/or Exabytes can be accessed and processed in accordance with execution of one or more queries at a given time, for example, reliably, redundantly and/or with a guarantee that no records are inadvertently missing from representation in a query resultant and/or duplicated in a query resultant. To execute a query against a massive scale of records in a reasonable amount of time such as a small number of seconds, minutes, or hours, the processing of a given query can be distributed across hundreds, thousands, and/or millions of computing devices 18, nodes 37, and/or processing core resources 48 for separate, independent processing with minimal and/or no coordination. The processing of queries at this massive scale and/or this data rate cannot practically be performed by the human mind. The processing of queries at this massive scale improves the technology of database systems by facilitating greater depth and/or insights of query resultants for queries performed upon this massive scale of data.

Furthermore, the database system 10 can be operable to perform multiple queries concurrently upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to perform multiple queries concurrently, for example, in parallel, against data at this massive scale, where hundreds and/or thousands of queries can be performed against the same, massive scale dataset within a same time frame and/or in overlapping time frames. To execute multiple concurrent queries against a massive scale of records in a reasonable amount of time such as a small number of seconds, minutes, or hours, the processing of a multiple queries can be distributed across hundreds, thousands, and/or millions of computing devices 18, nodes 37, and/or processing core resources 48 for separate, independent processing with minimal and/or no coordination. A given computing devices 18, nodes 37, and/or processing core resources 48 may be responsible for participating in execution of multiple queries at a same time and/or within a given time frame, where its execution of different queries occurs within overlapping time frames. The processing of many concurrent queries at this massive scale and/or this data rate cannot practically be performed by the human mind. The processing of concurrent queries improves the technology of database systems by facilitating greater numbers of users and/or greater numbers of analyses to be serviced within a given time frame and/or over time.

FIGS. 15-23 are schematic block diagrams of an example of processing a table or data set for storage in the database system 10. FIG. 15 illustrates an example of a data set or table that includes 32 columns and 80 rows, or records, that is received by the parallelized data input-subsystem. This is a very small table, but is sufficient for illustrating one or more concepts regarding one or more aspects of a database system. The table is representative of a variety of data ranging from insurance data, to financial data, to employee data, to medical data, and so on.

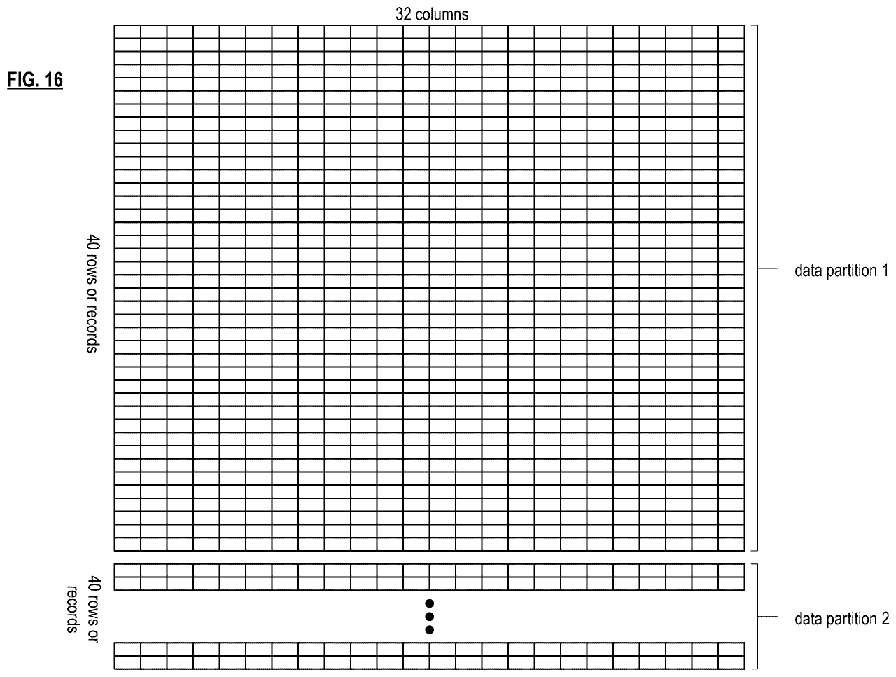

FIG. 16 illustrates an example of the parallelized data input-subsystem dividing the data set into two partitions. Each of the data partitions includes 40 rows, or records, of the data set. In another example, the parallelized data input-subsystem divides the data set into more than two partitions. In yet another example, the parallelized data input-subsystem divides the data set into many partitions and at least two of the partitions have a different number of rows.

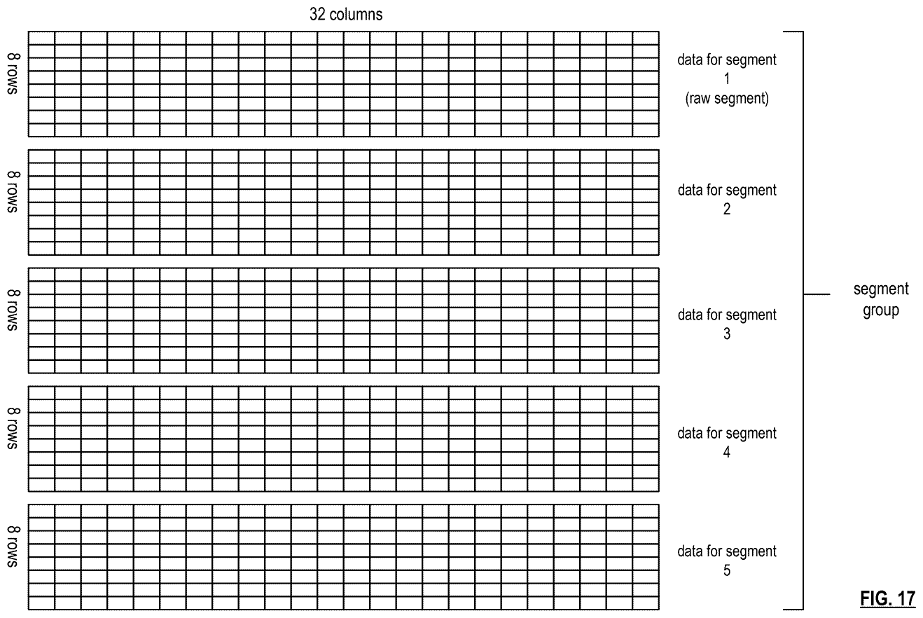

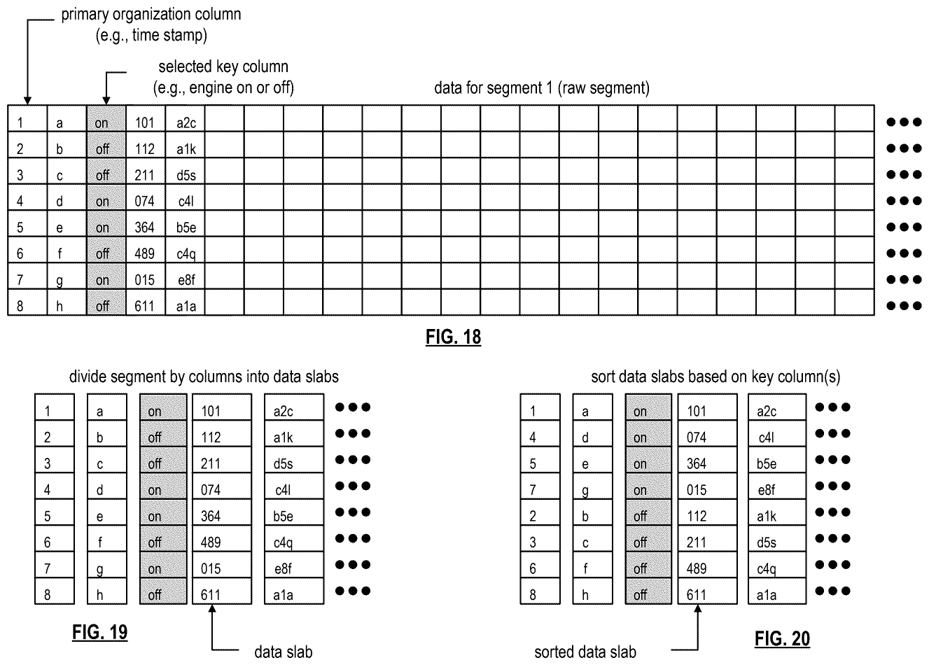

FIG. 17 illustrates an example of the parallelized data input-subsystem dividing a data partition into a plurality of segments to form a segment group. The number of segments in a segment group is a function of the data redundancy encoding. In this example, the data redundancy encoding is single parity encoding from four data pieces; thus, five segments are created. In another example, the data redundancy encoding is a two parity encoding from four data pieces; thus, six segments are created. In yet another example, the data redundancy encoding is single parity encoding from seven data pieces; thus, eight segments are created.

FIG. 18 illustrates an example of data for segment 1 of the segments of FIG. 17. The segment is in a raw form since it has not yet been key column sorted. As shown, segment 1 includes 8 rows and 32 columns. The third column is selected as the key column and the other columns store various pieces of information for a given row (i.e., a record). The key column may be selected in a variety of ways. For example, the key column is selected based on a type of query (e.g., a query regarding a year, where a data column is selected as the key column). As another example, the key column is selected in accordance with a received input command that identified the key column. As yet another example, the key column is selected as a default key column (e.g., a date column, an ID column, etc.)

As an example, the table is regarding a fleet of vehicles. Each row represents data regarding a unique vehicle. The first column stores a vehicle ID, the second column stores make and model information of the vehicle. The third column stores data as to whether the vehicle is on or off. The remaining columns store data regarding the operation of the vehicle such as mileage, gas level, oil level, maintenance information, routes taken, etc.

With the third column selected as the key column, the other columns of the segment are to be sorted based on the key column. Prior to being sorted, the columns are separated to form data slabs. As such, one column is separated out to form one data slab.

FIG. 19 illustrates an example of the parallelized data input-subsystem dividing segment 1 of FIG. 18 into a plurality of data slabs. A data slab is a column of segment 1. In this figure, the data of the data slabs has not been sorted. Once the columns have been separated into data slabs, each data slab is sorted based on the key column. Note that more than one key column may be selected and used to sort the data slabs based on two or more other columns.

FIG. 20 illustrates an example of the parallelized data input-subsystem sorting the each of the data slabs based on the key column. In this example, the data slabs are sorted based on the third column which includes data of “on” or “off”. The rows of a data slab are rearranged based on the key column to produce a sorted data slab. Each segment of the segment group is divided into similar data slabs and sorted by the same key column to produce sorted data slabs.

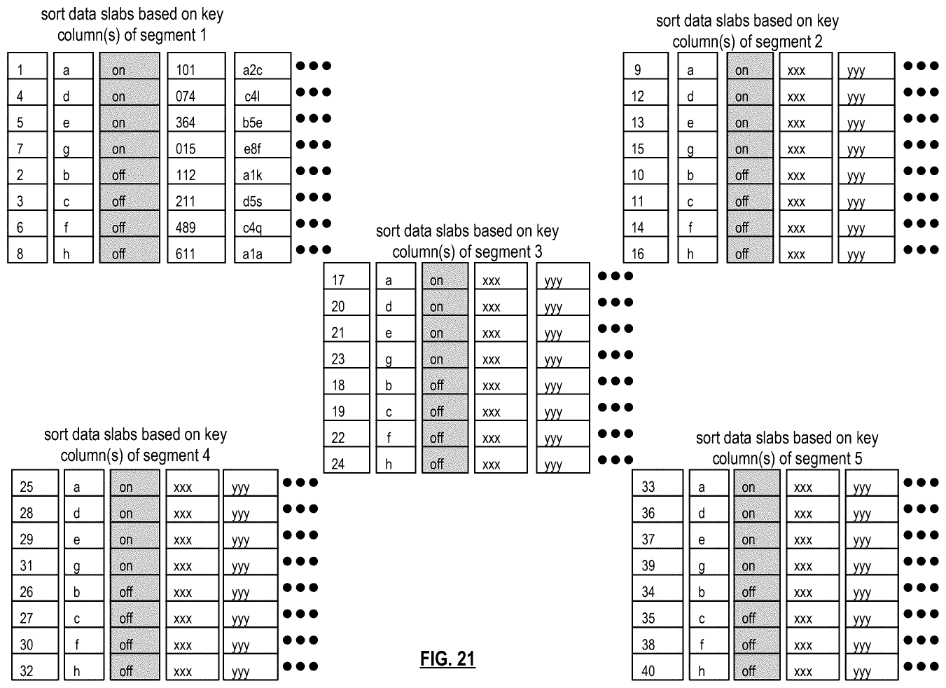

FIG. 21 illustrates an example of each segment of the segment group sorted into sorted data slabs. The similarity of data from segment to segment is for the convenience of illustration. Note that each segment has its own data, which may or may not be similar to the data in the other sections.

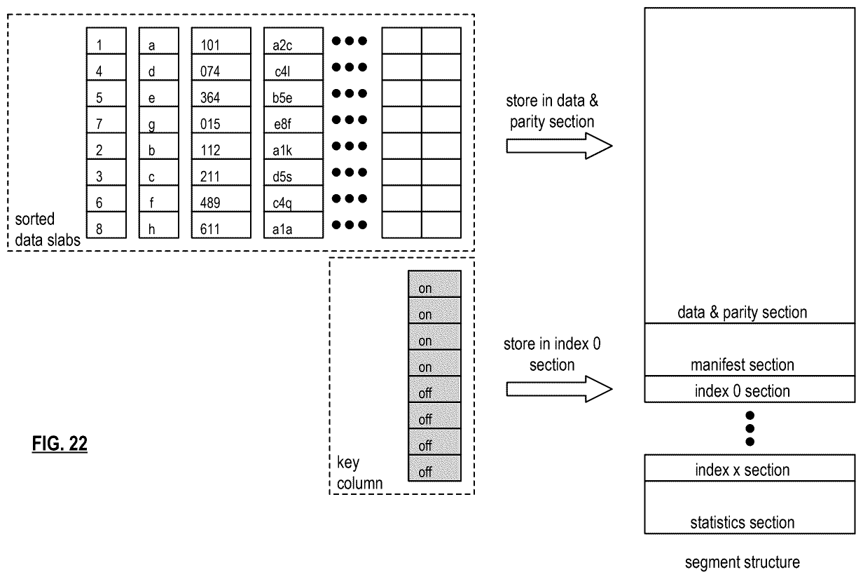

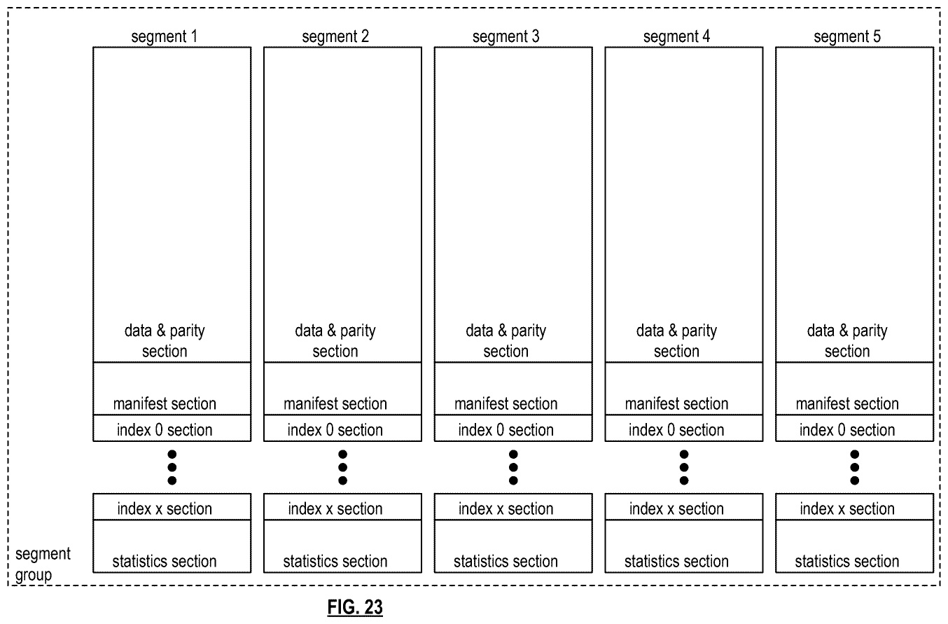

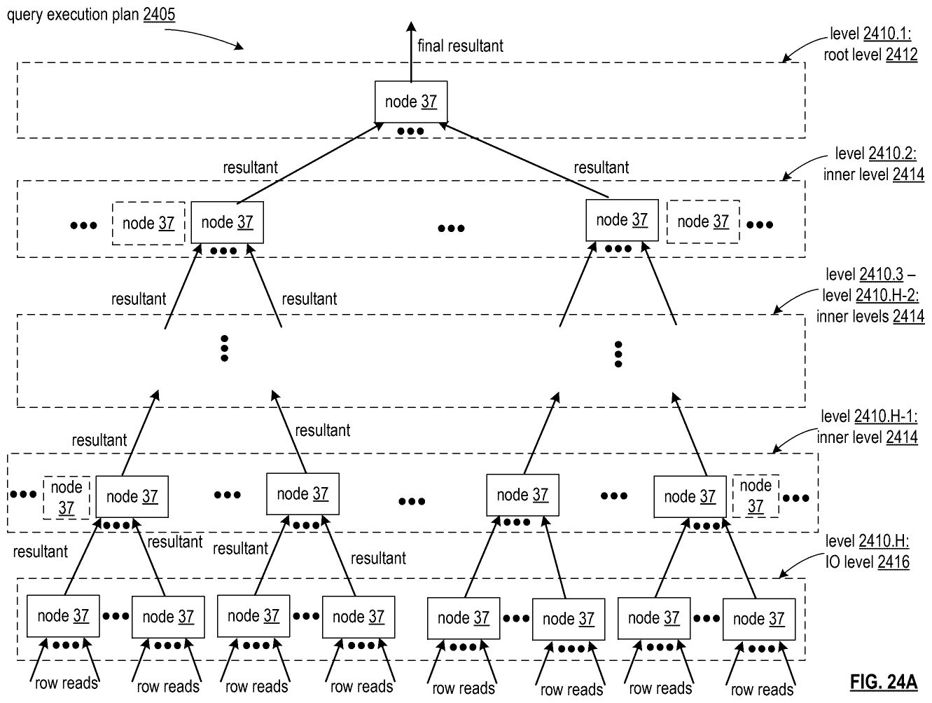

FIG. 22 illustrates an example of a segment structure for a segment of the segment group. The segment structure for a segment includes the data & parity section, a manifest section, one or more index sections, and a statistics section. The segment structure represents a storage mapping of the data (e.g., data slabs and parity data) of a segment and associated data (e.g., metadata, statistics, key column(s), etc.) regarding the data of the segment. The sorted data slabs of FIG. 16 of the segment are stored in the data & parity section of the segment structure. The sorted data slabs are stored in the data & parity section in a compressed format or as raw data (i.e., non-compressed format). Note that a segment structure has a particular data size (e.g., 32 Giga-Bytes) and data is stored within coding block sizes (e.g., 4 Kilo-Bytes).

Before the sorted data slabs are stored in the data & parity section, or concurrently with storing in the data & parity section, the sorted data slabs of a segment are redundancy encoded. The redundancy encoding may be done in a variety of ways. For example, the redundancy encoding is in accordance with RAID 5, RAID 6, or RAID 10. As another example, the redundancy encoding is a form of forward error encoding (e.g., Reed Solomon, Trellis, etc.). As another example, the redundancy encoding utilizes an erasure coding scheme.

The manifest section stores metadata regarding the sorted data slabs. The metadata includes one or more of, but is not limited to, descriptive metadata, structural metadata, and/or administrative metadata. Descriptive metadata includes one or more of, but is not limited to, information regarding data such as name, an abstract, keywords, author, etc. Structural metadata includes one or more of, but is not limited to, structural features of the data such as page size, page ordering, formatting, compression information, redundancy encoding information, logical addressing information, physical addressing information, physical to logical addressing information, etc. Administrative metadata includes one or more of, but is not limited to, information that aids in managing data such as file type, access privileges, rights management, preservation of the data, etc.

The key column is stored in an index section. For example, a first key column is stored in index #0. If a second key column exists, it is stored in index #1. As such, for each key column, it is stored in its own index section. Alternatively, one or more key columns are stored in a single index section.

The statistics section stores statistical information regarding the segment and/or the segment group. The statistical information includes one or more of, but is not limited, to number of rows (e.g., data values) in one or more of the sorted data slabs, average length of one or more of the sorted data slabs, average row size (e.g., average size of a data value), etc. The statistical information includes information regarding raw data slabs, raw parity data, and/or compressed data slabs and parity data.

FIG. 23 illustrates the segment structures for each segment of a segment group having five segments. Each segment includes a data & parity section, a manifest section, one or more index sections, and a statistic section. Each segment is targeted for storage in a different computing device of a storage cluster. The number of segments in the segment group corresponds to the number of computing devices in a storage cluster. In this example, there are five computing devices in a storage cluster. Other examples include more or less than five computing devices in a storage cluster.

FIG. 24A illustrates an example of a query execution plan 2405 implemented by the database system 10 to execute one or more queries by utilizing a plurality of nodes 37. Each node 37 can be utilized to implement some or all of the plurality of nodes 37 of some or all computing devices 18-1-18-n, for example, of the of the parallelized data store, retrieve, and/or process sub-system 12, and/or of the parallelized query and results sub-system 13. The query execution plan can include a plurality of levels 2410. In this example, a plurality of H levels in a corresponding tree structure of the query execution plan 2405 are included. The plurality of levels can include a top, root level 2412; a bottom, IO level 2416, and one or more inner levels 2414. In some embodiments, there is exactly one inner level 2414, resulting in a tree of exactly three levels 2410.1, 2410.2, and 2410.3, where level 2410.H corresponds to level 2410.3. In such embodiments, level 2410.2 is the same as level 2410.H−1, and there are no other inner levels 2410.3-2410.H−2. Alternatively, any number of multiple inner levels 2414 can be implemented to result in a tree with more than three levels.

This illustration of query execution plan 2405 illustrates the flow of execution of a given query by utilizing a subset of nodes across some or all of the levels 2410. In this illustration, nodes 37 with a solid outline are nodes involved in executing a given query. Nodes 37 with a dashed outline are other possible nodes that are not involved in executing the given query, but could be involved in executing other queries in accordance with their level of the query execution plan in which they are included.

Each of the nodes of IO level 2416 can be operable to, for a given query, perform the necessary row reads for gathering corresponding rows of the query. These row reads can correspond to the segment retrieval to read some or all of the rows of retrieved segments determined to be required for the given query. Thus, the nodes 37 in level 2416 can include any nodes 37 operable to retrieve segments for query execution from its own storage or from storage by one or more other nodes; to recover segment for query execution via other segments in the same segment grouping by utilizing the redundancy error encoding scheme; and/or to determine which exact set of segments is assigned to the node for retrieval to ensure queries are executed correctly.

IO level 2416 can include all nodes in a given storage cluster 35 and/or can include some or all nodes in multiple storage clusters 35, such as all nodes in a subset of the storage clusters 35-1-35-z and/or all nodes in all storage clusters 35-1-35-z. For example, all nodes 37 and/or all currently available nodes 37 of the database system 10 can be included in level 2416. As another example, IO level 2416 can include a proper subset of nodes in the database system, such as some or all nodes that have access to stored segments and/or that are included in a segment set. In some cases, nodes 37 that do not store segments included in segment sets, that do not have access to stored segments, and/or that are not operable to perform row reads are not included at the IO level, but can be included at one or more inner levels 2414 and/or root level 2412.

The query executions discussed herein by nodes in accordance with executing queries at level 2416 can include retrieval of segments; extracting some or all necessary rows from the segments with some or all necessary columns; and sending these retrieved rows to a node at the next level 2410.H−1 as the query resultant generated by the node 37. For each node 37 at IO level 2416, the set of raw rows retrieved by the node 37 can be distinct from rows retrieved from all other nodes, for example, to ensure correct query execution. The total set of rows and/or corresponding columns retrieved by nodes 37 in the IO level for a given query can be dictated based on the domain of the given query, such as one or more tables indicated in one or more SELECT statements of the query, and/or can otherwise include all data blocks that are necessary to execute the given query.

Each inner level 2414 can include a subset of nodes 37 in the database system 10. Each level 2414 can include a distinct set of nodes 37 and/or some or more levels 2414 can include overlapping sets of nodes 37. The nodes 37 at inner levels are implemented, for each given query, to execute queries in conjunction with operators for the given query. For example, a query operator execution flow can be generated for a given incoming query, where an ordering of execution of its operators is determined, and this ordering is utilized to assign one or more operators of the query operator execution flow to each node in a given inner level 2414 for execution. For example, each node at a same inner level can be operable to execute a same set of operators for a given query, in response to being selected to execute the given query, upon incoming resultants generated by nodes at a directly lower level to generate its own resultants sent to a next higher level. In particular, each node at a same inner level can be operable to execute a same portion of a same query operator execution flow for a given query. In cases where there is exactly one inner level, each node selected to execute a query at a given inner level performs some or all of the given query's operators upon the raw rows received as resultants from the nodes at the IO level, such as the entire query operator execution flow and/or the portion of the query operator execution flow performed upon data that has already been read from storage by nodes at the IO level. In some cases, some operators beyond row reads are also performed by the nodes at the IO level. Each node at a given inner level 2414 can further perform a gather function to collect, union, and/or aggregate resultants sent from a previous level, for example, in accordance with one or more corresponding operators of the given query.

The root level 2412 can include exactly one node for a given query that gathers resultants from every node at the top-most inner level 2414. The node 37 at root level 2412 can perform additional query operators of the query and/or can otherwise collect, aggregate, and/or union the resultants from the top-most inner level 2414 to generate the final resultant of the query, which includes the resulting set of rows and/or one or more aggregated values, in accordance with the query, based on being performed on all rows required by the query. The root level node can be selected from a plurality of possible root level nodes, where different root nodes are selected for different queries. Alternatively, the same root node can be selected for all queries.

As depicted in FIG. 24A, resultants are sent by nodes upstream with respect to the tree structure of the query execution plan as they are generated, where the root node generates a final resultant of the query. While not depicted in FIG. 24A, nodes at a same level can share data and/or send resultants to each other, for example, in accordance with operators of the query at this same level dictating that data is sent between nodes.

In some cases, the IO level 2416 always includes the same set of nodes 37, such as a full set of nodes and/or all nodes that are in a storage cluster 35 that stores data required to process incoming queries. In some cases, the lowest inner level corresponding to level 2410.H−1 includes at least one node from the IO level 2416 in the possible set of nodes. In such cases, while each selected node in level 2410.H−1 is depicted to process resultants sent from other nodes 37 in FIG. 24A, each selected node in level 2410.H−1 that also operates as a node at the IO level further performs its own row reads in accordance with its query execution at the IO level, and gathers the row reads received as resultants from other nodes at the IO level with its own row reads for processing via operators of the query. One or more inner levels 2414 can also include nodes that are not included in IO level 2416, such as nodes 37 that do not have access to stored segments and/or that are otherwise not operable and/or selected to perform row reads for some or all queries.

The node 37 at root level 2412 can be fixed for all queries, where the set of possible nodes at root level 2412 includes only one node that executes all queries at the root level of the query execution plan. Alternatively, the root level 2412 can similarly include a set of possible nodes, where one node selected from this set of possible nodes for each query and where different nodes are selected from the set of possible nodes for different queries. In such cases, the nodes at inner level 2410.2 determine which of the set of possible root nodes to send their resultant to. In some cases, the single node or set of possible nodes at root level 2412 is a proper subset of the set of nodes at inner level 2410.2, and/or is a proper subset of the set of nodes at the IO level 2416. In cases where the root node is included at inner level 2410.2, the root node generates its own resultant in accordance with inner level 2410.2, for example, based on multiple resultants received from nodes at level 2410.3, and gathers its resultant that was generated in accordance with inner level 2410.2 with other resultants received from nodes at inner level 2410.2 to ultimately generate the final resultant in accordance with operating as the root level node.

In some cases where nodes are selected from a set of possible nodes at a given level for processing a given query, the selected node must have been selected for processing this query at each lower level of the query execution tree. For example, if a particular node is selected to process a node at a particular inner level, it must have processed the query to generate resultants at every lower inner level and the IO level. In such cases, each selected node at a particular level will always use its own resultant that was generated for processing at the previous, lower level, and will gather this resultant with other resultants received from other child nodes at the previous, lower level. Alternatively, nodes that have not yet processed a given query can be selected for processing at a particular level, where all resultants being gathered are therefore received from a set of child nodes that do not include the selected node.

The configuration of query execution plan 2405 for a given query can be determined in a downstream fashion, for example, where the tree is formed from the root downwards. Nodes at corresponding levels are determined from configuration information received from corresponding parent nodes and/or nodes at higher levels, and can each send configuration information to other nodes, such as their own child nodes, at lower levels until the lowest level is reached. This configuration information can include assignment of a particular subset of operators of the set of query operators that each level and/or each node will perform for the query. The execution of the query is performed upstream in accordance with the determined configuration, where IO reads are performed first, and resultants are forwarded upwards until the root node ultimately generates the query result.

Some or all features and/or functionality of FIG. 24A can be performed via at least one node 37 in conjunction with system metadata applied across a plurality of nodes 37, for example, where at least one node 37 participates in some or all features and/or functionality of FIG. 24A based on receiving and storing the system metadata in local memory of the at least one node 37 as configuration data and/or based on further accessing and/or executing this configuration data to participate in a query execution plan of FIG. 24A as part of its database functionality accordingly. Performance of some or all features and/or functionality of FIG. 24A can optionally change and/or be updated over time, and/or a set of nodes participating in executing some or all features and/or functionality of FIG. 24A can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24B illustrates an embodiment of a node 37 executing a query in accordance with the query execution plan 2405 by implementing a query processing module 2435. The query processing module 2435 can be operable to execute a query operator execution flow 2433 determined by the node 37, where the query operator execution flow 2433 corresponds to the entirety of processing of the query upon incoming data assigned to the corresponding node 37 in accordance with its role in the query execution plan 2405. This embodiment of node 37 that utilizes a query processing module 2435 can be utilized to implement some or all of the plurality of nodes 37 of some or all computing devices 18-1-18-n, for example, of the of the parallelized data store, retrieve, and/or process sub-system 12, and/or of the parallelized query and results sub-system 13.

As used herein, execution of a particular query by a particular node 37 can correspond to the execution of the portion of the particular query assigned to the particular node in accordance with full execution of the query by the plurality of nodes involved in the query execution plan 2405. This portion of the particular query assigned to a particular node can correspond to execution plurality of operators indicated by a query operator execution flow 2433. In particular, the execution of the query for a node 37 at an inner level 2414 and/or root level 2412 corresponds to generating a resultant by processing all incoming resultants received from nodes at a lower level of the query execution plan 2405 that send their own resultants to the node 37. The execution of the query for a node 37 at the IO level corresponds to generating all resultant data blocks by retrieving and/or recovering all segments assigned to the node 37.

Thus, as used herein, a node 37's full execution of a given query corresponds to only a portion of the query's execution across all nodes in the query execution plan 2405. In particular, a resultant generated by an inner level node 37's execution of a given query may correspond to only a portion of the entire query result, such as a subset of rows in a final result set, where other nodes generate their own resultants to generate other portions of the full resultant of the query. In such embodiments, a plurality of nodes at this inner level can fully execute queries on different portions of the query domain independently in parallel by utilizing the same query operator execution flow 2433. Resultants generated by each of the plurality of nodes at this inner level 2414 can be gathered into a final result of the query, for example, by the node 37 at root level 2412 if this inner level is the top-most inner level 2414 or the only inner level 2414. As another example, resultants generated by each of the plurality of nodes at this inner level 2414 can be further processed via additional operators of a query operator execution flow 2433 being implemented by another node at a consecutively higher inner level 2414 of the query execution plan 2405, where all nodes at this consecutively higher inner level 2414 all execute their own same query operator execution flow 2433.

As discussed in further detail herein, the resultant generated by a node 37 can include a plurality of resultant data blocks generated via a plurality of partial query executions. As used herein, a partial query execution performed by a node corresponds to generating a resultant based on only a subset of the query input received by the node 37. In particular, the query input corresponds to all resultants generated by one or more nodes at a lower level of the query execution plan that send their resultants to the node. However, this query input can correspond to a plurality of input data blocks received over time, for example, in conjunction with the one or more nodes at the lower level processing their own input data blocks received over time to generate their resultant data blocks sent to the node over time. Thus, the resultant generated by a node's full execution of a query can include a plurality of resultant data blocks, where each resultant data block is generated by processing a subset of all input data blocks as a partial query execution upon the subset of all data blocks via the query operator execution flow 2433.

As illustrated in FIG. 24B, the query processing module 2435 can be implemented by a single processing core resource 48 of the node 37. In such embodiments, each one of the processing core resources 48-1-48-n of a same node 37 can be executing at least one query concurrently via their own query processing module 2435, where a single node 37 implements each of set of operator processing modules 2435-1-2435-n via a corresponding one of the set of processing core resources 48-1-48-n. A plurality of queries can be concurrently executed by the node 37, where each of its processing core resources 48 can each independently execute at least one query within a same temporal period by utilizing a corresponding at least one query operator execution flow 2433 to generate at least one query resultant corresponding to the at least one query.

Some or all features and/or functionality of FIG. 24B can be performed via a corresponding node 37 in conjunction with system metadata applied across a plurality of nodes 37 that includes the given node, for example, where the given node 37 participates in some or all features and/or functionality of FIG. 24B based on receiving and storing the system metadata in local memory of given node 37 as configuration data and/or based on further accessing and/or executing this configuration data to process data blocks via a query processing module as part of its database functionality accordingly. Performance of some or all features and/or functionality of FIG. 24B can optionally change and/or be updated over time, based on the system metadata applied across a plurality of nodes 37 that includes the given node being updated over time, and/or based on the given node updating its configuration data stored in local memory to reflect changes in the system metadata based on receiving data indicating these changes to the system metadata.

FIG. 24C illustrates a particular example of a node 37 at the IO level 2416 of the query execution plan 2405 of FIG. 24A. A node 37 can utilize its own memory resources, such as some or all of its disk memory 38 and/or some or all of its main memory 40 to implement at least one memory drive 2425 that stores a plurality of segments 2424. Memory drives 2425 of a node 37 can be implemented, for example, by utilizing disk memory 38 and/or main memory 40. In particular, a plurality of distinct memory drives 2425 of a node 37 can be implemented via the plurality of memory devices 42-1-42-n of the node 37's disk memory 38.

Each segment 2424 stored in memory drive 2425 can be generated as discussed previously in conjunction with FIGS. 15-23. A plurality of records 2422 can be included in and/or extractable from the segment, for example, where the plurality of records 2422 of a segment 2424 correspond to a plurality of rows designated for the particular segment 2424 prior to applying the redundancy storage coding scheme as illustrated in FIG. 17. The records 2422 can be included in data of segment 2424, for example, in accordance with a column-format and/or other structured format. Each segments 2424 can further include parity data 2426 as discussed previously to enable other segments 2424 in the same segment group to be recovered via applying a decoding function associated with the redundancy storage coding scheme, such as a RAID scheme and/or erasure coding scheme, that was utilized to generate the set of segments of a segment group.

Thus, in addition to performing the first stage of query execution by being responsible for row reads, nodes 37 can be utilized for database storage, and can each locally store a set of segments in its own memory drives 2425. In some cases, a node 37 can be responsible for retrieval of only the records stored in its own one or more memory drives 2425 as one or more segments 2424. Executions of queries corresponding to retrieval of records stored by a particular node 37 can be assigned to that particular node 37. In other embodiments, a node 37 does not use its own resources to store segments. A node 37 can access its assigned records for retrieval via memory resources of another node 37 and/or via other access to memory drives 2425, for example, by utilizing system communication resources 14.

The query processing module 2435 of the node 37 can be utilized to read the assigned by first retrieving or otherwise accessing the corresponding redundancy-coded segments 2424 that include the assigned records its one or more memory drives 2425. Query processing module 2435 can include a record extraction module 2438 that is then utilized to extract or otherwise read some or all records from these segments 2424 accessed in memory drives 2425, for example, where record data of the segment is segregated from other information such as parity data included in the segment and/or where this data containing the records is converted into row-formatted records from the column-formatted row data stored by the segment. Once the necessary records of a query are read by the node 37, the node can further utilize query processing module 2435 to send the retrieved records all at once, or in a stream as they are retrieved from memory drives 2425, as data blocks to the next node 37 in the query execution plan 2405 via system communication resources 14 or other communication channels.

Some or all features and/or functionality of FIG. 24C can be performed via a corresponding node 37 in conjunction with system metadata applied across a plurality of nodes 37 that includes the given node, for example, where the given node 37 participates in some or all features and/or functionality of FIG. 24C based on receiving and storing the system metadata in local memory of given node 37 as configuration data and/or based on further accessing and/or executing this configuration data to read segments and/or extract rows from segments via a query processing module as part of its database functionality accordingly. Performance of some or all features and/or functionality of FIG. 24C can optionally change and/or be updated over time, based on the system metadata applied across a plurality of nodes 37 that includes the given node being updated over time, and/or based on the given node updating its configuration data stored in local memory to reflect changes in the system metadata based on receiving data indicating these changes to the system metadata.

FIG. 24D illustrates an embodiment of a node 37 that implements a segment recovery module 2439 to recover some or all segments that are assigned to the node for retrieval, in accordance with processing one or more queries, that are unavailable. Some or all features of the node 37 of FIG. 24D can be utilized to implement the node 37 of FIGS. 24B and 24C, and/or can be utilized to implement one or more nodes 37 of the query execution plan 2405 of FIG. 24A, such as nodes 37 at the IO level 2416. A node 37 may store segments on one of its own memory drives 2425 that becomes unavailable, or otherwise determines that a segment assigned to the node for execution of a query is unavailable for access via a memory drive the node 37 accesses via system communication resources 14. The segment recovery module 2439 can be implemented via at least one processing module of the node 37, such as resources of central processing module 39. The segment recovery module 2439 can retrieve the necessary number of segments 1-K in the same segment group as an unavailable segment from other nodes 37, such as a set of other nodes 37-1-37-K that store segments in the same storage cluster 35. Using system communication resources 14 or other communication channels, a set of external retrieval requests 1-K for this set of segments 1-K can be sent to the set of other nodes 37-1-37-K, and the set of segments can be received in response. This set of K segments can be processed, for example, where a decoding function is applied based on the redundancy storage coding scheme utilized to generate the set of segments in the segment group and/or parity data of this set of K segments is otherwise utilized to regenerate the unavailable segment. The necessary records can then be extracted from the unavailable segment, for example, via the record extraction module 2438, and can be sent as data blocks to another node 37 for processing in conjunction with other records extracted from available segments retrieved by the node 37 from its own memory drives 2425.

Note that the embodiments of node 37 discussed herein can be configured to execute multiple queries concurrently by communicating with nodes 37 in the same or different tree configuration of corresponding query execution plans and/or by performing query operations upon data blocks and/or read records for different queries. In particular, incoming data blocks can be received from other nodes for multiple different queries in any interleaving order, and a plurality of operator executions upon incoming data blocks for multiple different queries can be performed in any order, where output data blocks are generated and sent to the same or different next node for multiple different queries in any interleaving order. IO level nodes can access records for the same or different queries any interleaving order. Thus, at a given point in time, a node 37 can have already begun its execution of at least two queries, where the node 37 has also not yet completed its execution of the at least two queries.

A query execution plan 2405 can guarantee query correctness based on assignment data sent to or otherwise communicated to all nodes at the IO level ensuring that the set of required records in query domain data of a query, such as one or more tables required to be accessed by a query, are accessed exactly one time: if a particular record is accessed multiple times in the same query and/or is not accessed, the query resultant cannot be guaranteed to be correct. Assignment data indicating segment read and/or record read assignments to each of the set of nodes 37 at the IO level can be generated, for example, based on being mutually agreed upon by all nodes 37 at the IO level via a consensus protocol executed between all nodes at the IO level and/or distinct groups of nodes 37 such as individual storage clusters 35. The assignment data can be generated such that every record in the database system and/or in query domain of a particular query is assigned to be read by exactly one node 37. Note that the assignment data may indicate that a node 37 is assigned to read some segments directly from memory as illustrated in FIG. 24C and is assigned to recover some segments via retrieval of segments in the same segment group from other nodes 37 and via applying the decoding function of the redundancy storage coding scheme as illustrated in FIG. 24D.

Assuming all nodes 37 read all required records and send their required records to exactly one next node 37 as designated in the query execution plan 2405 for the given query, the use of exactly one instance of each record can be guaranteed. Assuming all inner level nodes 37 process all the required records received from the corresponding set of nodes 37 in the IO level 2416, via applying one or more query operators assigned to the node in accordance with their query operator execution flow 2433, correctness of their respective partial resultants can be guaranteed. This correctness can further require that nodes 37 at the same level intercommunicate by exchanging records in accordance with JOIN operations as necessary, as records received by other nodes may be required to achieve the appropriate result of a JOIN operation. Finally, assuming the root level node receives all correctly generated partial resultants as data blocks from its respective set of nodes at the penultimate, highest inner level 2414 as designated in the query execution plan 2405, and further assuming the root level node appropriately generates its own final resultant, the correctness of the final resultant can be guaranteed.

In some embodiments, each node 37 in the query execution plan can monitor whether it has received all necessary data blocks to fulfill its necessary role in completely generating its own resultant to be sent to the next node 37 in the query execution plan. A node 37 can determine receipt of a complete set of data blocks that was sent from a particular node 37 at an immediately lower level, for example, based on being numbered and/or have an indicated ordering in transmission from the particular node 37 at the immediately lower level, and/or based on a final data block of the set of data blocks being tagged in transmission from the particular node 37 at the immediately lower level to indicate it is a final data block being sent. A node 37 can determine the required set of lower level nodes from which it is to receive data blocks based on its knowledge of the query execution plan 2405 of the query. A node 37 can thus conclude when a complete set of data blocks has been received each designated lower level node in the designated set as indicated by the query execution plan 2405. This node 37 can therefore determine itself that all required data blocks have been processed into data blocks sent by this node 37 to the next node 37 and/or as a final resultant if this node 37 is the root node. This can be indicated via tagging of its own last data block, corresponding to the final portion of the resultant generated by the node, where it is guaranteed that all appropriate data was received and processed into the set of data blocks sent by this node 37 in accordance with applying its own query operator execution flow 2433.

In some embodiments, if any node 37 determines it did not receive all of its required data blocks, the node 37 itself cannot fulfill generation of its own set of required data blocks. For example, the node 37 will not transmit a final data block tagged as the “last” data block in the set of outputted data blocks to the next node 37, and the next node 37 will thus conclude there was an error and will not generate a full set of data blocks itself. The root node, and/or these intermediate nodes that never received all their data and/or never fulfilled their generation of all required data blocks, can independently determine the query was unsuccessful. In some cases, the root node, upon determining the query was unsuccessful, can initiate re-execution of the query by re-establishing the same or different query execution plan 2405 in a downward fashion as described previously, where the nodes 37 in this re-established query execution plan 2405 execute the query accordingly as though it were a new query. For example, in the case of a node failure that caused the previous query to fail, the new query execution plan 2405 can be generated to include only available nodes where the node that failed is not included in the new query execution plan 2405.

Some or all features and/or functionality of FIG. 24D can be performed via a corresponding node 37 in conjunction with system metadata applied across a plurality of nodes 37 that includes the given node, for example, where the given node 37 participates in some or all features and/or functionality of FIG. 24D based on receiving and storing the system metadata in local memory of given node 37 as configuration data and/or based on further accessing and/or executing this configuration data to recover segments via external retrieval requests and performing a rebuilding process upon corresponding segments as part of its database functionality accordingly. Performance of some or all features and/or functionality of FIG. 24D can optionally change and/or be updated over time, based on the system metadata applied across a plurality of nodes 37 that includes the given node being updated over time, and/or based on the given node updating its configuration data stored in local memory to reflect changes in the system metadata based on receiving data indicating these changes to the system metadata.

FIG. 24E illustrates an embodiment of an inner level 2414 that includes at least one shuffle node set 2485 of the plurality of nodes assigned to the corresponding inner level. A shuffle node set 2485 can include some or all of a plurality of nodes assigned to the corresponding inner level, where all nodes in the shuffle node set 2485 are assigned to the same inner level. In some cases, a shuffle node set 2485 can include nodes assigned to different levels 2410 of a query execution plan. A shuffle node set 2485 at a given time can include some nodes that are assigned to the given level, but are not participating in a query at that given time, as denoted with dashed outlines and as discussed in conjunction with FIG. 24A. For example, while a given one or more queries are being executed by nodes in the database system 10, a shuffle node set 2485 can be static, regardless of whether all of its members are participating in a given query at that time. In other cases, shuffle node set 2485 only includes nodes assigned to participate in a corresponding query, where different queries that are concurrently executing and/or executing in distinct time periods have different shuffle node sets 2485 based on which nodes are assigned to participate in the corresponding query execution plan. While FIG. 24E depicts multiple shuffle node sets 2485 of an inner level 2414, in some cases, an inner level can include exactly one shuffle node set, for example, that includes all possible nodes of the corresponding inner level 2414 and/or all participating nodes of the of the corresponding inner level 2414 in a given query execution plan.

While FIG. 24E depicts that different shuffle node sets 2485 can have overlapping nodes 37, in some cases, each shuffle node set 2485 includes a distinct set of nodes, for example, where the shuffle node sets 2485 are mutually exclusive. In some cases, the shuffle node sets 2485 are collectively exhaustive with respect to the corresponding inner level 2414, where all possible nodes of the inner level 2414, or all participating nodes of a given query execution plan at the inner level 2414, are included in at least one shuffle node set 2485 of the inner level 2414. If the query execution plan has multiple inner levels 2414, each inner level can include one or more shuffle node sets 2485. In some cases, a shuffle node set 2485 can include nodes from different inner levels 2414, or from exactly one inner level 2414. In some cases, the root level 2412 and/or the IO level 2416 have nodes included in shuffle node sets 2485. In some cases, the query execution plan 2405 includes and/or indicates assignment of nodes to corresponding shuffle node sets 2485 in addition to assigning nodes to levels 2410, where nodes 37 determine their participation in a given query as participating in one or more levels 2410 and/or as participating in one or more shuffle node sets 2485, for example, via downward propagation of this information from the root node to initiate the query execution plan 2405 as discussed previously.

The shuffle node sets 2485 can be utilized to enable transfer of information between nodes, for example, in accordance with performing particular operations in a given query that cannot be performed in isolation. For example, some queries require that nodes 37 receive data blocks from its children nodes in the query execution plan for processing, and that the nodes 37 additionally receive data blocks from other nodes at the same level 2410. In particular, query operations such as JOIN operations of a SQL query expression may necessitate that some or all additional records that were access in accordance with the query be processed in tandem to guarantee a correct resultant, where a node processing only the records retrieved from memory by its child IO nodes is not sufficient.

In some cases, a given node 37 participating in a given inner level 2414 of a query execution plan may send data blocks to some or all other nodes participating in the given inner level 2414, where these other nodes utilize these data blocks received from the given node to process the query via their query processing module 2435 by applying some or all operators of their query operator execution flow 2433 to the data blocks received from the given node. In some cases, a given node 37 participating in a given inner level 2414 of a query execution plan may receive data blocks to some or all other nodes participating in the given inner level 2414, where the given node utilizes these data blocks received from the other nodes to process the query via their query processing module 2435 by applying some or all operators of their query operator execution flow 2433 to the received data blocks.

This transfer of data blocks can be facilitated via a shuffle network 2480 of a corresponding shuffle node set 2485. Nodes in a shuffle node set 2485 can exchange data blocks in accordance with executing queries, for example, for execution of particular operators such as JOIN operators of their query operator execution flow 2433 by utilizing a corresponding shuffle network 2480. The shuffle network 2480 can correspond to any wired and/or wireless communication network that enables bidirectional communication between any nodes 37 communicating with the shuffle network 2480. In some cases, the nodes in a same shuffle node set 2485 are operable to communicate with some or all other nodes in the same shuffle node set 2485 via a direct communication link of shuffle network 2480, for example, where data blocks can be routed between some or all nodes in a shuffle network 2480 without necessitating any relay nodes 37 for routing the data blocks. In some cases, the nodes in a same shuffle set can broadcast data blocks.

In some cases, some nodes in a same shuffle node set 2485 do not have direct links via shuffle network 2480 and/or cannot send or receive broadcasts via shuffle network 2480 to some or all other nodes 37. For example, at least one pair of nodes in the same shuffle node set cannot communicate directly. In some cases, some pairs of nodes in a same shuffle node set can only communicate by routing their data via at least one relay node 37. For example, two nodes in a same shuffle node set do not have a direct communication link and/or cannot communicate via broadcasting their data blocks. However, if these two nodes in a same shuffle node set can each communicate with a same third node via corresponding direct communication links and/or via broadcast, this third node can serve as a relay node to facilitate communication between the two nodes. Nodes that are “further apart” in the shuffle network 2480 may require multiple relay nodes.

Thus, the shuffle network 2480 can facilitate communication between all nodes 37 in the corresponding shuffle node set 2485 by utilizing some or all nodes 37 in the corresponding shuffle node set 2485 as relay nodes, where the shuffle network 2480 is implemented by utilizing some or all nodes in the nodes shuffle node set 2485 and a corresponding set of direct communication links between pairs of nodes in the shuffle node set 2485 to facilitate data transfer between any pair of nodes in the shuffle node set 2485. Note that these relay nodes facilitating data blocks for execution of a given query within a shuffle node sets 2485 to implement shuffle network 2480 can be nodes participating in the query execution plan of the given query and/or can be nodes that are not participating in the query execution plan of the given query. In some cases, these relay nodes facilitating data blocks for execution of a given query within a shuffle node sets 2485 are strictly nodes participating in the query execution plan of the given query. In some cases, these relay nodes facilitating data blocks for execution of a given query within a shuffle node sets 2485 are strictly nodes that are not participating in the query execution plan of the given query.

Different shuffle node sets 2485 can have different shuffle networks 2480. These different shuffle networks 2480 can be isolated, where nodes only communicate with other nodes in the same shuffle node sets 2485 and/or where shuffle node sets 2485 are mutually exclusive. For example, data block exchange for facilitating query execution can be localized within a particular shuffle node set 2485, where nodes of a particular shuffle node set 2485 only send and receive data from other nodes in the same shuffle node set 2485, and where nodes in different shuffle node sets 2485 do not communicate directly and/or do not exchange data blocks at all. In some cases, where the inner level includes exactly one shuffle network, all nodes 37 in the inner level can and/or must exchange data blocks with all other nodes in the inner level via the shuffle node set via a single corresponding shuffle network 2480.

Alternatively, some or all of the different shuffle networks 2480 can be interconnected, where nodes can and/or must communicate with other nodes in different shuffle node sets 2485 via connectivity between their respective different shuffle networks 2480 to facilitate query execution. As a particular example, in cases where two shuffle node sets 2485 have at least one overlapping node 37, the interconnectivity can be facilitated by the at least one overlapping node 37, for example, where this overlapping node 37 serves as a relay node to relay communications from at least one first node in a first shuffle node sets 2485 to at least one second node in a second first shuffle node set 2485. In some cases, all nodes 37 in a shuffle node set 2485 can communicate with any other node in the same shuffle node set 2485 via a direct link enabled via shuffle network 2480 and/or by otherwise not necessitating any intermediate relay nodes. However, these nodes may still require one or more relay nodes, such as nodes included in multiple shuffle node sets 2485, to communicate with nodes in other shuffle node sets 2485, where communication is facilitated across multiple shuffle node sets 2485 via direct communication links between nodes within each shuffle node set 2485.

Note that these relay nodes facilitating data blocks for execution of a given query across multiple shuffle node sets 2485 can be nodes participating in the query execution plan of the given query and/or can be nodes that are not participating in the query execution plan of the given query. In some cases, these relay nodes facilitating data blocks for execution of a given query across multiple shuffle node sets 2485 are strictly nodes participating in the query execution plan of the given query. In some cases, these relay nodes facilitating data blocks for execution of a given query across multiple shuffle node sets 2485 are strictly nodes that are not participating in the query execution plan of the given query.

In some cases, a node 37 has direct communication links with its child node and/or parent node, where no relay nodes are required to facilitate sending data to parent and/or child nodes of the query execution plan 2405 of FIG. 24A. In other cases, at least one relay node may be required to facilitate communication across levels, such as between a parent node and child node as dictated by the query execution plan. Such relay nodes can be nodes within a and/or different same shuffle network as the parent node and child node, and can be nodes participating in the query execution plan of the given query and/or can be nodes that are not participating in the query execution plan of the given query.

Some or all features and/or functionality of FIG. 24E can be performed via at least one node 37 in conjunction with system metadata applied across a plurality of nodes 37, for example, where at least one node 37 participates in some or all features and/or functionality of FIG. 24E based on receiving and storing the system metadata in local memory of the at least one node 37 as configuration data and/or based on further accessing and/or executing this configuration data to participate in one or more shuffle node sets of FIG. 24E as part of its database functionality accordingly. Performance of some or all features and/or functionality of FIG. 24E can optionally change and/or be updated over time, and/or a set of nodes participating in executing some or all features and/or functionality of FIG. 24E can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24F illustrates an embodiment of a database system that receives some or all query requests from one or more external requesting entities 2912. The external requesting entities 2912 can be implemented as a client device such as a personal computer and/or device, a server system, or other external system that generates and/or transmits query requests 2914. A query resultant 2920 can optionally be transmitted back to the same or different external requesting entity 2912. Some or all query requests processed by database system 10 as described herein can be received from external requesting entities 2912 and/or some or all query resultants generated via query executions described herein can be transmitted to external requesting entities 2912.

For example, a user types or otherwise indicates a query for execution via interaction with a computing device associated with and/or communicating with an external requesting entity. The computing device generates and transmits a corresponding query request 2914 for execution via the database system 10, where the corresponding query resultant 2920 is transmitted back to the computing device, for example, for storage by the computing device and/or for display to the corresponding user via a display device.

As another example, a query is automatically generated for execution via processing resources via a computing device and/or via communication with an external requesting entity implemented via at least one computing device. For example, the query is automatically generated and/or modified from a request generated via user input and/or received from a requesting entity in conjunction with implementing a query generator system, a query optimizer, generative artificial intelligence (AI), and/or other artificial intelligence and/or machine learning techniques. The computing device generates and transmits a corresponding query request 2914 for execution via the database system 10, where the corresponding query resultant 2920 is transmitted back to the computing device, for example, for storage by the computing device, transmission to another system, and/or for display to at least one corresponding user via a display device.

Some or all features and/or functionality of FIG. 24F can be performed via at least one node 37 in conjunction with system metadata applied across a plurality of nodes 37, for example, where at least one node 37 participates in some or all features and/or functionality of FIG. 24F based on receiving and storing the system metadata in local memory of the at least one node 37 as configuration data, and/or based on further accessing and/or executing this configuration data to generate query execution plan data from query requests by implementing some or all of the operator flow generator module 2514 as part of its database functionality accordingly, and/or to participate in one or more query execution plans of a query execution module 2504 as part of its database functionality accordingly. Performance of some or all features and/or functionality of FIG. 24F can optionally change and/or be updated over time, and/or a set of nodes participating in executing some or all features and/or functionality of FIG. 24F can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24G illustrates an embodiment of a query processing system 2502 that generates a query operator execution flow 2517 from a query expression 2509 for execution via a query execution module 2504. The query processing system 2502 can be implemented utilizing, for example, the parallelized query and/or response sub-system 13 and/or the parallelized data store, retrieve, and/or process subsystem 12. The query processing system 2502 can be implemented by utilizing at least one computing device 18, for example, by utilizing at least one central processing module 39 of at least one node 37 utilized to implement the query processing system 2502. The query processing system 2502 can be implemented utilizing any processing module and/or memory of the database system 10, for example, communicating with the database system 10 via system communication resources 14.

As illustrated in FIG. 24G, an operator flow generator module 2514 of the query processing system 2502 can be utilized to generate a query operator execution flow 2517 for the query indicated in a query expression 2509. This can be generated based on a plurality of query operators indicated in the query expression and their respective sequential, parallelized, and/or nested ordering in the query expression, and/or based on optimizing the execution of the plurality of operators of the query expression. This query operator execution flow 2517 can include and/or be utilized to determine the query operator execution flow 2433 assigned to nodes 37 at one or more particular levels of the query execution plan 2405 and/or can include the operator execution flow to be implemented across a plurality of nodes 37, for example, based on a query expression indicated in the query request and/or based on optimizing the execution of the query expression.

In some cases, the operator flow generator module 2514 implements an optimizer to select the query operator execution flow 2517 based on determining the query operator execution flow 2517 is a most efficient and/or otherwise most optimal one of a set of query operator execution flow options and/or that arranges the operators in the query operator execution flow 2517 such that the query operator execution flow 2517 compares favorably to a predetermined efficiency threshold. For example, the operator flow generator module 2514 selects and/or arranges the plurality of operators of the query operator execution flow 2517 to implement the query expression in accordance with performing optimizer functionality, for example, by perform a deterministic function upon the query expression to select and/or arrange the plurality of operators in accordance with the optimizer functionality. This can be based on known and/or estimated processing times of different types of operators. This can be based on known and/or estimated levels of record filtering that will be applied by particular filtering parameters of the query. This can be based on selecting and/or deterministically utilizing a conjunctive normal form and/or a disjunctive normal form to build the query operator execution flow 2517 from the query expression. This can be based on selecting a determining a first possible serial ordering of a plurality of operators to implement the query expression based on determining the first possible serial ordering of the plurality of operators is known to be or expected to be more efficient than at least one second possible serial ordering of the same or different plurality of operators that implements the query expression. This can be based on ordering a first operator before a second operator in the query operator execution flow 2517 based on determining executing the first operator before the second operator results in more efficient execution than executing the second operator before the first operator. For example, the first operator is known to filter the set of records upon which the second operator would be performed to improve the efficiency of performing the second operator due to being executed upon a smaller set of records than if performed before the first operator. This can be based on other optimizer functionality that otherwise selects and/or arranges the plurality of operators of the query operator execution flow 2517 based on other known, estimated, and/or otherwise determined criteria.

A query execution module 2504 of the query processing system 2502 can execute the query expression via execution of the query operator execution flow 2517 to generate a query resultant. For example, the query execution module 2504 can be implemented via a plurality of nodes 37 that execute the query operator execution flow 2517. In particular, the plurality of nodes 37 of a query execution plan 2405 of FIG. 24A can collectively execute the query operator execution flow 2517. In such cases, nodes 37 of the query execution module 2504 can each execute their assigned portion of the query to produce data blocks as discussed previously, starting from IO level nodes propagating their data blocks upwards until the root level node processes incoming data blocks to generate the query resultant, where inner level nodes execute their respective query operator execution flow 2433 upon incoming data blocks to generate their output data blocks. The query execution module 2504 can be utilized to implement the parallelized query and results sub-system 13 and/or the parallelized data store, receive and/or process sub-system 12.

Some or all features and/or functionality of FIG. 24G can be performed via at least one node 37 in conjunction with system metadata applied across a plurality of nodes 37, for example, where at least one node 37 participates in some or all features and/or functionality of FIG. 24G based on receiving and storing the system metadata in local memory of the at least one node 37 as configuration data and/or based on further accessing and/or executing this configuration data to generate query execution plan data from query requests by executing some or all operators of a query operator flow 2517 as part of its database functionality accordingly. Performance of some or all features and/or functionality of FIG. 24G can optionally change and/or be updated over time, and/or a set of nodes participating in executing some or all features and/or functionality of FIG. 24G can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24H presents an example embodiment of a query execution module 2504 that executes query operator execution flow 2517. Some or all features and/or functionality of the query execution module 2504 of FIG. 24H can implement the query execution module 2504 of FIG. 24G and/or any other embodiment of the query execution module 2504 discussed herein. Some or all features and/or functionality of the query execution module 2504 of FIG. 24H can optionally be utilized to implement the query processing module 2435 of node 37 in FIG. 24B and/or to implement some or all nodes 37 at inner levels 2414 of a query execution plan 2405 of FIG. 24A.

The query execution module 2504 can execute the determined query operator execution flow 2517 by performing a plurality of operator executions of operators 2520 of the query operator execution flow 2517 in a corresponding plurality of sequential operator execution steps. Each operator execution step of the plurality of sequential operator execution steps can correspond to execution of a particular operator 2520 of a plurality of operators 2520-1-2520-M of a query operator execution flow 2433.

In some embodiments, a single node 37 executes the query operator execution flow 2517 as illustrated in FIG. 24H as their operator execution flow 2433 of FIG. 24B, where some or all nodes 37 such as some or all inner level nodes 37 utilize the query processing module 2435 as discussed in conjunction with FIG. 24B to generate output data blocks to be sent to other nodes 37 and/or to generate the final resultant by applying the query operator execution flow 2517 to input data blocks received from other nodes and/or retrieved from memory as read and/or recovered records. In such cases, the entire query operator execution flow 2517 determined for the query as a whole can be segregated into multiple query operator execution sub-flows 2433 that are each assigned to the nodes of each of a corresponding set of inner levels 2414 of the query execution plan 2405, where all nodes at the same level execute the same query operator execution flows 2433 upon different received input data blocks. In some cases, the query operator execution flows 2433 applied by each node 37 includes the entire query operator execution flow 2517, for example, when the query execution plan includes exactly one inner level 2414. In other embodiments, the query processing module 2435 is otherwise implemented by at least one processing module the query execution module 2504 to execute a corresponding query, for example, to perform the entire query operator execution flow 2517 of the query as a whole.

A single operator execution by the query execution module 2504, such as via a particular node 37 executing its own query operator execution flows 2433, by executing one of the plurality of operators of the query operator execution flow 2433. As used herein, an operator execution corresponds to executing one operator 2520 of the query operator execution flow 2433 on one or more pending data blocks 2537 in an operator input data set 2522 of the operator 2520. The operator input data set 2522 of a particular operator 2520 includes data blocks that were outputted by execution of one or more other operators 2520 that are immediately below the particular operator in a serial ordering of the plurality of operators of the query operator execution flow 2433. In particular, the pending data blocks 2537 in the operator input data set 2522 were outputted by the one or more other operators 2520 that are immediately below the particular operator via one or more corresponding operator executions of one or more previous operator execution steps in the plurality of sequential operator execution steps. Pending data blocks 2537 of an operator input data set 2522 can be ordered, for example as an ordered queue, based on an ordering in which the pending data blocks 2537 are received by the operator input data set 2522. Alternatively, an operator input data set 2522 is implemented as an unordered set of pending data blocks 2537.

If the particular operator 2520 is executed for a given one of the plurality of sequential operator execution steps, some or all of the pending data blocks 2537 in this particular operator 2520's operator input data set 2522 are processed by the particular operator 2520 via execution of the operator to generate one or more output data blocks. For example, the input data blocks can indicate a plurality of rows, and the operation can be a SELECT operator indicating a simple predicate. The output data blocks can include only proper subset of the plurality of rows that meet the condition specified by the simple predicate.

Once a particular operator 2520 has performed an execution upon a given data block 2537 to generate one or more output data blocks, this data block is removed from the operator's operator input data set 2522. In some cases, an operator selected for execution is automatically executed upon all pending data blocks 2537 in its operator input data set 2522 for the corresponding operator execution step. In this case, an operator input data set 2522 of a particular operator 2520 is therefore empty immediately after the particular operator 2520 is executed. The data blocks outputted by the executed data block are appended to an operator input data set 2522 of an immediately next operator 2520 in the serial ordering of the plurality of operators of the query operator execution flow 2433, where this immediately next operator 2520 will be executed upon its data blocks once selected for execution in a subsequent one of the plurality of sequential operator execution steps.

Operator 2520.1 can correspond to a bottom-most operator 2520 in the serial ordering of the plurality of operators 2520.1-2520.M. As depicted in FIG. 24G, operator 2520.1 has an operator input data set 2522.1 that is populated by data blocks received from another node as discussed in conjunction with FIG. 24B, such as a node at the IO level of the query execution plan 2405. Alternatively these input data blocks can be read by the same node 37 from storage, such as one or more memory devices that store segments that include the rows required for execution of the query. In some cases, the input data blocks are received as a stream over time, where the operator input data set 2522.1 may only include a proper subset of the full set of input data blocks required for execution of the query at a particular time due to not all of the input data blocks having been read and/or received, and/or due to some data blocks having already been processed via execution of operator 2520.1. In other cases, these input data blocks are read and/or retrieved by performing a read operator or other retrieval operation indicated by operator 2520.

Note that in the plurality of sequential operator execution steps utilized to execute a particular query, some or all operators will be executed multiple times, in multiple corresponding ones of the plurality of sequential operator execution steps. In particular, each of the multiple times a particular operator 2520 is executed, this operator is executed on set of pending data blocks 2537 that are currently in their operator input data set 2522, where different ones of the multiple executions correspond to execution of the particular operator upon different sets of data blocks that are currently in their operator queue at corresponding different times.

As a result of this mechanism of processing data blocks via operator executions performed over time, at a given time during the query's execution by the node 37, at least one of the plurality of operators 2520 has an operator input data set 2522 that includes at least one data block 2537. At this given time, one more other ones of the plurality of operators 2520 can have input data sets 2522 that are empty. For example, a given operator's operator input data set 2522 can be empty as a result of one or more immediately prior operators 2520 in the serial ordering not having been executed yet, and/or as a result of the one or more immediately prior operators 2520 not having been executed since a most recent execution of the given operator.

Some types of operators 2520, such as JOIN operators or aggregating operators such as SUM, AVERAGE, MAXIMUM, or MINIMUM operators, require knowledge of the full set of rows that will be received as output from previous operators to correctly generate their output. As used herein, such operators 2520 that must be performed on a particular number of data blocks, such as all data blocks that will be outputted by one or more immediately prior operators in the serial ordering of operators in the query operator execution flow 2517 to execute the query, are denoted as “blocking operators.” Blocking operators are only executed in one of the plurality of sequential execution steps if their corresponding operator queue includes all of the required data blocks to be executed. For example, some or all blocking operators can be executed only if all prior operators in the serial ordering of the plurality of operators in the query operator execution flow 2433 have had all of their necessary executions completed for execution of the query, where none of these prior operators will be further executed in accordance with executing the query.

Some operator output generated via execution of an operator 2520, alternatively or in addition to being added to the input data set 2522 of a next sequential operator in the sequential ordering of the plurality of operators of the query operator execution flow 2433, can be sent to one or more other nodes 37 in a same shuffle node set as input data blocks to be added to the input data set 2522 of one or more of their respective operators 2520. In particular, the output generated via a node's execution of an operator 2520 that is serially before the last operator 2520.M of the node's query operator execution flow 2433 can be sent to one or more other nodes 37 in a same shuffle node set as input data blocks to be added to the input data set 2522 of a respective operators 2520 that is serially after the last operator 2520.1 of the query operator execution flow 2433 of the one or more other nodes 37.

As a particular example, the node 37 and the one or more other nodes 37 in a shuffle node set all execute queries in accordance with the same, common query operator execution flow 2433, for example, based on being assigned to a same inner level 2414 of the query execution plan 2405. The output generated via a node's execution of a particular operator 2520.i this common query operator execution flow 2433 can be sent to the one or more other nodes 37 in a same shuffle node set as input data blocks to be added to the input data set 2522 the next operator 2520.i+1, with respect to the serialized ordering of the query of this common query operator execution flow 2433 of the one or more other nodes 37. For example, the output generated via a node's execution of a particular operator 2520.i is added input data set 2522 the next operator 2520.i+1 of the same node's query operator execution flow 2433 based on being serially next in the sequential ordering and/or is alternatively or additionally added to the input data set 2522 of the next operator 2520.i+1 of the common query operator execution flow 2433 of the one or more other nodes in a same shuffle node set based on being serially next in the sequential ordering.

In some cases, in addition to a particular node sending this output generated via a node's execution of a particular operator 2520.i to one or more other nodes to be input data set 2522 the next operator 2520.i+1 in the common query operator execution flow 2433 of the one or more other nodes 37, the particular node also receives output generated via some or all of these one or more other nodes' execution of this particular operator 2520.i in their own query operator execution flow 2433 upon their own corresponding input data set 2522 for this particular operator. The particular node adds this received output of execution of operator 2520.i by the one or more other nodes to the be input data set 2522 of its own next operator 2520.i+1.

This mechanism of sharing data can be utilized to implement operators that require knowledge of all records of a particular table and/or of a particular set of records that may go beyond the input records retrieved by children or other descendants of the corresponding node. For example, JOIN operators can be implemented in this fashion, where the operator 2520.i+1 corresponds to and/or is utilized to implement JOIN operator and/or a custom-join operator of the query operator execution flow 2517, and where the operator 2520.i+1 thus utilizes input received from many different nodes in the shuffle node set in accordance with their performing of all of the operators serially before operator 2520.i+1 to generate the input to operator 2520.i+1.

Some or all features and/or functionality of FIG. 24H can be performed via at least one node 37 in conjunction with system metadata applied across a plurality of nodes 37, for example, where at least one node 37 participates in some or all features and/or functionality of FIG. 24H based on receiving and storing the system metadata in local memory of the at least one node 37 as configuration data and/or based on further accessing and/or executing this configuration data execute some or all operators of a query operator flow 2517 as part of its database functionality accordingly. Performance of some or all features and/or functionality of FIG. 24H can optionally change and/or be updated over time, and/or a set of nodes participating in executing some or all features and/or functionality of FIG. 24H can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24I illustrates an example embodiment of multiple nodes 37 that execute a query operator execution flow 2433. For example, these nodes 37 are at a same level 2410 of a query execution plan 2405, and receive and perform an identical query operator execution flow 2433 in conjunction with decentralized execution of a corresponding query. Each node 37 can determine this query operator execution flow 2433 based on receiving the query execution plan data for the corresponding query that indicates the query operator execution flow 2433 to be performed by these nodes 37 in accordance with their participation at a corresponding inner level 2414 of the corresponding query execution plan 2405 as discussed in conjunction with FIG. 24G. This query operator execution flow 2433 utilized by the multiple nodes can be the full query operator execution flow 2517 generated by the operator flow generator module 2514 of FIG. 24G. This query operator execution flow 2433 can alternatively include a sequential proper subset of operators from the query operator execution flow 2517 generated by the operator flow generator module 2514 of FIG. 24G, where one or more other sequential proper subsets of the query operator execution flow 2517 are performed by nodes at different levels of the query execution plan.

Each node 37 can utilize a corresponding query processing module 2435 to perform a plurality of operator executions for operators of the query operator execution flow 2433 as discussed in conjunction with FIG. 24H. This can include performing an operator execution upon input data sets 2522 of a corresponding operator 2520, where the output of the operator execution is added to an input data set 2522 of a sequentially next operator 2520 in the operator execution flow, as discussed in conjunction with FIG. 24H, where the operators 2520 of the query operator execution flow 2433 are implemented as operators 2520 of FIG. 24H. Some or operators 2520 can correspond to blocking operators that must have all required input data blocks generated via one or more previous operators before execution. Each query processing module can receive, store in local memory, and/or otherwise access and/or determine necessary operator instruction data for operators 2520 indicating how to execute the corresponding operators 2520.

Some or all features and/or functionality of FIG. 24I can be performed via at least one node 37 in conjunction with system metadata applied across a plurality of nodes 37, for example, where at least one node 37 participates in some or all features and/or functionality of FIG. 24I based on receiving and storing the system metadata in local memory of the at least one node 37 as configuration data and/or based on further accessing and/or executing this configuration data to execute some or all operators of a query operator flow 2517 in parallel with other nodes, send data blocks to a parent node, and/or process data blocks from child nodes as part of its database functionality accordingly. Performance of some or all features and/or functionality of FIG. 24I can optionally change and/or be updated over time, and/or a set of nodes participating in executing some or all features and/or functionality of FIG. 24I can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24J illustrates an embodiment of a query execution module 2504 that executes each of a plurality of operators of a given operator execution flow 2517 via a corresponding one of a plurality of operator execution modules 3215. The operator execution modules 3215 of FIG. 24J can be implemented to execute any operators 2520 being executed by a query execution module 2504 for a given query as described herein.

In some embodiments, a given node 37 can optionally execute one or more operators, for example, when participating in a corresponding query execution plan 2405 for a given query, by implementing some or all features and/or functionality of the operator execution module 3215, for example, by implementing its operator processing module 2435 to execute one or more operator execution modules 3215 for one or more operators 2520 being processed by the given node 37. For example, a plurality of nodes of a query execution plan 2405 for a given query execute their operators based on implementing corresponding query processing modules 2435 accordingly.

FIG. 24K illustrates an embodiment of database storage 2450 operable to store a plurality of database tables 2712, such as relational database tables or other database tables as described previously herein. Database storage 2450 can be implemented via the parallelized data store, retrieve, and/or process sub-system 12, via memory drives 2425 of one or more nodes 37 implementing the database storage 2450, and/or via other memory and/or storage resources of database system 10. The database tables 2712 can be stored as segments as discussed in conjunction with FIGS. 15-23 and/or FIGS. 24B-24D. A database table 2712 can be implemented as one or more datasets and/or a portion of a given dataset, such as the dataset of FIG. 15.

A given database table 2712 can be stored based on being received for storage, for example, via the parallelized ingress sub-system 24 and/or via other data ingress. Alternatively or in addition, a given database table 2712 can be generated and/or modified by the database system 10 itself based on being generated as output of a query executed by query execution module 2504, such as a Create Table As Select (CTAS) query or Insert query.

A given database table 2712 can be in accordance with a schema 2409 defining columns of the database table, where records 2422 correspond to rows having values 2708 for some or all of these columns. Different database tables can have different numbers of columns and/or different datatypes for values stored in different columns. For example, the set of columns 2707.1_{A}-2707.C_{A} of schema 2709.A for database table 2712.A can have a different number of columns than and/or can have different datatypes for some or all columns of the set of columns 2707.1_{B}-2707.C_{B} of schema 2709.B for database table 2712.B. The schema 2409 for a given n database table 2712 can denote same or different datatypes for some or all of its set of columns. For example, some columns are variable-length and other columns are fixed-length. As another example, some columns are integers, other columns are binary values, other columns are Strings, and/or other columns are char types.

Row reads performed during query execution, such as row reads performed at the IO level of a query execution plan 2405, can be performed by reading values 2708 for one or more specified columns 2707 of the given query for some or all rows of one or more specified database tables, as denoted by the query expression defining the query to be performed. Filtering, join operations, and/or values included in the query resultant can be further dictated by operations to be performed upon the read values 2708 of these one or more specified columns 2707.

FIG. 24L illustrates an embodiment of a dataset 2502 having one or more columns 3023 implemented as array fields 2712. Some or all features and/or functionality of the dataset 2502 of FIG. 24L can be utilized to implement one or more of the database tables 2712 of FIG. 24K and/or any embodiment of any database table and/or dataset received, stored, and processed via the database system 10 as described herein.

Columns 3023 implemented as array fields 2712 can include array structures 2718 as values 3024 for some or all rows. A given array structure 2718 can have a set of elements 2709.1-2709.M. The value of M can be fixed for a given array field 2712, or can be different for different array structures 2718 of a given array field 2712. In embodiments where the number of elements is fixed, different array fields 2712 can have different fixed numbers of array elements 2709, for example, where a first array field 2712.A has array structures having M elements, and where a second array field 2712.B has array structures having N elements.

Note that a given array structure 2718 of a given array field can optionally have zero elements, where such array structures are considered as empty arrays satisfying the empty array condition. An empty array structure 2718 is distinct from a null value 3852, as it is a defined structure as an array 2718, despite not being populated with any values. For example, consider an example where an array field for rows corresponding to people is implemented to note a list of spouse names for all marriages of each person. An empty array for this array field for a first given row denotes a first corresponding person was never married, while a null value for this array field for a second given row denotes that it is unknown as to whether the second corresponding person was ever married, or who they were married to.

Array elements 2709 of a given array structure can have the same or different data type. In some embodiments, data types of array elements 2709 can be fixed for a given array field (e.g. all array elements 2709 of all array structures 2718 of array field 2712.A are string values, and all array elements 2709 of all array structures 2718 of array field 2712.B are integer values). In other embodiments, data types of array elements 2709 can be different for a given array field and/or a given array structure.

Some array structures 2718 that are non-empty can have one or more array elements having the null value 3852, where the corresponding value 3024 thus meets the null-inclusive array condition. This is distinct from the null value condition 3842, as the value 3024 itself is not null, but is instead an array structure 2718 having some or all of its array elements 2709 with values of null. Continuing example where an array field for rows corresponding to people is implemented to note a list of spouse names for all marriages of each person, a null value for this array field for the second given row denotes that it is unknown as to whether the second corresponding person was ever married or who they were married to, while a null value within an array structure for a third given row denotes that the name of the spouse for a corresponding one of a set of marriages of the person is unknown.

Some array structures 2718 that are non-empty can have all non-null values for its array elements 2709, where all corresponding array elements 2709 were populated and/or defined. Some array structures 2718 that are non-empty can have values for some of its array elements 2709 that are null, and values for others of its array elements 2709 that are non-null values.

Some array structures 2718 that are non-empty can have values for all of its array elements 2709 that are null. This is still distinct from the case where the value 3024 denotes a value of null with no array structure 2718. Continuing example where an array field for rows corresponding to people is implemented to note a list of spouse names for all marriages of each person, a null value for this array field for the second given row denotes that it is unknown as to whether the second corresponding person was ever married, how many times they were married or who they were married to, while the array structure for the third given row denotes a set of three null values and non-null values, denoting that the person was married three times, but the names of the spouses for all three marriages are unknown.

FIGS. 24M-24N illustrates an example embodiment of a query execution module 2504 of a database system 10 that executes queries via generation, storage, and/or communication of a plurality of column data streams 2968 corresponding to a plurality of columns. Some or all features and/or functionality of query execution module 2504 of FIGS. 24M-24N can implement any embodiment of query execution module 2504 described herein and/or any performance of query execution described herein. Some or all features and/or functionality of column data streams 2968 of FIGS. 24M-24N can implement any embodiment of data blocks 2537 and/or other communication of data between operators 2520 of a query operator execution flow 2517 when executed by a query execution module 2504, for example, via a corresponding plurality of operator execution modules 3215.

As illustrated in FIG. 24M, in some embodiments, data values of each given column 2915 are included in data blocks of their own respective column data stream 2968. Each column data stream 2968 can correspond to one given column 2915, where each given column 2915 is included in one data stream included in and/or referenced by output data blocks generated via execution of one or more operator execution module 3215, for example, to be utilized as input by one or more other operator execution modules 3215. Different columns can be designated for inclusion in different data streams. For example, different column streams are written do different portions of memory, such as different sets of memory fragments of query execution memory resources.

As illustrated in FIG. 24N, each data block 2537 of a given column data stream 2968 can include values 2918 for the respective column for one or more corresponding rows 2916. In the example of FIG. 24N, each data block includes values for V corresponding rows, where different data blocks in the column data stream include different respective sets of V rows, for example, that are each a subset of a total set of rows to be processed. In other embodiments, different data blocks can have different numbers of rows. The subsets of rows across a plurality of data blocks 2537 of a given column data stream 2968 can be mutually exclusive and collectively exhaustive with respect to the full output set of rows, for example, emitted by a corresponding operator execution module 3215 as output.

Values 2918 of a given row utilized in query execution are thus dispersed across different A given column 2915 can be implemented as a column 2707 having corresponding values 2918 implemented as values 2708 read from database table 2712 read from database storage 2450, for example, via execution of corresponding IO operators. Alternatively or in addition, a given column 2915 can be implemented as a column 2707 having new and/or modified values generated during query execution, for example, via execution of an extend expression and/or other operation. Alternatively or in addition, a given column 2915 can be implemented as a new column generated during query execution having new values generated accordingly, for example, via execution of an extend expression and/or other operation. The set of column data streams 2968 generated and/or emitted between operators in query execution can correspond to some or all columns of one or more tables 2712 and/or new columns of an existing table and/or of a new table generated during query execution.

Additional column streams emitted by the given operator execution module can have their respective values for the same full set of output rows across for other respective columns. For example, the values across all column streams are in accordance with a consistent ordering, where a first row's values 2918.1.1-2918.1.C for columns 2915.1-2915.C are included first in every respective column data stream, where a second row's values 2918.2.1-2918.2.C for columns 2915.1-2915.C are included second in every respective column data stream, and so on. In other embodiments, rows are optionally ordered differently in different column streams. Rows can be identified across column streams based on consistent ordering of values, based on being mapped to and/or indicating row identifiers, or other means.

As a particular example, for every fixed-length column, a huge block can be allocated to initialize a fixed length column stream, which can be implemented via mutable memory as a mutable memory column stream, and/or for every variable-length column, another huge block can be allocated to initialize a binary stream, which can be implemented via mutable memory as a mutable memory binary stream. A given column data stream 2968 can be continuously appended with fixed length values to data runs of contiguous memory and/or may grow the underlying huge page memory region to acquire more contiguous runs and/or fragments of memory.

In other embodiments, rather than emitting data blocks with values 2918 for different columns in different column streams, values 2918 for a set of multiple column can be emitted in a same multi-column data stream.

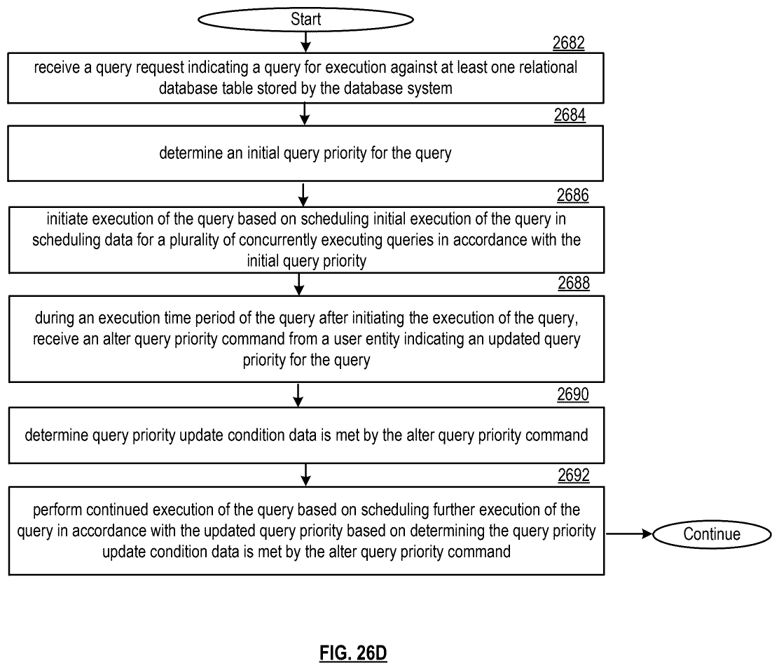

FIG. 240 illustrates an example of operator execution modules 3215.C that each write their output memory blocks to one or more memory fragments 2622 of query execution memory resources 3045 and/or that each read/process input data blocks based on accessing the one or more memory fragments 2622 Some or all features and/or functionality of the operator execution modules 3215 of FIG. 24O can implement the operator execution modules of FIG. 24J and/or can implement any query execution described herein. The data blocks 2537 can implement the data blocks of column streams of FIGS. 24M and/or 24N, and/or any operator 2520's input data blocks and/or output data blocks described herein.

A given operator execution module 3215.A for an operator that is a child operator of the operator executed by operator execution module 3215.B can emit its output data blocks for processing by operator execution module 3215.B based on writing each of a stream of data blocks 2537.1-2537.K of data stream 2917.A to contiguous or non-contiguous memory fragments 2622 at one or more corresponding memory locations 2951 of query execution memory resources 3045.

Operator execution module 3215.A can generate these data blocks 2537.1-2537.K of data stream 2917.A in conjunction with execution of the respective operator on incoming data. This incoming data can correspond to one or more other streams of data blocks 2537 of another data stream 2917 accessed in memory resources 3045 based on being written by one or more child operator execution modules corresponding to child operators of the operator executed by operator execution module 3215.A. Alternatively or in addition, the incoming data is read from database storage 2450 and/or is read from one or more segments stored on memory drives, for example, based on the operator executed by operator execution module 3215.A being implemented as an IO operator.

The parent operator execution module 3215.B of operator execution module 3215.A can generate its own output data blocks 2537.1-2537.J of data stream 2917.B based on execution of the respective operator upon data blocks 2537.1-2537.K of data stream 2917.A. Executing the operator can include reading the values from and/or performing operations toy filter, aggregate, manipulate, generate new column values from, and/or otherwise determine values that are written to data blocks 2537.1-2537.J.

In other embodiments, the operator execution module 3215.B does not read the values from these data blocks, and instead forwards these data blocks, for example, where data blocks 2537.1-2537.J include memory reference data for the data blocks 2537.1-2537.K to enable one or more parent operator modules, such as operator execution module 3215.C, to access and read the values from forwarded streams.

In the case where operator execution module 3215.A has multiple parents, the data blocks 2537.1-2537.K of data stream 2917.A can be read, forwarded, and/or otherwise processed by each parent operator execution module 3215 independently in a same or similar fashion. Alternatively or in addition, in the case where operator execution module 3215.B has multiple children, each child's emitted set of data blocks 2537 of a respective data stream 2917 can be read, forwarded, and/or otherwise processed by operator execution module 3215.B in a same or similar fashion.

The parent operator execution module 3215.C of operator execution module 3215.B can similarly read, forward, and/or otherwise process data blocks 2537.1-2537.J of data stream 2917.B based on execution of the respective operator to render generation and emitting of its own data blocks in a similar fashion. Executing the operator can include reading the values from and/or performing operations to filter, aggregate, manipulate, generate new column values from, and/or otherwise process data blocks 2537.1-2537.J to determine values that are written to its own output data. For example, the operator execution module 3215.C reads data blocks 2537.1-2537.K of data stream 2917.A and/or the operator execution module 3215.B writes data blocks 2537.1-2537.J of data stream 2917.B. As another example, the operator execution module 3215.C reads data blocks 2537.1-2537.K of data stream 2917.A, or data blocks of another descendent, based on having been forwarded, where corresponding memory reference information denoting the location of these data blocks is read and processed from the received data blocks data blocks 2537.1-2537.J of data stream 2917.B enable accessing the values from data blocks 2537.1-2537.K of data stream 2917.A. As another example, the operator execution module 3215.B does not read the values from these data blocks, and instead forwards these data blocks, for example, where data blocks 2537.1-2537.J include memory reference data for the data blocks 2537.1-2537.J to enable one or more parent operator modules to read these forwarded streams.

This pattern of reading and/or processing input data blocks from one or more children for use in generating output data blocks for one or more parents can continue until ultimately a final operator, such as an operator executed by a root level node, generates a query resultant, which can itself be stored as data blocks in this fashion in query execution memory resources and/or can be transmitted to a requesting entity for display and/or storage.

For example, rather than accessing this large data for some or all potential records prior to filtering in a query execution, for example, via IO level 2416 of a corresponding query execution plan 2405 as illustrated in FIGS. 24A and 24C, and/or rather than passing this large data to other nodes 37 for processing, for example, from IO level nodes 37 to inner level nodes 37 and/or between any nodes 37 as illustrated in FIGS. 24A, 24B, and 24C, this large data is not accessed until a final stage of a query. As a particular example, this large data of the projected field is simply joined at the end of the query for the corresponding outputted rows that meet query predicates of the query. This ensures that, rather than accessing and/or passing the large data of these fields for some or all possible records that may be projected in the resultant, only the large data of these fields for final, filtered set of records that meet the query predicates are accessed and projected.

FIG. 24P illustrates an embodiment of a database system 10 that implements a segment generator 2507 to generate segments 2424. Some or all features and/or functionality of the database system 10 of FIG. 24P can implement any embodiment of the database system 10 described herein. Some or all features and/or functionality of segments 2424 of FIG. 24P can implement any embodiment of segment 2424 described herein.

A plurality of records 2422.1-2422.Z of one or more datasets 2505 to be converted into segments can be processed to generate a corresponding plurality of segments 2424.1-2424.Y. Each segment can include a plurality of column slabs 2610.1-2610.C corresponding to some or all of the C columns of the set of records.

In some embodiments, the dataset 2505 can correspond to a given database table 2712. In some embodiments, the dataset 2505 can correspond to only portion of a given database table 2712 (e.g. the most recently received set of records of a stream of records received for the table over time), where other datasets 2505 are later processed to generate new segments as more records are received over time. In some embodiments, the dataset 2505 can correspond to multiple database tables. The dataset 2505 optionally includes non-relational records and/or any records/files/data that is received from/generated by a given data source multiple different data sources.

Each record 2422 of the incoming dataset 2505 can be assigned to be included in exactly one segment 2424. In this example, segment 2424.1 includes at least records 2422.3 and 2422.7, while segment 2424 includes at least records 2422.1 and 2422.9. All of the Z records can be guaranteed to be included in exactly one segment by segment generator 2507. Rows are optionally grouped into segments based on a cluster-key based grouping or other grouping by same or similar column values of one or more columns. Alternatively, rows are optionally grouped randomly, in accordance with a round robin fashion, or by any other means.

A given row 2422 can thus have all of its column values 2708.1-2708.C included in exactly one given segment 2424, where these column values are dispersed across different column slabs 2610 based on which columns each column value corresponds. This division of column values into different column slabs can implement the columnar-format of segments described herein. The generation of column slabs can optionally include further processing of each set of column values assigned to each column slab. For example, some or all column slabs are optionally compressed and stored as compressed column slabs.

The database storage 2450 can thus store one or more datasets as segments 2424, for example, where these segments 2424 are accessed during query execution to identify/read values of rows of interest as specified in query predicates, where these identified rows/the respective values are further filtered/processed/etc., for example, via operators 2520 of a corresponding query operator execution flow 2517, or otherwise accordance with the query to render generation of the query resultant.

FIG. 24Q illustrates an example embodiment of a segment generator 2507 of database system 10. Some or all features and/or functionality of the database system 10 of FIG. 24Q can implement any embodiment of the database system 10 described herein. Some or all features and/or functionality of the segment generator 2507 of FIG. 24Q can implement the segment generator 2507 of FIG. 24P and/or any embodiment of the segment generator 2507 described herein.

The segment generator 2507 can implement a cluster key-based grouping module 2620 to group records of a dataset 2505 by a predetermined cluster key 2607, which can correspond to one or more columns. The cluster key can be received, accessed in memory, configured via user input, automatically selected based on an optimization, or otherwise determined. This grouping by cluster key can render generation of a plurality of record groups 2625.1-2625.X.

The segment generator 2507 can implement a columnar rotation module 2630 to generate a plurality of column formatted record data (e.g. column slabs 2610 to be included in respective segments 2424). Each record group 2625 can have a corresponding set of J column-formatted record data 2565.1-2565.J generated, for example, corresponding to J segments in a given segment group.

A metadata generator module 2640 can further generate parity data, index data, statistical data, and/or other metadata to be included in segments in conjunction with the column-formatted record data. A set of X segment groups corresponding to the X record groups can be generated and stored in database storage 2450. For example, each segment group includes J segments, where parity data of a proper subset of segments in the segment group can be utilized to rebuild column-formatted record data of other segments in the same segment group as discussed previously.

In some embodiments, the segment generator 2507 implements some or all features and/or functionality of the segment generator disclosed by: U.S. Utility application Ser. No. 16/985,723, entitled “DELAYING SEGMENT GENERATION IN DATABASE SYSTEMS”, filed Aug. 5, 2020, which is hereby incorporated herein by reference in its entirety and made part of the present U.S. Utility Patent Application for all purposes; U.S. Utility application Ser. No. 16/985,957 entitled “PARALLELIZED SEGMENT GENERATION VIA KEY-BASED SUBDIVISION IN DATABASE SYSTEMS”, filed Aug. 5, 2020, which is hereby incorporated herein by reference in its entirety and made part of the present U.S. Utility Patent Application for all purposes; and/or U.S. Utility application Ser. No. 16/985,930, entitled “RECORD DEDUPLICATION IN DATABASE SYSTEMS”, filed Aug. 5, 2020, issued as U.S. Pat. No. 11,321,288 on May 3, 2022, which is hereby incorporated herein by reference in its entirety and made part of the present U.S. Utility Patent Application for all purposes. For example, the database system 10 implements some or all features and/or functionality of record processing and storage system of U.S. Utility application Ser. No. 16/985,723, U.S. Utility application Ser. No. 16/985,957, and/or U.S. Utility application Ser. No. 16/985,930.

FIG. 24R illustrates an embodiment of a query processing system 2510 that implements an IO pipeline generator module 2834 to generate a plurality of IO pipelines 2835.1-2835.R for a corresponding plurality of segments 2424.1-2424.R, where these IO pipelines 2835.1-2835.R are each executed by an IO operator execution module 2840 to facilitate generation of a filtered record set by accessing the corresponding segment. Some or all features and/or functionality of the query processing system 2510 of FIG. 24R can implement any embodiment of query processing system 2510, any embodiment of query execution module 2504, and/or any embodiment of executing a query described herein.

Each IO pipeline 2835 can be generated based on corresponding segment configuration data 2833 for the corresponding segment 2424, such as secondary indexing data for the segment, statistical data/cardinality data for the segment, compression schemes applied to the column slabs of the segment, or other information denoting how the segment is configured. For example, different segments 2424 have different IO pipelines 2835 generated for a given query based on having different secondary indexing schemes, different statistical data/cardinality data for its values, different compression schemes applied for some of all of the columns of its records, or other differences.

An IO operator execution module 2840 can execute each respective IO pipeline 2835. For example, the IO operator execution module 2840 is implemented by nodes 37 at the IO level of a corresponding query execution plan 2405, where a node 37 storing a given segment 2424 is responsible for accessing the segment as described previously, and thus executes the IO pipeline for the given segment.

This execution of IO pipelines 2835 by IO operator execution module 2840 correspond to executing IO operators 2421 of a query operator execution flow 2517. The output of IO operators 2421 can correspond to output of IO operators 2421 and/or output of IO level. This output can correspond to data blocks that are further processed via additional operators 2520, for example, by nodes at inner levels and/or the root level of a corresponding query execution plan.

Each IO pipeline 2835 can be generated based on pushing some or all filtering down to the IO level, where query predicates are applied via the IO pipeline based on accessing index structures, sourcing values, filtering rows, etc. Each IO pipeline 2835 can be generated to render semantically equivalent application of query predicates, despite differences in how the IO pipeline is arranged/executed for the given segment. For example, an index structure of a first segment is used to identify a set of rows meeting a condition for a corresponding column in a first corresponding IO pipeline while a second segment has its row values sourced and compared to a value to identify which rows meet the condition, for example, based on the first segment having the corresponding column indexed and the second segment not having the corresponding column indexed. As another example, the IO pipeline for a first segment applies a compressed column slab processing element to identify where rows are stored in a compressed column slab and to further facilitate decompression of the rows, while a second segment accesses this column slab directly for the corresponding column based on this column being compressed in the first segment and being uncompressed for the second segment.

FIG. 24S illustrates an example embodiment of an IO pipeline 2835 that is generated to include one or more index elements 3512, one or more source elements 3014, and/or one or more filter elements 3016. These elements can be arranged in a serialized ordering that includes one or more parallelized paths. These elements can implement sourcing and/or filtering of rows based on query predicates 2822 applied to one or more columns, identified by corresponding column identifiers 3041 and corresponding filter parameters 3048. Some or all features and/or functionality of the IO pipeline 2835 and/or IO pipeline generator module 2834 of FIG. 24S can implement the IO pipeline 2835 and/or IO pipeline generator module 2834 of FIG. 24R, and/or any embodiment of IO pipeline 2835, of IO pipeline generator module 2834, or of any query execution via accessing segments described herein.

In some embodiments, the IO pipeline generator module 2834, IO pipeline 2835, IO operator execution module 2840, and/or any embodiment of IO pipeline generation and/or IO pipeline execution described herein, implements some or all features and/or functionality of the IO pipeline generator module 2834, IO pipeline 2835, IO operator execution module 2840, and/or pushing of filtering and/or other operations to the IO level as disclosed by: U.S. Utility application Ser. No. 17/303,437, entitled “QUERY EXECUTION UTILIZING PROBABILISTIC INDEXING” and filed May 28, 2021; U.S. Utility application Ser. No. 17/450,109, entitled “MISSING DATA-BASED INDEXING IN DATABASE SYSTEMS” and filed Oct. 6, 2021; U.S. Utility application Ser. No. 18/310,177, entitled “OPTIMIZING AN OPERATOR FLOW FOR PERFORMING AGGREGATION VIA A DATABASE SYSTEM” and filed May 1, 2023; U.S. Utility application Ser. No. 18/355,505, entitled “STRUCTURING GEOSPATIAL INDEX DATA FOR ACCESS DURING QUERY EXECUTION VIA A DATABASE SYSTEM” and filed Jul. 20, 2023; and/or U.S. Utility application Ser. No. 18/485,861, entitled “QUERY PROCESSING IN A DATABASE SYSTEM BASED ON APPLYING A DISJUNCTION OF CONJUNCTIVE NORMAL FORM PREDICATES” and filed Oct. 12, 2023; all of which hereby incorporated herein by reference in its entirety and made part of the present U.S. Utility Patent Application for all purposes.

FIG. 24T presents an embodiment of a database system 10 that includes a plurality of storage clusters 2535. Storage clusters 2535.1-2535.Z of FIG. 24T can implement some or all features and/or functionality of storage clusters 35-1-35-Z described herein, and/or can implement some or all features and/or functionality of any embodiment of a storage cluster described herein. Some or all features and/or functionality of database system 10 of FIG. 24T can implement any embodiment of database system 10 described herein.

Each storage cluster 2535 can be implemented via a corresponding plurality of nodes 37. In some embodiments, a given node 37 of database system 10 is optionally included in exactly one storage cluster. In some embodiments, one or more nodes 37 of database system 10 are optionally included in no storage clusters (e.g. aren't configured to store segments). In some embodiments, one or more nodes 37 of database system 10 can be included in multiple storage clusters.

In some embodiments, some or all nodes 37 in a storage cluster 2535 participate at the IO level 2416 in query execution plans based on storing segments 2424 in corresponding memory drives 2425, and based on accessing these segments 2424 during query execution. This can include executing corresponding IO operators, for example, via executing an IO pipeline 2835 (and/or multiple IO pipelines 2835, where each IO pipeline is configured for each respective segment 2424). All segments in a given same segment group (e.g. a set of segments collectively storing parity data and/or replicated parts enabling any given segment in the segment group to be rebuilt/accessed as a virtual segment during query execution via access to some or all other segments in the same segment group as described previously) are optionally guaranteed to be stored in a same storage cluster 2535, where segment rebuilds and/or virtual segment use in query execution can thus be facilitated via communication between nodes in a given storage cluster 2535 accordingly, for example, in response to a node failing and/or a segment becoming unavailable.

Each storage cluster 2535 can further mediate cluster state data 3105 in accordance with a consensus protocol mediated via the plurality of nodes 37 of the given storage cluster. Cluster state data 3105 can implement any embodiment of state data and/or system metadata described herein. In some embodiments, cluster state data 3105 can indicate data ownership information indicating ownership of each segments stored by the cluster by exactly one node (e.g. as a physical segment or a virtual segment) to ensure queries are executed correctly via processing rows in each segment (e.g. of a given dataset against which the query is executed) exactly once.

Consensus protocol 3100 can be implemented via the raft consensus protocol and/or any other consensus protocol. Consensus protocol 3100 can be implemented be based on distributing a state machine across a plurality of nodes, ensuring that each node in the cluster agrees upon the same series of state transitions and/or ensuring that each node operates in accordance with the currently agreed upon state transition. Consensus protocol 3100 can implement any embodiment of consensus protocol described herein.

Coordination across different storage clusters 2535 can be minimal and/or non-existent, for example, based on each storage cluster coordinating state data and/or corresponding query execution separately. For example, state data 3105 across different storage clusters is optionally unrelated.

Each storage cluster's nodes 37 can perform various database tasks (e.g. participate in query execution) based on accessing/utilizing the state data 3105 of its given storage cluster, for example, without knowledge of state data of other storage clusters. This can include nodes syncing state data 3105 and/or otherwise utilizing the most recent version of state data 3105, for example, based on receiving updates from a leader node in the cluster, triggering a sync process in response to determining to perform a corresponding task requiring most recent state data, accessing/updating a locally stored copy of the state data, and/or otherwise determining updated state data.

In some embodiments, updating of state data (such as configuration data, system metadata, data shared via a consensus protocol, and/or any other state data described herein), for example, utilized by nodes to perform respective functionality over time, can be performed in conjunction with an event driven model. In some embodiments, such updating of state data over time can be performed in a same or similar fashion as updating of configuration data as disclosed by: U.S. Utility application Ser. No. 18/321,212, entitled COMMUNICATING UPDATES TO SYSTEM METADATA VIA A DATABASE SYSTEM, filed May 22, 2023; and/or U.S. Utility application Ser. No. 18/310,262, entitled “GENERATING A SEGMENT REBUILD PLAN VIA A NODE OF A DATABASE”, filed May 1, 2023; which are hereby incorporated herein by reference in their entirety and made part of the present U.S. Utility Patent Application for all purposes.

In some embodiments, system metadata can be generated and/or updated over time with different corresponding metadata sequence numbers (MSNs). For example, such generation/updating of metadata over time can be implemented via any features and/or functionality of the generation of data ownership information over time with corresponding OSNs as disclosed by U.S. Utility Application No. 16/778, 194, entitled “SERVICING CONCURRENT QUERIES VIA VIRTUAL SEGMENT RECOVERY”, filed Jan. 31, 2020, and issued as U.S. Pat. No. 11,061,910 on Jul. 13, 2021, which is hereby incorporated herein by reference in its entirety and made part of the present U.S. Utility Patent Application for all purposes. In some embodiments, the system metadata management system 2702 and/or a corresponding metadata system protocol can be implemented via a consensus protocols mediated via a plurality of nodes, for example, to update system metadata 2710, in a via any features and/or functionality of the execution of consensus protocols mediated via a plurality of nodes as disclosed by this U.S. Utility application Ser. No. 16/778,194. In some embodiments, each version of system metadata 2710 can assign nodes to different tasks and/or functionality via any features and/or functionality of assigning nodes to different segments for access in query execution in different versions of data ownership information as disclosed by this U.S. Utility application Ser. No. 16/778,194. In some embodiments, system metadata indicates a current version of data ownership information, where nodes utilize system metadata and corresponding system configuration data to determine their own ownership of segments for use in query execution accordingly, and/or to execute queries utilizing correct sets of segments accordingly, based on processing the denoted data ownership information as U.S. Utility application Ser. No. 16/778,194.

FIGS. 24U and 24V illustrate embodiments of a database system 10 that utilizes a dictionary structure to store compressed columns. Some or all features and/or functionality of the dictionary structure 5016 of FIGS. 24U and/or 24V can implement any compression scheme data and/or means of generating and/or accessing compressed columns described herein. Any other features and/or functionality of database system 10 of FIG. 24U and/or 24V can implement any other embodiment of database system 10 described herein.

In some embodiments, columns are compressed as compressed columns 5005 based on a globally maintained dictionary (e.g. dictionary structure 5016), for example, in conjunction with applying Global Dictionary Compression (GDC). Applying Global Dictionary Compression can include replaces variable length column values with fixed length integers on disk (e.g. in database storage 2450), where the globally maintained dictionary is stored elsewhere, for example, via different (e.g. slower/less efficient) memory resources of a different type/in a different location from the database storage 2450 that stores the compressed columns 5005 accessed during query execution.

The dictionary structure can store a plurality of fixed-length, compressed values 5013 (e.g. integers) each mapped to a single uncompressed value 5012 (e.g. variable-length values, such as strings). The mapping of compressed values 5013 to uncompressed values 5012 can be in accordance with a one-to-one mapping. The mapping of compressed values 5013 to uncompressed values 5012 can be based on utilizing the fixed-length values 5013 as keys of a corresponding map and/or dictionary data structure, and/or can be based on utilizing the uncompressed values 5012 as keys of a corresponding map and/or dictionary data structure.

A given uncompressed value 5012 that is included in many rows of one or more tables can be replaced (i.e. “compressed”) via a same corresponding compressed value 5013 mapped to this uncompressed value 5012 as the compressed value 5008 for these rows in compressed column 5005 in database storage. As new rows are received for storage over time, their column values for one or more compressed columns 5005 can be replaced via corresponding compressed values 5008 based on accessing the dictionary structure and determining whether the uncompressed value 5012 of this column is stored in the dictionary structure 5016. If yes, the compressed value 5013 mapped to the uncompressed value 5012 in this existing entry is stored as compressed value 5008 in the compressed column 5005 in the database storage 2450. If no, the dictionary structure 5016 can be updated to include a new entry that includes the uncompressed value 5012 and a new compressed value 5013 (e.g. different from all existing compressed values in the structure) generated for this uncompressed value 5012, where this new compressed value 5013 is stored as is applied as compressed value 5008 in the database storage 2450.

The dictionary structure 5016 can be stored in dictionary storage resources 2514, which can be different types of resources from and/or can be stored in a different location from the database storage 2450 storing the compressed columns for query execution. In some embodiments, the dictionary storage resources 2514 storing dictionary structure 5016 can be considered a portion/type of memory as of database storage 2450 that are accessed during query execution as necessary for decompressing column values. In some embodiments, the dictionary storage resources 2514 storing dictionary structure 5016 can be implemented as metadata storage resources, for example, implemented by a metadata consensus state mediated via a metadata storage cluster of nodes maintaining system metadata such as GDCs of the database system 10.

The dictionary structure 5016 can correspond to a given column 5005, where different columns optionally have their own dictionary structure 5016 build and maintained. Alternatively, a common dictionary structure 5016 can optionally be maintained for multiple columns of a same table/same dataset, and/or for multiple columns across different tables/different datasets. For example, a given uncompressed value 5012 appearing in different columns 5005 of the same or different table is compressed via the same fixed-length value 5013 as dictated by the dictionary structure 5016.

This dictionary structure 5016 can be globally maintained (e.g. across some or all nodes, indicating fixed length values mapped across one or more segments stored in conjunction with storing one or more relational database tables) and can be updated overtime (e.g. as more data is added with new variable length values requiring mapping to fixed length values). For example, the dictionary structure 5016 is maintained/stored in state data that is mediated/accessible by some or all nodes 37 of the database system 10 via the dictionary structure 5016 being included in any embodiment of state data described herein.

In some embodiments, dictionary compression via dictionary structure 5016 can implement the compression scheme utilized to generate (e.g. compress/decompress the values of) compressed columns 5005 of FIG. 24U based on implementing some or all features and/or functionality of the compression of data during ingress via a dictionary as disclosed by U.S. Utility application Ser. No. 16/985,723, entitled “DELAYING SEGMENT GENERATION IN DATABASE SYSTEMS”, filed Aug. 5, 2020, which is hereby incorporated herein by reference in its entirety and made part of the present U.S. Utility Patent Application for all purposes.

In some embodiments, dictionary compression via dictionary structure 5016 can implement the compression scheme utilized to generate (e.g. compress/decompress the values of) compressed columns 5005 of FIG. 24U based on implementing some or all features and/or functionality of global dictionary compression as disclosed by U.S. Utility application Ser. No. 16/220,454, entitled “DATA SET COMPRESSION WITHIN A DATABASE SYSTEM”, filed Dec. 14, 2018, issued as U.S. Pat. No. 11,256,696 on Feb. 22, 2022, which is hereby incorporated herein by reference in its entirety and made part of the present U.S. Utility Patent Application for all purposes.

In some embodiments, dictionary compression via dictionary structure 5016 can be utilized in performing GDC join processes during query execution to enable recovery of uncompressed values during query execution, for example, based on implementing some or all features and/or functionality of GDC joins as disclosed by U.S. Utility application Ser. No. 18/226,525, entitled “SWITCHING MODES OF OPERATION OF A ROW DISPERSAL OPERATION DURING QUERY EXECUTION”, filed Jul. 26, 2023, which is hereby incorporated herein by reference in its entirety and made part of the present U.S. Utility Patent Application for all purposes.

FIG. 24U illustrates an embodiment of database system 10 where a compressed column filter conversion module 5010 accesses a dictionary structure 5016 to generate an updated filtering expression 5021 in conjunction with query execution.

The compressed column filter conversion module 5010 can generate updated filtering expression 5021 based on updating one or more literals 5011.1 from corresponding literals 5011.0 based on replacing uncompressed values 5012 with compressed values 5013 mapped to these compressed values based on accessing dictionary structure 5016 and determining which fixed-length compressed value 5013 is mapped to each given uncompressed value 5012. Such functionality can be implemented for one or more queries executed by database system 10 to reduce access to the dictionary structure during query execution in conjunction with performing one or more optimizations of the query operator execution flow to improve query performance.

FIG. 24V illustrates an embodiment of executing a join process 2530 that is implemented as a global dictionary compression (GDC) join. This can include applying a matching row determination module 2558 via access to a dictionary structure 5016,

In some embodiments, unlike hash maps generated during query execution for access in conjunction with executing other types of JOIN operations (e.g. as described in U.S. Utility application Ser. No. 18/266,525), the dictionary structure 5016 can optionally be accessed during GDC join processes based on being globally maintained, and thus being generated prior to execution of the corresponding query. In particular, the dictionary structure 5016 can be implemented in conjunction with compressing one or more columns, such as a variable length values stored in one or more variable length columns, by mapping these variable length, uncompressed values (e.g. strings, other large values of a given column) to corresponding fixed-length, compressed values 5013 (e.g. integers or other fixed length values).

For example, segments can store the fixed length values to improve storage efficiency and/or queries can access and process these fixed length values, where the uncompressed variable length values are only required via access to dictionary structure 5016 to emit an uncompressed value 5012 for a given fixed-length value 5013 of a given input row. This functionality can be achieved via performing a corresponding join as described herein, where the matching condition 2519 is implemented for a compressed column and indicates matching by the value of the compressed column, such as simply emitting the uncompressed value mapped to the compressed column as the right output value 2563 for a given input row, implemented as a left input row 2542 of a join operation.

FIG. 24W illustrates an embodiment of database system 10 operable to communicate with a plurality of user entities. Some or all features and/or functionality of FIG. 24W can implement any embodiment of database system 10 described herein.

Various users can send data to and/or receive data from database system 10 over time, for example, as corresponding requests and/or responses. Requests can indicate requests for queries to be executed, requests that include data to be loaded/stored, requests that include configuration data configuring any values/functionality utilized by database system 10 to perform its functionality, data supplied in response to a request from database system 10, and/or other requests to database system 10 for processing by database system 10. Responses can indicate query resultants of executed queries, notifications/confirmation that requests were processed successfully or rendered failure, error notifications, data supplied in response to a request from user entity 2012, and/or other information.

Some or all user entities 2012 can be implemented as user entities corresponding to humans that communicate with database system 10 (e.g. requests are configured via user input to a corresponding computing device of database system 10 or communicating with database system 10); user entities corresponding to groups of multiple people, for example, corresponding to companies/establishments that communicate with database system 10; user entities corresponding to automated entities such as one or more computing devices and/or server systems (e.g. implemented via artificial intelligence, machine learning, and/or configured instructions to cause these automated entities to send requests and/or process responses; and/or corresponding to a given person and configured to send/receive data based on user input from a corresponding person); and/or other user entities. Some or all user entities 2012 can be implemented as humans and/or devices included in/associated with database system 10 (e.g. personnel/employees of a service provided by database system 10; computing devices implementing nodes/processing modules of database system 10 that communicate via internal communication resources of database system 10, etc.). Some or all user entities 2012 can be implemented as humans and/or devices external from database system 10 (e.g. humans/companies that are customers of a service provided by database system 10; computing devices external from the computing devices/nodes/processing resources of database system 10 that communicate with database system 10 via a corresponding communication interface, etc.)

User entities 2012 can include various type of user entities 2012, which can include one or more user entities 2012.A, one or more user entities 2012.B, and/or one or more user entities 2012.C. A given user entity can optionally implement multiple types of user entities 2012 (e.g. a given user entity 2012 operates as both a user entity 2012.A and a user entity 2012.B). Multiple different users (e.g. different people, different devices) can implement a given user entity 2012 (e.g. different employees of a given company implement a given user entity 2012 at different times; different devices associated with a given person or company implement a given user entity 2012 at different times, etc.).

In some embodiments, some or all user entities 2012 can configure/perform functionality corresponding to workload management (WLM).

User entities 2012 can include one or more user entities 2012.A.1-2012.A.M corresponding to query requestor user entities 2005.1-2005.M. Query requestor user entities 2005 can send query requests 2914 indicating queries for execution and/or receive query resultants in response 2920. User entities 2012 can optionally be implemented in a same or similar fashion as external requesting entity 2912.

User entities 2012 can include one or more user entities 2012.B.1-2012.B.S corresponding to database administrator user entities 2006 that request/configure/monitor loading/storage of/access to a corresponding database 1901 that stores a corresponding plurality of database tables 2712.1-2712-T (e.g. database administrator user entities 2006 optionally correspond to data sources that load their data to the system for use in query execution, where this data source sources data included in tables 2712 of a corresponding database 1901).

For example, in some embodiments, database system 10 can implement database storage 2450 to store various tables 2712 corresponding to multiple different databases 1902.1-1901.S, for example, each sourced by, accessible by, and/or configured via corresponding user entities 2012.B. Different databases 1901 can store same or different types of data, same or different numbers of tables 2712, etc. Some or all user entities 2012.A can correspond to a given database 1901 (e.g. based on being associated with the corresponding data source and/or user entities 2012.B) for example, where these user entities are only allowed to query against the given database 1901.

User entities 2012 can include one or more user entities 2012.C corresponding to system administrators of the database system 10 that request/configure/monitor loading/storage of/access to databases in query execution and/or otherwise configure/monitor functionality of database system 10 described herein.

Different user entities can have different corresponding permissions/privileges/access types, for example, indicated in corresponding user permissions data stored by and/or accessible by database system 10. In some embodiments, one or more given user entities can configure permissions of other user entities. Such permissions can configure types of requests that can be sent, restrictions on data included in responses, and/or which data can be accessed (e.g. in loading data and/or requesting data). For example, some users entities 2012.A can be restricted to certain types of queries/query functions be performed, access to only some databases 1902 and/or only some tables 2712, limits on how many queries be executed/how much data be returned, certain levels of query priority, certain service classes of query execution defining corresponding attributes of how queries be executed/how query execution be restricted, etc. As another example, some user entities 2012.B can be restricted to certain types/rates of data loading to a corresponding database 1901, certain permissions regarding how much configuration of database system 10 they can have power over, etc. As another example, different user entities 2012.C can have different permissions regarding how much configuration of database system 10 they can have power over, different functionalities/aspects of database system that they have permissions to configure, etc.

In some embodiments, database system 10 implements a workload management (WLM) system, and service classes 3520 are implemented in conjunction with implementing the WLM system. A service class 3520 can be implemented as a grouping of users (e.g. user entities 2012) that governs many options for querying the database, including the maximum number of concurrent queries that can be executing, scheduling priority of the query, and/or cache settings for the query. For example, the workload management system can be configured by/utilized by a system administrator user entity 2007 to dictate query settings for different types of users and/or different types of queries.

In some embodiments, implementing the WLM system can include determining, when a new user (e.g. user entity 2012.A) is added to the environment: what service class(es) are they assigned to; and/or what happens when their work crosses multiple types of work, all with different priorities. A user can be assigned to multiple service classes (e.g. each of their queries are executed via a given service class selected from the multiple service classes assigned to the user, where different queries requested by a user are executed via different ones of the multiple service classes assigned to the user based on other aspects of the query and/or current conditions), for example, where the hierarchy of their assignment is defined/determined/configured (e.g. via a system administrator).

In some embodiments, implementing the WLM system can include determining when an existing user submits workload of a certain type that falls outside of their normal daily operations or workload management profile, and/or determine how to handle this workload (e.g. is the corresponding query executed or rejected, is the profile for the user updated accordingly, etc.).

In some embodiments, implementing the WLM system can include determining, when job (e.g. query) is running on the system, that it ideally not be killed, but its priority need be changed. For example, this determination can corresponding to a determination to slow down a low priority query that's overwhelming the system or speed up a very important one without losing the progress that's already been made.

FIGS. 25A-25F and FIGS. 26A-26C present embodiments of a database system 10 that addresses ease of service class management and prioritization, for example, to simplify and/or improve WLM usability.

FIGS. 25A-25F illustrate embodiments of a database system 10 operable to select a service class 3520 for execution of a corresponding query based on comparing text of the corresponding query expression 2914 to text patterns 3521 corresponding to different service classes 3520 and selecting a service class 3520.i having a text pattern 3521.i matching and/or otherwise comparing favorably to the text of the query expression 2914. Some or all features and/or functionality of FIGS. 25A-25F can implement any embodiment of database system 10 described herein.

In some embodiments, unless a specific service class 3520 is designated at the query or session level, the service class is selected as the most (and/or in some cases, least) restrictive values from all available service classes. In some embodiments, these may be overridden (made more/less restrictive) by setting them on the query or session level.

In some embodiments, more flexibility and/or configuration is implemented via database system 10 based on enabling automatic service class selection based on query text, for example, via implementing some or all features and/or functionality presented in conjunction with FIGS. 25A-25F.

FIG. 25A illustrates an embodiment of a query processing module 2502 that implements a service class selection module 3505 to select a service class 3520 for a given query (e.g. denoted in an incoming query request 2914 via a corresponding query expression 3515). This can include selecting the given service class 3520.i from a set of service classes 3520.1-3520.C based on determining the given service class 3520.i has a text pattern 3521.i to which the text of query expression 3515 compares favorably (e.g. matches). The query execution module 2504 can execute the given query (e.g. via executing a given query operator execution flow 2517 generator for the query via an operator flow generator module 2514) in accordance with applying at least one query execution attribute 3522.i for the given service class (e.g. applying a corresponding query priority, corresponding limits/restrictions for the service class, etc.).

Some or all features and/or functionality of query processing module 2502 and/or query execution module 2504 of FIG. 25A can implement any embodiment of query processing module 2502 and/or query execution module 2504 described herein. Some or all features and/or functionality of selecting a service class for a query of FIG. 25A can implement any embodiment of selecting a service class for a query described herein, and/or selecting corresponding query priority and/or WLM limits for executing the query described herein.

In some embodiments, each time a query is requested, service class selection module 3505 can be implemented to look through the possible service classes it can run and selected a corresponding service class based on the text of the corresponding query expression 3515, for example, to select values for one or more WLM limits such as the maximum number of rows that can be returned (e.g. “max_row_returned”), and/or to determine which query priority the query can run with.

The query expression 3515 can be implemented as text denoting a corresponding query expression for execution, where this text is compared with the text patterns 3521 of some or all service classes 3520. For example, the query expression 3515 includes text having SQL syntax and/or other syntax denoting a query for execution as configured by database system 1. For example, the query expression 3515 includes calls to corresponding query functions of a function library identified via corresponding text (e.g. function keywords and/or text defining configured arguments to these functions), for example, indicating execution against rows/values of corresponding tables 2712 and/or corresponding columns 2707 via corresponding text denoting identifiers for these tables and/or corresponding columns.

A given text pattern 3521 can indicate one or more text strings that must be included for the query expressions 3515 to match/compare favorably with the text pattern. The given text pattern 3521 can include wildcard characters (e.g. %) denoting any given string can be included in the corresponding arrangement, and/or other “special” characters/metacharacters/strings/keywords having special pattern-based definitions (e.g. \hat{ }, \, ( ), −, ., *, +, $,?) defining the corresponding text pattern (e.g. options for text/type of structure denoted in a given portion of the text pattern to match the corresponding text pattern). For example, the given text pattern 3521 corresponds to an expression to which a LIKE, SIMILAR TO, and/or REGEX comparison be applied in comparing the given text pattern 3521 to the query expression, where the given text pattern 3521 matches and/or otherwise compares favorably to the query expression when the result of this comparison is TRUE and/or otherwise denotes the query service class test data 3510 compares favorably with the text pattern 3521 as defined by the corresponding LIKE, SIMILAR TO, and/or REGEX expression. This can include executing a corresponding LIKE, SIMILAR TO, and/or REGEX operation (e.g. in conjunction with SQL syntax and/or functional, and/or in conjunction with other syntax and/or functionality in conjunction with executing a corresponding function).

In some embodiments, a given text pattern 3521 can indicate one or more text strings corresponding to names/identifiers of query functions, tables 2712, and/or columns 2707, where, if some or all of these text strings are included (e.g. a subset of at least one/all of these strings, for example, in a particular arrangement, as defined by the text pattern 3521), the corresponding text pattern 3521 is met by the corresponding query expression 3515. Configuing of such text patterns with corresponding service classes 3520 can be useful in configuring limitations as to how a given query be executed as a function of which query functions it calls, which tables it is run against, which columns it accesses, and/or some combination of these features (e.g. running a particular combination of one or more functions against a particular column of a particular table renders execution of the corresponding query via a particular service class with particular query priority/limitations).

The query service class text pattern data 3510 (e.g. for a given user entity) can optionally include multiple different text patterns corresponding to different types of query expressions that can optionally be encompassed in a same text pattern (e.g. via a corresponding regular expression denoting different options for falling within this given service class).

In some embodiments, when selecting the service class for a query, the service class selection module 3505 checks service classes one at a time in conjunction with a defined ordering of the service classes 3520 (e.g. ordering from service class 3520.1-3520.C). For example, starting with service class 3520.1 based on service class 3520.1 being first in the ordering, and continues checking one at a time via the ordering until a given service class 3520.i matching the text pattern (e.g. service classes after 3520.i in the ordering need not be checked based on service class 3520.i matching the text pattern, even if additional text patterns 3520 also match that of the query request). Thus, service class 3520.i can correspond to a first service class in the defined ordering having a text pattern 3521 that matches the query expression 3515.

In some embodiments, the defined ordering of the service classes 3520.1-3520.C is based on an alphabetical ordering (e.g. of the names/identifiers of the service classes 3520.1-3520.C). Numeric ordering and/or other ordering schemes can be applied to define the ordering of service classes 3520.1-3520.C in other embodiments.

In the case where none of the service classes 3520.1-3520.C are determined match the query expression 3515 (e.g. after checking all C text patterns 3521.1-3521.C), the service class is optionally selected as the most (and/or in some cases, least) restrictive values of query execution attributes of one or more additional service classes not having corresponding text patterns 3521 (e.g. a set of d additional service classes 3520.C+1-3520.C+d not having corresponding text patterns 3521), which can include a default service class (e.g. the default service class is applied when none of the service classes 3520.1-3520.C are determined match the query expression 3515).

In some embodiments, the default service class can optionally be configured to also have a text pattern 3521 required for its selection (e.g. statement text and/or statement text matcher for the default service class can be modified, for example, via user input by a user entity 2012, for example, based on database system 10 being configured to allow text pattern 3521 to be defined for the default service class), where there are optionally no additional service classes 3520.C+1-3520.C+d not having corresponding text patterns 3521 based on all possible service classes being assigned corresponding text patterns 3521. In such embodiments, if a query request 2914 does not match any service class available (and/or there are no non-statement-text service classes available), including the default service class, an error is returned (e.g. to a corresponding user entity requesting the query request 2914) and/or the query request is not run.

FIG. 25B illustrates an embodiment where different users have different query service class text pattern data 3510 based on given query service class text pattern data 3510 being implemented as per-user query service class text pattern data 3510. Some or all features and/or functionality of per-user query service class text pattern data 3510 of FIG. 25B can implement query service class text pattern data 3510 of FIG. 25A and/or any embodiment of query service class text pattern data 3510 described herein.

The service class selection module 3505 can select the service class 3520 for a given query as a given service class 3520.x.i of a set of service classes 3520.x.1-3520.x.C of a given per-user query service class text pattern data 3510.x mapped to a given user entity 2012.A.x (and/or mapped to a group of multiple user entities that includes the given user entity 2012.A.x) based on receiving the query request 2914 from the given user entity 2012.A.x (and/or otherwise determining the given user entity 2012.A.x generated/wrote the corresponding query expression and/or that the given user entity 2012.A.x requested the corresponding query).

The service class selection module can similarly select service classes for queries requested by other user entities based on corresponding per-user query service class text pattern data for these other user entities. As illustrated in FIG. 25B, user-to-service class text pattern data mapping data 3511 can indicate per-user query service class text pattern data for some or all user entities 2012 of the database system 10 (e.g. some or all query requestor user entities 2005 that request queries for execution). User-to-service class text pattern data mapping data 3511 can be configured via user input (e.g. by a system administrator user entity or one or more database administrator user entities), can be received, can be accessed in memory resources of database system 10, can be automatically generated, and/or can otherwise be determined.

Different per-user query service class text pattern data 3510 can have same or different numbers of service classes C. A given set of service classes of a first per-user query service class text pattern data 3510 can be the same or different (e.g. based on having same or different query execution attributes 3522) from those of a given set of service classes of a second per-user query service class text pattern data 3510 (e.g. these sets are optionally equivalent, optionally have a non-null intersection, and/or optionally have a non-null set difference).

In some embodiments, two different per-user query service class text pattern data 3510 for two different user entities include a same given service class 3520 (e.g. having same query execution attributes 3522), but this same given service class 3520 is mapped to different text patterns 3521 for the two different users. The actual service classes in such an embodiment would be different. They could have the exact same query execution attributes, apart from the text pattern, but their IDs could be different (e.g. service class 12345 and service class 54321). It is further worth noting that, although the system can retrieve service classes for a given user when executing a query, these can ne assigned to groups of users, to which a user may belong. In this example, the service classes for a user can be pulled from the service classes of all groups in the database to which the user belongs.

In some embodiments, two different per-user query service class text pattern data 3510 for two different user entities include a same given service class 3520 (e.g. having same query execution attributes 3522), but this same given service class 3520 is ordered differently in the different per-user query service class text pattern data 3510 (e.g. one per-user query service class text pattern data 3510 has more other service classes prior to the given service class in its respective ordering, which can render this service class being selected for the corresponding user less often in the case where text patterns are evaluated one at a time in accordance with this ordering).

In some embodiments, two different per-user query service class text pattern data 3510 for two different user entities include a same given text pattern 3521 mapped to different service classes (e.g. the given text pattern 3521 is mapped to a first service class 3520 having one or more first query execution attributes 3522 in the first per-user query service class text pattern data 3510 for a first user entity, and the given text pattern 3521 is mapped to a second service class 3520 having one or more second query execution attributes 3522, different some or all of the first query execution attributes 3522, in the second per-user query service class text pattern data 3510 for a second user entity).

FIG. 25C illustrates an embodiment of query processing system 2502 implementing a service class selection module 3505 operable to implement a text pattern comparison module 3530 to apply a text pattern comparison type 3523.i, mapped to the given text pattern 3521.i in the query service class text pattern data 3510, in evaluating whether the given text pattern 3521.i matches/compares favorably to the query expression 3515. Some or all features and/or functionality of the query processing system 2502, service class selection module 3505, and/or query service class text pattern data 3510 of FIG. 25C can implement the query processing system 2502, service class selection module 3505, and/or query service class text pattern data 3510 of FIG. 25A and/or any embodiment of query processing system 2502, service class selection module 3505, and/or query service class text pattern data 3510 described herein.

In some embodiments, automatic service class selection based on query text can be based on adding an optional text pattern 3521 (e.g. a “statement_text” field) and a text pattern comparison type 3523 (e.g. a “statement_text_matcher_type” field) to each service class 3520. For example, a given text pattern field 3521 is a like expression 3528 (e.g. LIKE) and/or a regular expression 3529 (e.g. REGEX), and text pattern comparison type 3523 denotes the type of matcher that given text pattern 3521 is (e.g. indicates the given statement is either a like expression 3528 or a regular expression 3529).

The text pattern comparison module 3530 can apply the text pattern comparison type 3523.i to generate comparison output 3531.i for the given text pattern 3521.i (e.g. a binary output denoting either true or false, or otherwise denoting whether or not the comparison was favorable/the text pattern 3521.i matched the query expression 3515 via applying the text pattern comparison type 3523.i). This can include performance of a corresponding LIKE and/or REGEX operation (e.g. in accordance with SQL and/or another function definition), as denoted by the text pattern comparison type 3523.i for the given text pattern 3521.i.

In some embodiments, each text pattern 3521 is denoted as being in accordance with either the like expression type or the regular expression type, where each given text pattern is thus processed via the text pattern comparison module 3530 via executing/processing the text pattern 3521 in conjunction with processing a corresponding like expression 3528 or a corresponding regular expression 3529. For example, a first proper subset of text patterns (including text pattern 3521.1 in this example) in the set of text patterns 3521.1-3521.C are configured via a text pattern comparison type 3521 corresponding to the like expression 3528, while a second proper subset of text patterns (including text pattern 3521.C in this example) in the set of text patterns 3521.1-3521.C are configured via a text pattern comparison type 3521 corresponding to the regular expression 3529. The first proper subset and second proper subset can both be non-null, can be mutually exclusive, and/or can be collectively exhaustive with respect to the set of text patterns 3521.1-3521.C.

FIG. 25D illustrates an embodiment of query processing system 2502 where a given service class 3520.i has an example set of query execution attributes 3522. Some or all features and/or functionality of the example set of query execution attributes 3522 of FIG. 25D can implement the set of query execution attributes 3522 of any service class 3520 of FIG. 25A and/or any embodiment of service class described herein.

A given service class 3520.i can include a query execution attribute 3522.1 corresponding to one or more query priorities 3541 (e.g. a given query priority value under which the query be executed, multiple query priority values corresponding to a range of query priority values under which the query can be executed/can dynamically change between, and/or other query priority data indicating query priority for a query having this service class).

Alternatively or in addition, a given service class 3520.i can include one or more query execution attributes (e.g. including at least query execution attributes 3522.2 and 3522.3) corresponding to limits 3542 (e.g. defined via configured integer values) of corresponding one or more WLM limit types 3543. For example, a given service class 3520.i can include a query execution attribute 3522.2 corresponding to a limit 3542.1 (e.g. the value of a “max_rows_returned” variable) of a first WLM limit type 3543.1, for example, corresponding to a number of rows returned limit type 3544. As another example, a given service class 3520.i can include a query execution attribute 3522.3 corresponding to a limit 3542.2 (e.g. the value of a “MAX_CONCURRENT_QUERIES” variable) of a second WLM limit type 3543.2, for example, corresponding to a number of concurrent queries limit type 3544.

Execution of a given query via this example service class 3520.i (e.g. based on this service class being selected for the selected query request 2914 via service class selection module 3505 based on query service class text pattern data 3510 and text of the query expression 3515) can include applying the set of query execution attributes 3522 accordingly. For example, the query is executed via applying the query priorities 3541 denoted via query execution attribute 3522.1 (e.g. executing the query at a corresponding priority or within a corresponding priority range, for example, in its concurrent execution with other queries). Alternatively or in addition, the query is executed via applying the one or more limits 3542 via one or more other query execution attributes 3522 corresponding to WLM limit types. For example, the query is executed based on only emitting a number of rows less than or equal to the value of limit 3542.1 (e.g. dropping additional rows as needed) and/or the query is included in a set of concurrently executing queries that includes up to a number of queries denoted by the value of limit 3542.2 (e.g. if this number of queries/more than this number of queries are already concurrently executing, wait to execute the query once less than this number of queries are concurrently executing such that execution of the query and other queries concurrently renders a set of concurrently executing queries that includes less than or equal to a max number of queries denoted by the value of limit 3542.2, where other queries are optionally not added to the set of concurrently executing queries that would render exceeding of this limit until the execution of this query completes). In other examples, if query returns more rows than the value of limit 3542.1, an error message can be generated as result.

Other service classes 3520 in the query service class text pattern data 3510 (e.g. for a given user entity) can optionally include same or different types of query attributes. In cases where one or more types of query attributes are the same, their respective values (e.g. defining query priority 3541 and/or limit 3542) can be same or different. For example, no two queries have equivalent sets of query attributes with all the same values, but can optionally have a proper subset of a shared set of query attributes having the same configured values.

In some embodiments, two or more service classes 3520 have the different sets of query execution attributes 3522 for different sets of WLM limit types 3542 (e.g. same or different numbers of attributes for different numbers of WLM limit types; and/or different sets of query execution attributes 3522 for different sets of WLM limit types 3542 having non-null intersection and/or non-null set difference). For example, one service class has a number of rows returned limit type 3544 and another does not (e.g. has no restriction on number of rows returned). In some embodiments, two or more service classes 3520 have query execution attributes 3522 for some or all of the same WLM limit types 3543 with different limits 3542. For example, one service class has a number of rows returned limit type 3544 with a limit 3542 having a first value, while another service class has a number of rows returned limit type 3544 with a limit 3542 having a second value different from (e.g. less than or greater than) the first value.

FIG. 25E illustrates an embodiment of query processing system where selected service class 3520.i for a given query is cached in cache memory 3533. Some or all features and/or functionality of query processing system 2502 and/or mapping selected service class 3520.i for a given query for use in executing the query via caching can implement query processing system 2502 and/or mapping selected service class 3520.i for a given query for use in executing the query of FIG. 25A and/or any embodiment of query processing system 2502 and/or mapping selected service class 3520.i for a given query for use in executing the query described herein.

In some embodiments, to avoid re-checking query text against text patterns 3521 (e.g. via a corresponding statement text matcher) over and over again (e.g. which can be expensive if the text of the query expression 2914 is large) a matched service class identifier 3536 denoting the service class 3520.i (e.g. a corresponding name/UUID/other identifier for the service class 3520.i) selected for a given query request 2914.j is cached (e.g. stored in query to selected service class mapping data 3534 of cache memory 3533 and mapped to an identifier/other information denoting the given query j to which it is mapped) for the duration of the query. Whenever the query processing system 2502 needs to compare query text vs service class statement text matchers to find the service class for a given query j to be run with (e.g. via query execution module 2504, such as via individual nodes 37 and/or individual processing core resources 48 participating in execution of the query in parallel) the query processing system 2502 can first check whether the matched service class ID 3536.i is cached already (e.g. via one or more corresponding cache accesses 3539.j for the given query request 2914.j). This cache can be reset after the given query is run (e.g. the given query and its corresponding matched service class identifier 3536 are removed).

At a given time, or over time, the cache memory can store matched service class identifiers 3536 for multiple different query requests (e.g. requested over time, and/or being executed concurrently).

In some embodiments, there are three possible types of return values for this matched service class ID check (e.g. values of matched service class ID returned via a given cache access 3539): a null value type 3537 (e.g. NULL), a null value type 3538 (e.g. “std::nullopt”), or a non-null identifier (e.g. a UUID) for the corresponding service class assigned to the query.

If the value returned from that check has null value type 3537 (e.g. is null, for example, due to not being yet stored or not being populated in cache), this indicates that a service class has not yet been attempted to be selected for this query, and should go ahead with checking statement texts (e.g. via implementing service class selection module 3505 to select the service class) and once a match is found (or not found) the matched service class ID value is updated accordingly. In this example, query request 2914.j+1 has such a null value type 3537 returned in cache access based on not being stored in cache yet, where a first cache access 2529.j+1 for this query j+1 can initiate the processing of query request 2914.j+1 via service class selection module 3505 to select the service class for query request 2914.j+1.

If the value returned from that check has null value type 3538 (e.g. a configured value denoting a null ID, different from null value type 3538, for example, populated previously for storage in cache), this indicates that a service class was attempted to be matched for this query and there were no matches (e.g. none of the text patterns 3521.1-3521.C matched the text of its query expression). In this case, query execution attributes 3522 (e.g. one or more WLM limits and/or query priorities) can be selected from additional available service classes without statement text (e.g. one or more additional service classes 3520 are available and have no corresponding text pattern 3521, where a query's query execution attributes 3522 are selected from these additional service classes 3520 when none of the first C service classes are applicable due to none of the text patterns 3521.1-3521.C matching the text of its query expression. In this example, query request 2914.j−2 has such a null value type 3538 returned in cache access based on storing a corresponding value denoting no match was found, where cache access 2529.j−2 for this query j−2 can initiate the query request 2914.j−2 be executed via query execution attributes 3522 selected from these additional service classes 3520 beyond the C service classes 3520.1-3520.C (and/or an error is returned if no such additional service classes 3520 exist based on all possible service classes having corresponding text patterns 3521).

If the value returned from that check is an identifier denoting a given service class 3520, this indicates that a service class was attempted to be matched for this query and that there was a match found. In In this case, query execution attributes 3522 (e.g. one or more WLM limits and/or query priorities) from the given service class 3520 that was matched (e.g. denoted by the identifier for the selected service class 3520). In this example, query requests 2914.j−1 and 2914.j have such non-null identifiers returned in cache access based on storing corresponding values denoting a match was found for query request j−1 corresponding to service class 3520.k and denoting a match was found for query request j corresponding to service class 3520.i, where cache access 2529.j−1 for query j−1 can initiate the query request 2914.j−1 be executed via query execution attributes 3522.k of service class 3520.k, and/or where cache access 2529.j for query j can initiate the query request 2914.j be executed via query execution attributes 3522.i of service class 3520.i.

In some embodiments, executing a query is based on acquiring a slot for the corresponding service class 3520. For example, if a given query matches to a service class, this service class will be attempted to be used in executing the corresponding query. For example, the service class 3520 has a set of slots which can be assigned queries for execution under this service class at a given time (e.g. the number of slots is based on a configured number of concurrently executing queries, for example, set as a limit 3542 for the given service class 3520 for a WLM limit type 3543 corresponding to number of concurrent queries limit type 3544). In some embodiments, if the given service class 3520 it has no slots remaining, rather than trying any other service classes (e.g. which could enable a user to bypass the restrictions the system's service class setup was designed to enforce for the corresponding text pattern), the query is queued until a slot to opens up in that service class.

FIG. 25F illustrates an embodiment of query processing system 2502 where at least one service class 3520.1 is implemented as a query blocking service class 3545 (e.g. “scBlock”) based on having a corresponding query execution attribute 3522 corresponding to a blocking attribute 3547, where the corresponding query request 2914 is not executed due to applying of the blocking attribute 3547. Some or all features and/or functionality of query processing system 2502 and/or query blocking service class 3545 can implement the query processing system 2502 and/or any service class 3520 of FIG. 25A, and/or any embodiment of query processing system 2502 and/or service class 3520 described herein.

In some embodiments, functionality of automated service class selection based on text patterns of query expressions as described in conjunction with FIGS. 25A-25E can be leveraged to prevent running of certain queries (e.g. by certain users). For example, if some or all users should be restricted from running queries against a particular table (e.g. “myschema.really_critical_table”), a service class 3520 can be configured to have a corresponding text pattern denoting this table (e.g. a match corresponds to any query that includes the text of the name of the table, such as inclusion of the text “myschema.really_critical_table”), and this service class 3520 can be configured as a query blocking service class 3545 based on the service class 2520 having at least one query execution attribute 3522 dictating that a corresponding query cannot be run. For example, if a corresponding user tries to run something like “select * from myschema.really_critical_table” the query will automatically run with query blocking service class 3545 and the user will be prevented from running the query.

Other types of queries can be similarly blocked via corresponding text patterns 3521 (e.g. prohibited types/combinations of query functions, tables, and/or columns can be enforced based on having their respective names/identifiers included in text pattern 3521 for the query blocking service class 3545. The query service class text pattern data 3510 (e.g. for a given user entity) can optionally include multiple query blocking service classes 3545 corresponding to different text patterns corresponding to query expression to be prevented from execution. Alternatively, multiple different text patterns corresponding to different types of query expressions can optionally be encompassed in a same text pattern (e.g. via a corresponding regular expression denoting different options for falling within this given service class).

In some embodiments, such blocking of query execution can be achieved based on the query blocking service class 3545 can be first ordered in the ordering of service classes (e.g. is first alphabetically or otherwise is first in the ordering), where the first service class 3520.1 of the set of service classes is implemented as query blocking service class 3545, dictating that its text pattern 3521.1 be checked first. Thus, even if the given query matches other text patterns of other service classes that are non-blocking, the query blocking service class 3545 will be selected if the given query expression text matches the text pattern 3521.1 for the query blocking service class 3545 based on being checked first. If multiple query blocking service classes 3545, they can be the first ordered service classes before any non-blocking service classes in the ordering.

Alternatively or in addition, such blocking of query execution can be achieved based on setting WLM limit 3542 of a query execution attribute 3522 of the query blocking service class 3545 having WLM limit type 3545.2 corresponding to the number of concurrent queries limit type 3544 to a value set to zero (e.g. the value of a “MAX_CONCURRENT_QUERIES” is set to zero), dictating that the set of concurrently running queries that queries of this service class can be included in have no more than zero queries, rendering it impossible for queries of this service class to ever be run as their inclusion in a set of running queries would render the size of this set greater than or equal to one.

Different per-user query service class text pattern data 3510 can include query blocking service classes 3545 with same or different text patterns 3521 (e.g. different user entities have different text patterns 3521 based on being prohibited from running different types of queries, such as queries with different particular query functions, queries against different particular tables, and/or queries against different particular columns). One or more per-user query service class text pattern data 3510 optionally have no query blocking service classes 3545 (e.g. no type of query is prohibited entirely for these users), for example, where some users have query blocking service classes 3545 and others don't).

In some embodiments, some or all features and/or functionality of limits imposed via service classes, for example in accordance with implementing workload management, imposing limitations on queries (e.g. imposing maximums on number of rows returned), and/or imposing limits based on query attributes such as user entity, a table being accessed, and/or a query function being performed as described herein implements some or all features and/or functionality of or functionality of limits imposed via service classes, imposing limitations on queries (e.g. via rulesets enforced via compliance modules), and/or imposing limits based on query attributes such as user entity, a table being accessed, and/or a query function being performed as disclosed by: U.S. Utility application Ser. No. 16/668,402, entitled “ENFORCEMENT OF SETS OF QUERY RULES FOR ACCESS TO DATA SUPPLIED BY A PLURALITY OF DATA PROVIDERS”, filed Oct. 30, 2019, which is hereby incorporated herein by reference in its entirety and made part of the present U.S. Utility Patent Application for all purposes.

FIG. 25G illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 25G, for example, based on participating in execution of a query being executed by the database system 10. Some or all of the method of FIG. 25G can be performed by nodes executing a query in conjunction with a query execution, for example, via one or more nodes 37 implemented as nodes of a query execution module 2504 implementing a query execution plan 2405. In some embodiments, a node 37 can implement some or all of FIG. 25G based on implementing a corresponding plurality of processing core resources 48.1-48.W. Some or all of the steps of FIG. 25G can optionally be performed by any other one or more processing modules of the database system 10. Some or all of the steps of FIG. 25G can be performed to implement some or all of the functionality of the database system 10 as described in conjunction with FIGS. 25A-25F, for example, by implementing some or all of the functionality of query processing module 2502, query execution module 2504, service class selection module 3503, and/or query service class text pattern data 3510. Some or all steps of FIG. 25G can be performed by database system 10 in accordance with other embodiments of the database system 10 and/or nodes 37 discussed herein. Some or all of the steps of FIG. 25G can be performed in conjunction with performing some or all steps of any other method described herein.

Step 2582 includes determining query service class text pattern data indicating a plurality of text patterns each corresponding to one of a plurality of service classes. Step 2584 includes determining a query expression indicating a query for execution. Step 2586 includes utilizing the query service class text pattern data to select one service class of the plurality of service classes for the query based on text of the query expression matching a corresponding text pattern of the plurality of text patterns that corresponds to the one service class. Step 2588 executing the query in accordance with a set of query execution attributes of the one service class based on selecting the one service class for the query.

In various examples, the set of query execution attributes includes a query priority of a plurality of query priorities and/or at least one limit for at least one workload management limit type.

In various examples, the at least one workload management limit type includes a number of rows returned limit type. In various examples, executing the query in accordance with the set of query execution attributes of the one service class includes generating a query resultant for the query based on emitting only up to a threshold maximum number of rows indicated as the limit for the number of rows returned type for the one service class.

In various examples, the at least one workload management limit type includes a number of concurrent queries limit type. In various examples, executing the query in accordance with the set of query execution attributes of the one service class includes executing the query with other queries included in a set of concurrently executing queries that includes only up to a threshold maximum number of queries indicated as the limit for the number of concurrent queries limit type for the one service class.

In various examples, the one service class is a query blocking service class. In various examples, the threshold maximum number of queries indicated as the limit for the number of concurrent queries limit type has a value of zero for the one service class based on the one service class being the query blocking service class. In various examples, the query is not executed based on the limit for the number of concurrent queries limit type having the value of zero.

In various examples, each of the plurality of service classes has a corresponding plurality of query execution attributes. In various examples, a second one of the plurality of service classes has a second set of query execution attributes different from the set of query execution attributes based on including: a second query priority of the plurality of query priorities different from the query priority; and/or a second at least one limit for the at least one workload management limit type different from the at least one limit.

In various examples, utilizing the query service class text pattern data to select one service class of the plurality of service classes includes comparing the text of the query expression to one text pattern of the plurality of text patterns at a time, in accordance with an ordering of the plurality of service classes starting with a first ordered one of the plurality of service classes, until identifying a match with a text pattern of one of the plurality of services classes. In various examples, the one service class is selected based on being a first instance of the text of the query matching with any of the plurality of text patterns.

In various examples, the ordering of the plurality of service classes corresponds to an alphabetical ordering of the plurality of service classes by names of the plurality of service classes.

In various examples, the first ordered one of the plurality of service classes is a query blocking service class. In various examples, the query blocking service class is the one service class selected for the query based on the text pattern of the first ordered one of the plurality of services classes matching the text of the query. In various examples, the query is not executed based on selecting the query blocking service class for the query.

In various examples, the query expression is received from a user entity in a corresponding query request. In various examples, the method further includes identifying the plurality of service classes as a first set of service classes available to the user entity based on user-to-service class text pattern data mapping data indicating sets of service classes available to each of a plurality of user entities. In various examples, the query service class text pattern data is utilized to select one service class based on only evaluating service classes included in the first set of service classes available to the user entity. In various examples, the one service class is included in the first set of services classes.

In various examples, the user-to-service class text pattern data mapping data indicates a second set of service classes available to a second user entity. In various examples, the second set of service classes has a non-null set difference with the first set of service classes. In various examples, the method further includes determining a second query expression indicating a second query for execution based on receiving the second query expression from the second user entity in a second corresponding query request; selecting a selected service class of the second set of service classes for the second query based on text of the query expression matching a text pattern that corresponds to the selected service class of the second set of service classes; and/or executing the second query in accordance with the selected service class of the second set of service classes based on selecting the selected service class of the second set of service classes for the second query.

In various examples, the selected service class of the second set of service classes is the one service class based on the one service class being included in a non-null intersection of the second set of service classes and the first set of service classes. In various examples, the text of the second query is different from the text of the query. In various examples, both the text of the query and the text of the second query match the corresponding text pattern for the one service class.

In various examples, the selected service class of the second set of service classes is different from the one service class despite the text for the second query matching the corresponding text pattern for the one service class based on the one service class not being included in the second set of service classes.

In various examples, the selected service class of the second set of service classes is different from the one service class despite the text for the second query matching the corresponding text pattern for the one service class based on the one service class being included in the second set of service classes.

In various examples, the selected service class of the second set of service classes is selected instead of the one service class based on the selected service class of the second set of service classes being higher ordered (e.g. alphabetically) in an ordering of the second set of service classes.

In various examples, the query expression is received from a user entity in a corresponding query request. In various examples, the query service class text pattern data is first per-user query service class text pattern data determined for the user entity. In various examples, the method further includes: determining second per-user query service class text pattern data for a second user indicating a second plurality of text patterns each corresponding to one of the plurality of service classes; determining a second query expression from a second user entity indicating a query for execution; utilizing the second per-user query service class text pattern data to select a selected service class of the plurality of service classes for the second query based on text of the second query expression matching a second corresponding text pattern of the second plurality of text patterns that corresponds to the selected service class in the second per-user query service class text pattern data; and/or executing the second query in accordance with the second set of query execution attributes of the selected service class based on selecting the selected service class for the second query.

In various examples, the selected service class of the plurality of service classes selected for the second query is the one service class. In various examples, the one service class is selected for the second query despite the text of the second query expression not matching the corresponding text pattern for the one service class in the first per-user query service class text pattern data based on the second corresponding text pattern for the one service class indicated in the second per-user query service class text pattern data being different from the corresponding text pattern of the first per-user query service class text pattern data.

In various examples, the selected service class of the plurality of service class for the second query is a second service class distinct from the one service class. In various examples, the second service class is selected instead of the one service class despite the text of the second query expression matching the corresponding text pattern for the one service class based on another corresponding text pattern mapped to the one service class in the second per-user query service class text pattern data being different from the corresponding text pattern and not matching the text of the second query.

In various examples, the corresponding text pattern indicates at least one text string. In various examples, the one service class is selected based on the text of the query including the at least one text string.

In various examples, the at least one text string includes: at least one table name of at least one relational database table; at least one column name of at least one column of the at least one relational database table; and/or at least one function identifier for at least one query function. In various examples, the corresponding text pattern indicates the at least one text string based on: the query expression indicating access to the at least one relational database table in executing the query; the query expression indicating access to the at least one column of the at least one relational database table in executing the query; and/or the query expression indicating performance of the at least one query function in executing the query.

In various examples, the corresponding text pattern further indicates comparison with the text of the query be in accordance with either a like expression or a regular expression. In various examples, the text of the query expression is determined to match the corresponding text pattern in accordance with applying either the like expression or the regular expression, based on whether the like expression or the regular expression was indicated for the corresponding text pattern.

In various examples, a second text pattern of the query service class text pattern data for a second query class indicates the comparison with the text of the query be in accordance a different type of expression that is different from that of the corresponding text pattern.

In various examples, the method further includes determining to utilize the query service class text pattern data to select the one service class of the plurality of service classes for the query based on determining no service class is yet mapped to the query in cache based on first performance of a matched service class identifier check via accessing a cache memory; mapping a service class identifier for the one service class in the cache memory based on the one service class being selected for the query; and/or after determining to utilize the query service class text pattern data to select the one service class, further determining the query service class text pattern data is not needed for further processing the query based on determining the one service class is already mapped to the query in cache based on second performance of the matched service class identifier check via accessing the cache memory; and/or resetting the cache memory after completing execution of the query to remove the mapping of the service class mapped to the query in the cache memory.

In various examples, performance of the matched service class identifier check for a corresponding query renders a returned value corresponding to one of: a first null value type denoting no service class is yet mapped to the corresponding query in cache due to the query service class text pattern data not yet being utilized for the corresponding query to identify a matching service class, where the first performance of the matched service class identifier check renders returning of the first null value type; a second null value type denoting no service class is mapped to the corresponding query in cache based on the query service class text pattern data having been utilized for the corresponding query and no matching service class being identified, where a selected service class for the corresponding query was determined without utilizing the query service class text pattern data based on the second null value type being returned; or an identifier for a corresponding service class mapped to the corresponding query in cache based on the query service class text pattern data having been utilized for the corresponding query to select the corresponding service class for the corresponding query based on having a text pattern matching corresponding text of a corresponding query expression of the corresponding query, where the second performance of the matched service class identifier check renders returning of the identifier for the one service class.

In various examples, each of the plurality of service classes are implemented via a corresponding plurality of query slots. In various examples, the method further includes in response to selecting the one service class at a first time: determining to delay execution of the query based on the executing the query in accordance with a set of query execution attributes of the one service class based on the corresponding plurality of query slots for the one service class all being filled at the first time; and/or executing the query at a second time after the first time based on at least one of the corresponding plurality of query slots being available at the second time. In various examples, the query is assigned to the one of the corresponding plurality of query slots at the second time.

In various examples, the method further includes: determining a second query expression indicating a second query for execution; utilizing the query service class text pattern data to determine none of the plurality of service classes have text patterns matching text of the second query expression; and/or returning an error notification to a user entity that requested the second query based on determine none of the plurality of service classes have text patterns matching text of the second query expression.

In various examples, the plurality of services classes includes a default service class. In various examples, the default service class is not selected for the second query expression based on a text pattern of the default service class not matching text of the second query expression.

In various embodiments, any one of more of the various examples listed above are implemented in conjunction with performing some or all steps of FIG. 25G. In various embodiments, any set of the various examples listed above can be implemented in tandem, for example, in conjunction with performing some or all steps of FIG. 25G, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 25G described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 25G, for example, in conjunction with further implementing any one or more of the various examples described above.

In various embodiments, the operational instructions, when executed by the at least one processor, cause the database system to: determine query service class text pattern data indicating a plurality of text patterns each corresponding to one of a plurality of service classes; determine a query expression indicating a query for execution; utilize the query service class text pattern data to select one service class of the plurality of service classes for the query based on text of the query expression matching a corresponding text pattern of the plurality of text patterns that corresponds to the one service class; and/or execute the query in accordance with a set of query execution attributes of the one service class based on selecting the one service class for the query.

FIGS. 26A-26C illustrate embodiments of a database system 10 operable to alter the query priority of a currently running query based on processing an alter query priority command. Some or all features and/or functionality of FIGS. 26A-26C can implement any embodiment of database system 10 described herein.

FIG. 26A illustrates an embodiment of a database system that implements a query scheduling module 4215 to generate query scheduling data 4216 for concurrent execution of a plurality of queries 1-R based on priority values 2942 of the plurality of queries, for example, determined via a priority determination module 3210. Execution scheduling instructions 4217.1-4217.R can be indicated for the plurality of queries, for example, indicating scheduling of operator executions of operators 2520 of query operator execution flows 2517.1-2517.R for the queries 1-R (e.g. executed via a corresponding node 37 and/or corresponding one or more processing core resources 48 over a plurality of time windows, where a given operator execution of a given operator of a given query is scheduled in a given time window, and/or where proportion of time assigned to execution of a given query is proportional to/otherwise influenced by their respective priority value 2942, where one or more different nodes and/or different processing core resources 48 optionally implement some or all features and/or functionality of FIG. 26A in conjunction with parallelized participation in executing the corresponding query, for example, in accordance with participation in a corresponding query execution plan 2405).

In some embodiments, some or all features and/or functionality of concurrently executing queries via scheduling of execution in accordance with assigned query priority, setting/updating query priority of queries, and/or workload management as described herein implements some or all features and/or functionality of concurrently executing queries in accordance with assigned query priority, setting/updating query priority of queries, and/or workload management as disclosed by: U.S. Utility application Ser. No. 18/482,939, entitled “PERFORMING SHUTDOWN OF A NODE IN A DATABASE SYSTEM”, filed Oct. 9, 2023, which is hereby incorporated herein by reference in its entirety and made part of the present U.S. Utility Patent Application for all purposes; and/or U.S. Utility application Ser. No. 18/226,525, entitled “SWITCHING MODES OF OPERATION OF A ROW DISPERSAL OPERATION DURING QUERY EXECUTION”, filed Jul. 26, 2023, which is hereby incorporated herein by reference in its entirety and made part of the present U.S. Utility Patent Application for all purposes.

In some embodiments, the priority determination module 3210 of FIG. 26A can be implemented to determine query priorities (e.g. corresponding priority values 2942) for queries scheduled for execution. This can include determining an initial priority value 2942.0 for each query, which can be fixed or can dynamically change automatically over time, for example, in conjunction with implementing a dynamic priority update strategy (e.g. via implementing some or all features and/or functionality of dynamic priority update module of U.S. Utility application Ser. No. 18/482,939). The query priorities (e.g. initial priority values) can be determined based on a service class 3520 determined for the query, for example, in conjunction with implementing some or all features and/or functionality of service class selection module 3505. For example, a query execution attribute 3522 for a service class assigned to a given query indicates/is utilized to determine the priority value 2942, for example, as the corresponding query priority 3541 indicated by the query execution attribute 3522 and/or as one query priority selected from a range of query priorities indicated by the query execution attribute 3522. As another example, the query priority is determined based on a corresponding user entity 2012 (e.g. where different user entities are assigned different query priorities/different ranges of query priorities and/or from the service class or classes available to the user entity).

FIGS. 26B and 26C illustrate changing of a given query priority for a given query from an initial query priority value 2942.y.0 determined at a first time t0 to an updated query priority value 2942.y.1 at a later time t1, based on the query priority for the query being altered in an alter query priority command processed during an execution time period of the query y, for example, corresponding to the time period after initiation of execution of the query y and before completion of execution of the query y, where the query y is optionally concurrently executed with one or more other queries (E.g. is included in the set of queries 1-R of FIG. 26A) during some or all of its execution time period. Some or all features and/or functionality of the query scheduling module 4215 and/or query execution module 2504 of FIGS. 26B-26C can implement query scheduling module 4215 and/or query execution module 2504 of FIG. 26A and/or any embodiment of query scheduling module 4215 and/or query execution module 2504 described herein.

FIG. 26B illustrates execution of a query via a query execution module 2504 during a first portion of the execution time period (e.g. after a first time to and before a second time t1) based on query scheduling data 4216 generated based on an initial priority value 2942.y.0 for the query, denoting execution scheduling instructions 4217.y.0 rendering a first portion of execution of the query y (e.g. a first set of operator executions of operators 2520 of query operator execution flow 2517) being executed in accordance with the initial query priority value 2942.y.0 (e.g. in conjunction with also scheduling concurrent execution of other queries of a set of concurrently executing queries). While not illustrated, during this first portion of the execution time period, the query priority optionally changes dynamically automatically in conjunction with implementing a dynamic priority update strategy, for example, via implementing some or all features and/or functionality of dynamic priority update module of U.S. Utility application Ser. No. 18/482,939.

FIG. 26C illustrates execution of this query via a query execution module 2504 during a second portion of the execution time period (e.g. after the second time t1) based on query scheduling data 4216 generated based on an updated priority value 2942.y.1 for the query generated via an alter query priority command processing module 3211 based on processing an alter query priority command 3212 rendering a second portion of execution of the query y (e.g. a second set of operator executions of operators 2520 of query operator execution flow 2517) being executed in accordance with the updated query priority value 2942.y.1 (e.g. in conjunction with also scheduling further concurrent execution of other queries of the set of concurrently executing queries).

In some embodiments, there are situations where it can be ideal (e.g. as determined by a user entity) to immediately alter the priority of a running query. This can be accomplished via the database system 10 being configured to process an alter query priority command 3212 (e.g. based on this command being defined in a function library and/or otherwise being known to database system 10 to enable the database system 10 to parse/process such commands received over time).

The alter query priority command 3212 can indicate a given query y to have its priority altered based on indicating a query identifier 3213 in the alter query priority command 3212 that indicates the given query y. The alter query priority command 3212 can alternatively or additionally indicate a query priority 3541 denoting a corresponding updated priority value 2942.y.1 for the given query y. It should be noted, in various examples, the updated priority value may be the same as the initial priority value of the query (or whatever priority the query is running with at the time the alter query priority command attempts to modify the priority).

For example, the query priority 3541 and the query identifier 3213 are configurable arguments of the alter query priority command 3212, for example, configured (e.g. via user input to a corresponding computing device) by a corresponding user entity 2012 that generates and/or sends the alter query priority command 3212. The alter query priority command 3212 can be expressed (e.g. as a text statement) in accordance with syntax defined for the alter query priority command 3212 (e.g. one or more corresponding keywords identifying the alter query priority command 3212 and/or the corresponding arguments, for example, in accordance with a defined ordering).

As a particular example, the alter query priority command 3212 can be implemented as:
alter query “<query_uuid>” set priority <priority>

For example, <query uuid> corresponds to the argument for the query identifier 3213 and/or <priority> corresponds to the argument for query priority 3541, and/or “alter”, “query”, “set” and/or “priority” correspond to keywords for the alter query priority command 3212.

The query priority command processing module 3211 can process incoming alter query priority commands 3212 (e.g. in accordance with a function definition for the alter query priority commands 3212). This can include determining whether or not to process the alter query priority commands 3212 and update the priority value for the query accordingly as the updated priority value 2942.y.1 denoted in the alter query priority command 3212 based on determining whether one or more conditions required by query priority update condition data 3215 are met.

For example, the query priority update condition data 3215 can require that a user entity 2012 issuing the alter query priority command 3212 must either be the user who originally issued the query, a system administrator, or a database administrator for whichever database the query is running on. Such checking of the roles assigned to the user entity against these requirements can be performed via the query priority command processing module 3211 to determine whether to update the priority value for the query. For example, the user entity does not fit into one of these categories, for example as defined by the query priority update condition data 3215, the priority of the query is not altered (e.g. as the user entity is not allowed to alter the query priority), and an error is optionally returned (e.g. a notification indicating the error is sent back to the user entity 2012 that sent the alter query priority commands 3212).

For example, the query priority update condition data 3215 can require that the updated priority value 2942.y.1 denoted in the alter query priority command 3212 be within an allowed query priority range (e.g. the minimum and maximum priority) this query can run with (e.g. as assigned to the corresponding user entity that requested the query and/or as indicated in a service class 3520 assigned to the query). Such checking of the updated priority value 2942.y.1 denoted in the alter query priority command 3212 against an allowed query priority query priority range for the query can be performed via the query priority command processing module 3211 to determine whether to update the priority value for the query. For example, if the updated priority value 2942.y.1 denoted in the alter query priority command 3212 does not fall within the query priority range for the query, the priority of the query is not altered, and an error is optionally returned (e.g. a notification indicating the error is sent back to the user entity 2012 that sent the alter query priority commands 3212).

In some embodiments, altering query priority via an updated priority value 2942.y.1 can include sending a VM request (e.g. to query scheduling module 4215 for configuring of query scheduling data 4216 processed via query execution module 2504), for example, using a same or similar mechanism utilized to facilitate dynamic query priority adjustments as disclosed by U.S. Utility application Ser. No. 18/482,939.

In embodiments where automatic dynamic query priority adjustments are implemented via implementing a dynamic priority update strategy (e.g. as disclosed by U.S. Utility application Ser. No. 18/482,939) any further dynamic priority adjustments can be disabled for the given query y if its priority is successfully updated via an alter query priority command 3212 (e.g. alter query priority command 3212 is effectively implemented as “hard override”). In some embodiments, if the query priority is not successfully set via a received alter query priority command 3212 (e.g. due to the alter query priority command 2942 failing to meet query priority update condition data 3215), such dynamic priority adjustment are not disabled/are re-enabled.

In some embodiments, even in cases where further dynamic priority adjustments are disabled for the given query, the given query y can optionally have its query priority further altered via one or more subsequent alter query priority commands 3212, enabling a query priority to be altered in this fashion multiple times over the lifetime of the query.

FIG. 26D illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 26D, for example, based on participating in execution of a query being executed by the database system 10. Some or all of the method of FIG. 26D can be performed by nodes executing a query in conjunction with a query execution, for example, via one or more nodes 37 implemented as nodes of a query execution module 2504 implementing a query execution plan 2405. In some embodiments, a node 37 can implement some or all of FIG. 26D based on implementing a corresponding plurality of processing core resources 48.1-48.W. Some or all of the steps of FIG. 26D can optionally be performed by any other one or more processing modules of the database system 10. Some or all of the steps of FIG. 26D can be performed to implement some or all of the functionality of the database system 10 as described in conjunction with FIGS. 26A-26C, for example, by implementing some or all of the functionality of query scheduling module 4215, query execution module 2504, alter query priority command processing module 3211, and/or alter query priority command 3212. Some or all steps of FIG. 26D can be performed by database system 10 in accordance with other embodiments of the database system 10 and/or nodes 37 discussed herein. Some or all of the steps of FIG. 26D can be performed in conjunction with performing some or all steps of any other method described herein.

Step 2682 includes receiving a query request indicating a query for execution against at least one relational database table stored by the database system. Step 2684 includes determining an initial query priority (e.g. an initial query priority value 2942) for the query. Step 2686 includes initiating execution of the query based on scheduling initial execution of the query in scheduling data for a plurality of concurrently executing queries in accordance with the initial query priority.

Steps 2688-2892 can be performed during an execution time period of the query after initiating the execution of the query. Step 2688 includes receiving an alter query priority command from a user entity indicating an updated query priority (e.g. updated query priority value 2942) for the query. Step 2690 includes determining query priority update condition data is met by the alter query priority command. Step 2692 includes performing continued execution of the query based on scheduling further execution of the query in accordance with the updated query priority based on determining the query priority update condition data is met by the alter query priority command.

In various examples, the query request is received from the user entity based on the user entity corresponding to a query requestor user entity.

In various examples, the query request is received from a second user entity different from the user entity. In various examples, the second user entity is different from the user entity based on the second user entity corresponding to a query requestor user entity and the user entity corresponding to a system administrator user entity for the database system. In various examples, the second user entity is different from the user entity based on the second user entity corresponding to a query requestor user entity and the user entity corresponding to a database administrator user entity for one database of a plurality of databases stored by the database system that includes the at least one relational database table.

In various examples, the database system stores a plurality of databases. In various examples, a plurality of user entities of the database system include a plurality of database administers each corresponding to one of the plurality of databases. In various examples, the query request indicates execution of the query against one of the plurality of databases based on the at least one relational database table being included in the one of the plurality of databases. In various examples, the user entity corresponds to one of the plurality of database administrators for the one of the plurality of databases.

In various examples, the query priority update condition data includes a user entity-based condition requiring that the user entity is one of a set of acceptable user entities determined for the query. In various examples, the set of acceptable user entities includes: a query requestor user entity corresponding to the query request; a database administrator user entity corresponding to the at least one relational database table; and/or a system administrator user entity corresponding to the database system.

In various examples, the method further includes determining the set of acceptable user entities for the query based on: including the query requestor user entity in the set of acceptable user entities for the query based on at least one of: having received the query request from the query requestor user entity, or determining the query requestor user entity generated the query request; and/or including the database administrator user entity in the set of acceptable user entities for the query based on determining the at least one relational database table indicated in the query is included in a database stored by the database system is managed by the database administrator user entity.

In various examples, the method further includes receiving a second query request indicating a second query for execution against at least one second relational database table stored by the database system and/or determining a second set of acceptable user entities for the second query based on at least one of: including a second query requestor user entity, distinct from the query requestor user entity, in the second set of acceptable user entities for the second query based on at least one of: having received the query request from the second query requestor user entity, or determining the second query requestor user entity generated the query request; and/or including a second database administrator user entity, distinct from the database administrator user entity, in the second set of acceptable user entities for the second query based on determining the second at least one relational database table indicated in the query is included in a second database, stored by the database system and distinct from the database, is managed by the second database administrator user entity.

In various examples, the query priority update condition data includes a query priority range-based condition requiring that the updated query priority is included in a set of query priorities falling withing an allowed query priority range determined for the query.

In various examples, the method further includes determining the allowed query priority range for the query based on selecting a service class for the query indicating the allowed query priority range. In various examples, the service class is selected for the query based on determining text of a query expression for the query matches a text pattern for the service class.

In various examples, the method further includes: receiving a second query request indicating a second query for execution; determining a second initial query priority for the second query; and/or initiating execution of the second query based on scheduling initial execution of the second query in second scheduling data for a second plurality of concurrently executing queries in accordance with the second initial query priority. In various examples, the method further includes, during a second execution time period of the second query after initializing the execution of the second query: receiving a second alter query priority command from a second user entity indicating second updated query priority for the second query; determining the query priority update condition data is unmet by the second alter query priority command; and performing continued execution of the second query based on scheduling further execution of the second query in accordance with the second initial query priority based on determining the query priority update condition data is unmet by the second alter query priority command. In various examples, the method further includes sending an error notification to the second user entity in response to determining the query priority update condition data is unmet by the second alter query priority command.

In various examples, the alter query priority command indicates a query identifier denoting the query and a priority value denoting the updated query priority.

In various examples, the method further includes detecting the alter query priority command based on having syntax in accordance with an alter query priority function call to an alter query priority function of the database system; and/or extracting the query identifier and the priority value from the alter query priority command based on detecting the alter query priority command.

In various examples, the alter query priority function of the database system has a corresponding function definition denoting a set of configurable argument of the alter query priority function that includes a query identifier argument and a priority value argument. In various examples, the query identifier argument is configured in the alter query priority command as the query identifier denoting the query. In various examples, the priority value argument is configured in the alter query priority command as the priority value denoting the updated query priority.

In various examples, the query identifier indicated in the alter query priority command denotes the query based on at least one of: the query identifier being indicated in the query request; the query identifier being assigned to the query based on receiving the query request; and/or the query identifier being communicated to the user entity based on the query identifier being assigned to the query.

In various examples, at least some of the plurality of concurrently executing queries are automatically assigned at least one updated query priority during execution based on applying a dynamic priority update strategy in scheduling execution of the plurality of executing queries. In various examples, scheduling of the at least some of the plurality of concurrently executing queries over time is in accordance with the at least one updated query priority.

In various examples, the method further includes, in response to receiving the alter query priority command for the query and determining the query priority update condition data is met by the alter query priority command, overriding the dynamic priority update strategy for the query. In various examples, the query is not automatically assigned any further updated priorities via the dynamic priority update strategy after overriding the dynamic priority update strategy for the query. In various examples, all continued execution of the query is based on scheduling further execution of the query in accordance with the updated query priority indicated in the alter query priority command based on overriding the dynamic priority update strategy for the query.

In various examples, the alter query priority command is received from the user entity at a first time during the execution time period. In various examples, the continued execution of the query is based on scheduling further execution of the query in accordance with the updated query priority during a first time frame within the execution time period after the first time. In various examples, the method further includes, during the execution time period of the query: receiving, at a second time after the first time, a second alter query priority command indicating a second updated query priority for the query; determining the query priority update condition data is met by the second alter query priority command; and performing further continued execution of the query during a second time frame after the first time frame based on scheduling further execution of the query in accordance with the second updated query priority based on determining the second updated query priority update condition data is met by the second alter query priority command. In various examples, the second alter query priority command is received from the user entity. In various examples, the second alter query priority command is received from a second user entity different from the user entity.

In various examples, the execution of the query is completed over a duration of the execution time period based on scheduling a plurality of operator executions for the query in the scheduling data and performing the plurality of operator executions over at least some of a plurality of time windows within the execution time period based on the scheduling data. In various examples, during a first time frame prior to determining the query priority update condition data is met by the alter query priority command, operator executions are scheduled in a first set of time windows within the first time frame corresponding to a first proportion of time windows within the first time frame based on the initial query priority. In various examples, during a second time frame after determining the query priority update condition data is met by the alter query priority command, operator executions are scheduled in a second set of time windows within the second time frame corresponding to a second proportion of time windows within the second time frame based on the updated query priority. In various examples, the first proportion of time windows is less than the second proportion of time windows based on the initial query priority being lower priority than the updated query priority. In various examples, the first proportion of time windows is greater than the second proportion of time windows based on the initial query priority being greater priority than the updated query priority.

In various embodiments, any one or more of the various examples listed above are implemented in conjunction with performing some or all steps of FIG. 26D. In various embodiments, any set of the various examples listed above can be implemented in tandem, for example, in conjunction with performing some or all steps of FIG. 26D, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 26D described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 26D, for example, in conjunction with further implementing any one or more of the various examples described above.

In various embodiments, the operational instructions, when executed by the at least one processor, cause the database system to: receive a query request indicating a query for execution against at least one relational database table stored by the database system; determine an initial priority for the query; and/or initiating execution of the query based on scheduling initial execution of the query in scheduling data for a plurality of concurrently executing queries in accordance with the initial priority. In various embodiments, the operational instructions, when executed by the at least one processor, further cause the database system to, during an execution time period of the query after initializing the execution of the query: receive an alter query priority command from a user entity indicating an updated priority for the query; determine query priority update condition data is met by the alter query priority command; and/or perform continued execution of the query based on scheduling further execution of the query in accordance with the updated priority based on determining the query priority update condition data is met by the alter query priority command.

As used herein, an “AND operator” can correspond to any operator implementing logical conjunction. As used herein, an “OR operator” can correspond to any operator implementing logical disjunction.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., indicates an advantageous relationship that would be evident to one skilled in the art in light of the present disclosure, and based, for example, on the nature of the signals/items that are being compared. As may be used herein, the term “compares unfavorably”, indicates that a comparison between two or more items, signals, etc., fails to provide such an advantageous relationship and/or that provides a disadvantageous relationship. Such an item/signal can correspond to one or more numeric values, one or more measurements, one or more counts and/or proportions, one or more types of data, and/or other information with attributes that can be compared to a threshold, to each other and/or to attributes of other information to determine whether a favorable or unfavorable comparison exists. Examples of such an advantageous relationship can include: one item/signal being greater than (or greater than or equal to) a threshold value, one item/signal being less than (or less than or equal to) a threshold value, one item/signal being greater than (or greater than or equal to) another item/signal, one item/signal being less than (or less than or equal to) another item/signal, one item/signal matching another item/signal, one item/signal substantially matching another item/signal within a predefined or industry accepted tolerance such as 1%, 5%, 10% or some other margin, etc. Furthermore, one skilled in the art will recognize that such a comparison between two items/signals can be performed in different ways. For example, when the advantageous relationship is that signal 1 has a greater magnitude than signal 2, a favorable comparison may be achieved when the magnitude of signal 1 is greater than that of signal 2 or when the magnitude of signal 2 is less than that of signal 1. Similarly, one skilled in the art will recognize that the comparison of the inverse or opposite of items/signals and/or other forms of mathematical or logical equivalence can likewise be used in an equivalent fashion. For example, the comparison to determine if a signal X>5 is equivalent to determining if −X<−5, and the comparison to determine if signal A matches signal B can likewise be performed by determining −A matches −B or not(A) matches not(B). As may be discussed herein, the determination that a particular relationship is present (either favorable or unfavorable) can be utilized to automatically trigger a particular action. Unless expressly stated to the contrary, the absence of that particular condition may be assumed to imply that the particular action will not automatically be triggered. In other examples, the determination that a particular relationship is present (either favorable or unfavorable) can be utilized as a basis or consideration to determine whether to perform one or more actions. Note that such a basis or consideration can be considered alone or in combination with one or more other bases or considerations to determine whether to perform the one or more actions. In one example where multiple bases or considerations are used to determine whether to perform one or more actions, the respective bases or considerations are given equal weight in such determination. In another example where multiple bases or considerations are used to determine whether to perform one or more actions, the respective bases or considerations are given unequal weight in such determination.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e. machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event—without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind.

While particular combinations of various functions and features of the one or more embodiments have been expressly described herein, other combinations of these features and functions are likewise possible. The present disclosure is not limited by the particular examples disclosed herein and expressly incorporates these other combinations.

1. A method for execution by at least one processor of a database system, comprising:
determining query service class text pattern data indicating a plurality of text patterns each corresponding to one of a plurality of service classes;
determining a query expression indicating a query for execution;
utilizing the query service class text pattern data to select one service class of the plurality of service classes for the query based on text of the query expression matching a corresponding text pattern of the plurality of text patterns that corresponds to the one service class; and
executing the query in accordance with a set of query execution attributes of the one service class based on selecting the one service class for the query.

2. The method of claim 1, wherein the set of query execution attributes includes at least one of:
a query priority of a plurality of query priorities; or
at least one limit for at least one workload management limit type.

3. The method of claim 2, wherein the at least one workload management limit type includes a number of rows returned limit type, and wherein executing the query in accordance with the set of query execution attributes of the one service class includes generating a query resultant for the query based on emitting only up to a threshold maximum number of rows indicated as the limit for the number of rows returned type for the one service class.

4. The method of claim 2, wherein the at least one workload management limit type includes a number of concurrent queries limit type, and wherein executing the query in accordance with the set of query execution attributes of the one service class includes executing the query with other queries included in a set of concurrently executing queries that includes only up to a threshold maximum number of queries indicated as the limit for the number of concurrent queries limit type for the one service class.

5. The method of claim 4, wherein the one service class is a query blocking service class, wherein the threshold maximum number of queries indicated as the limit for the number of concurrent queries limit type has a value of zero for the one service class based on the one service class being the query blocking service class, and wherein the query is not executed based on the limit for the number of concurrent queries limit type having the value of zero.

6. The method of claim 2, wherein each of the plurality of service classes has a corresponding plurality of query execution attributes, and wherein a second one of the plurality of service classes has a second set of query execution attributes different from the set of query execution attributes based on including at least one of:
a second query priority of the plurality of query priorities different from the query priority; or
a second at least one limit for the at least one workload management limit type different from the at least one limit.

7. The method of claim 1, wherein utilizing the query service class text pattern data to select one service class of the plurality of service classes includes comparing the text of the query expression to one text pattern of the plurality of text patterns at a time, in accordance with an ordering of the plurality of service classes starting with a first ordered one of the plurality of service classes, until identifying a match with a text pattern of one of the plurality of services classes, wherein the one service class is selected based on being a first instance of the text of the query matching with any of the plurality of text patterns.

8. The method of claim 7, wherein the ordering of the plurality of service classes corresponds to an alphabetical ordering of the plurality of service classes by names of the plurality of service classes.

9. The method of claim 7, wherein the first ordered one of the plurality of service classes is a query blocking service class, wherein the query blocking service class is the one service class selected for the query based on the text pattern of the first ordered one of the plurality of services classes matching the text of the query, and wherein the query is not executed based on selecting the query blocking service class for the query.

10. The method of claim 1,
wherein the query expression is received from a user entity in a corresponding query request, further comprising:
identifying the plurality of service classes as a first set of service classes available to the user entity based on user-to-service class text pattern data mapping data indicating sets of service classes available to each of a plurality of user entities, wherein the query service class text pattern data is utilized to select one service class based on only evaluating service classes included in the first set of service classes available to the user entity, and wherein the one service class is included in the first set of services classes;
wherein the user-to-service class text pattern data mapping data indicates a second set of service classes available to a second user entity, wherein the second set of service classes has a non-null set difference with the first set of service classes, further comprising:
determining a second query expression indicating a second query for execution based on receiving the second query expression from the second user entity in a second corresponding query request;
selecting a selected service class of the second set of service classes for the second query based on text of the query expression matching a text pattern that corresponds to the selected service class of the second set of service classes; and
executing the second query in accordance with the selected service class of the second set of service classes based on selecting the selected service class of the second set of service classes for the second query.

11. The method of claim 1, wherein the corresponding text pattern indicates at least one text string, and wherein the one service class is selected based on the text of the query including the at least one text string.

12. The method of claim 11,
wherein the at least one text string includes at least one of:
at least one table name of at least one relational database table;
at least one column name of at least one column of the at least one relational database table; or
at least one function identifier for at least one query function;
wherein the corresponding text pattern indicates the at least one text string based on at least one of:
the query expression indicating access to the at least one relational database table in executing the query;
the query expression indicating access to the at least one column of the at least one relational database table in executing the query; or
the query expression indicating performance of the at least one query function in executing the query.

13. The method of claim 1, wherein the corresponding text pattern further indicates comparison with the text of the query be in accordance with one of: a like expression or a regular expression, and wherein the text of the query expression is determined to match the corresponding text pattern in accordance with applying the one of: the like expression or the regular expression.

14. The method of claim 13, wherein a second text pattern of the query service class text pattern data for a second query class indicates the comparison with the text of the query be in accordance a different one of: the like expression or the regular expression, wherein the different one of: the like expression or the regular expression is different from the one of: the like expression or the regular expression.

15. The method of claim 1, further comprising:
determining to utilize the query service class text pattern data to select the one service class of the plurality of service classes for the query based on:
determining no service class is yet mapped to the query in cache based on first performance of a matched service class identifier check via accessing a cache memory;
mapping a service class identifier for the one service class in the cache memory based on the one service class being selected for the query;
after determining to utilize the query service class text pattern data to select the one service class, further determining the query service class text pattern data is not needed for further processing the query based on:
determining the one service class is already mapped to the query in cache based on second performance of the matched service class identifier check via accessing the cache memory; and
resetting the cache memory after completing execution of the query to remove the mapping of the service class mapped to the query in the cache memory.

16. The method of claim 15, wherein performance of the matched service class identifier check for a corresponding query renders a returned value corresponding to one of:
a first null value type denoting no service class is yet mapped to the corresponding query in cache due to the query service class text pattern data not yet being utilized for the corresponding query to identify a matching service class, wherein the first performance of the matched service class identifier check renders returning of the first null value type;
a second null value type denoting no service class is mapped to the corresponding query in cache based on the query service class text pattern data having been utilized for the corresponding query and no matching service class being identified, wherein a selected service class for the corresponding query was determined without utilizing the query service class text pattern data based on the second null value type being returned; or
an identifier for a corresponding service class mapped to the corresponding query in cache based on the query service class text pattern data having been utilized for the corresponding query to select the corresponding service class for the corresponding query based on having a text pattern matching corresponding text of a corresponding query expression of the corresponding query, wherein the first performance of the matched service class identifier check renders returning of the identifier for the one service class.

17. The method of claim 1, each of the plurality of service classes are implemented via a corresponding plurality of query slots, further comprising:
in response to selecting the one service class at a first time:
determining to delay execution of the query based on the executing the query in accordance with a set of query execution attributes of the one service class based on the corresponding plurality of query slots for the one service class all being filled at the first time; and
executing the query at a second time after the first time based on at least one of the corresponding plurality of query slots being available at the second time, wherein the query is assigned to the one of the corresponding plurality of query slots at the second time.

18. The method of claim 1, further comprising:
determining a second query expression indicating a second query for execution;
utilizing the query service class text pattern data to determine none of the plurality of service classes have text patterns matching text of the second query expression; and
returning an error notification to a user entity that requested the second query based on determine none of the plurality of service classes have text patterns matching text of the second query expression.

19. A database system includes:
at least one processor; and
a memory that stores operational instructions that, when executed by the at least one processor, causes the database system to:
determine query service class text pattern data indicating a plurality of text patterns each corresponding to one of a plurality of service classes;
determine a query expression indicating a query for execution;
utilize the query service class text pattern data to select one service class of the plurality of service classes for the query based on text of the query expression matching a corresponding text pattern of the plurality of text patterns that corresponds to the one service class; and
execute the query in accordance with a set of query execution attributes of the one service class based on selecting the one service class for the query.

20. A non-transitory computer readable storage medium comprises:
at least one memory section that stores operational instructions that, when executed by at least one processing module that includes a processor and a memory, causes the at least one processing module to:
determine query service class text pattern data indicating a plurality of text patterns each corresponding to one of a plurality of service classes;
determine a query expression indicating a query for execution;
utilize the query service class text pattern data to select one service class of the plurality of service classes for the query based on text of the query expression matching a corresponding text pattern of the plurality of text patterns that corresponds to the one service class; and
execute the query in accordance with a set of query execution attributes of the one service class based on selecting the one service class for the query.
